(19) United States
(12) Patent Application Publication
(10) Pub. No.: US 2026/0267115 A1
(43) Pub. Date: Sep. 10, 2026

(54) IMAGING LENS AND IMAGING DEVICE

(71) Applicant: SONY SEMICONDUCTOR SOLUTIONS CORPORATION, Kanagawa (JP)

(72) Inventors: Keiji MATSUSAKA, Kanagawa (JP); Shinichiro NOUDO, Kumamoto (JP); Kensuke SUZUKI, Kanagawa (JP); Koji MIYATA, Tokyo (JP); Katsuji KIMURA, Kanagawa (JP); Toshihito IWASE, Kanagawa (JP)

(73) Assignee: SONY SEMICONDUCTOR SOLUTIONS CORPORATION, Kanagawa (JP)

(21) Appl. No.: 19/167,589

(22) PCT Filed: Mar. 25, 2024
(86) PCT No.: PCT/JP2024/011696

§ 371 Date: Sep. 22, 2025

Related U.S. Application Data
(63) Continuation-in-part of application No. 18/605,009, filed on Mar. 14, 2024.
(60) Provisional application No. 63/456,098, filed on Mar. 31, 2023.

(51) Int. Cl. G02B 13/00; G02B 9/64; H04N 23/698; H04N 25/771

(52) U.S. Cl. CPC G02B 13/0045; G02B 9/64; H04N 23/698; H04N 25/771

(57) ABSTRACT

An imaging lens and an imaging device providing a high-quality image with a maximum angle of view of 90 degrees or more at a low height. One or more lenses that form an image of an object on a curved surface shape. The maximum angle of view is 90 degrees or more. A first image height Yw where a half angle of view is 40 degrees, a second image height Y where a half angle of view is half of the maximum angle of view, an optical total length on an optical axis from an object-side surface of a lens closest to an object side to the imaging surface in the lens group is TL, a focal length of the entire imaging lens is f, and a focal length of the lens closest to the object side is f1, the following conditions are satisfied: 0.27≤(Yw/Y)²≤0.7, 0.3≤TL/2Y≤0.695, −0.35≤f/f1≤0.73.

### TECHNICAL FIELD

The present technology relates to an imaging lens and an imaging device, and more particularly, to an imaging lens and an imaging device capable of achieving imaging of a high-quality image with a maximum angle of view of 90 degrees or more at a low height.

### BACKGROUND ART

At present, smartphones equipped with multi-view cameras (multi-camera) including main cameras such as standard cameras or wide-angle cameras (Wide) and sub cameras such as ultra-wide-angle cameras (Ultra-Wide) or telephoto cameras (Tele) are widely used.

In such a multi-view camera, in particular, in an ultra-wide-angle camera having a maximum angle of view of 90 degrees or more, it is difficult to increase the size of the image sensor and improve the image quality of the captured image due to restriction on the optical total length due to thinning of the smartphone.

Meanwhile, an imaging device having a curved imaging surface has been devised (see, for example, Patent Document 1).

### CITATION LIST

### Patent Document

Patent Document 1: WO 2013/027641 A

### SUMMARY OF THE INVENTION

### Problems to be Solved by the Invention

As described above, in a mobile terminal such as a smartphone, it is difficult to increase the size of an image sensor of an ultra-wide-angle camera and to improve the image quality of a captured image due to restriction of the optical total length or the like. Therefore, there is a demand for providing a method for achieving imaging of a high quality image having a maximum angle of view of 90 degrees or more with a low height, but such a demand has not been sufficiently met.

The present technology has been made in view of such a situation, and an object thereof is to realize imaging of a high-quality image having a maximum angle of view of 90 degrees or more at a low height.

### Solutions to Problems

An imaging lens according to a first aspect of the present technology includes: a lens group including one or more lenses that form an optical image of an object on an imaging surface having a curved shape, in which when a maximum angle of view is 90 degrees or more, a first image height that is an image height in a case where a half angle of view is 40 degrees is Yw, a second image height that is an image height in a case where a half angle of view is a maximum half angle of view that is half of the maximum angle of view is Y, an optical total length that is a distance on an optical axis from an object-side surface of a lens closest to an object side to the imaging surface in the lens group is TL, a focal length of the entire imaging lens is f, and a focal length of the lens closest to the object side is f1, the following conditions are satisfied: 0.27≤(Yw/Y)²≤0.7, 0.3≤TL/2Y≤0.695, −0.35≤f/f1≤0.73.

In the first aspect of the present technology, there is provided a lens group including one or more lenses that form an optical image of an object on an imaging surface having a curved shape. The maximum angle of view is 90 degrees or more. When a first image height that is an image height in a case where a half angle of view is 40 degrees is Yw, a second image height that is an image height in a case where a half angle of view is a maximum half angle of view that is half of the maximum angle of view is Y, an optical total length that is a distance on an optical axis from an object-side surface of a lens closest to an object side to the imaging surface in the lens group is TL, a focal length of the entire imaging lens is f, and a focal length of the lens closest to the object side is f1, the following conditions are satisfied: 0.27≤(Yw/Y)²≤0.7, 0.3≤TL/2Y≤0.695, −0.35≤f/f1≤0.73.

An imaging device according to a second aspect of the present technology includes: a lens group including one or more lenses that form an optical image of an object on an imaging surface having a curved shape; an imaging lens configured such that, when a maximum angle of view is 90 degrees or more, a first image height that is an image height in a case where a half angle of view is 40 degrees is Yw, a second image height that is an image height in a case where a half angle of view is a maximum half angle of view that is half of the maximum angle of view is Y, an optical total length that is a distance on an optical axis from an object-side surface of a lens closest to an object side to the imaging surface in the lens group is TL, a focal length of the entire imaging lens is f, and a focal length of the lens closest to the object side is f1, the following conditions are satisfied: 0.27≤(Yw/Y)²≤0.7, 0.3≤TL/2Y≤0.695, −0.35≤f/f1≤0.73; and an imaging element having the imaging surface, in which a pixel array section including a plurality of pixels is formed on the imaging surface, and the pixel includes one or more photoelectric conversion sections that converts light corresponding to the optical image formed on the imaging surface into a charge, and outputs an electric signal corresponding to the charge.

In the second aspect of the present technology, an imaging lens and an imaging element are provided. The imaging lens includes a lens group including one or more lenses that form an optical image of an object on an imaging surface having a curved shape, and has a maximum angle of view of 90 degrees or more. When a first image height that is an image height in a case where a half angle of view is 40 degrees is Yw, a second image height that is an image height in a case where a half angle of view is a maximum half angle of view that is half of the maximum angle of view is Y, an optical total length that is a distance on an optical axis from an object-side surface of a lens closest to an object side to the imaging surface in the lens group is TL, a focal length of the entire imaging lens is f, and a focal length of the lens closest to the object side is f1, the following conditions are satisfied: 0.27≤(Yw/Y)²≤0.7, 0.3≤TL/2Y≤0.695, −0.35≤f/f1≤0.73. The imaging element includes the imaging surface. A pixel array section including a plurality of pixels is formed on the imaging surface. The pixel includes one or more photoelectric conversion sections that convert light corresponding to the optical image formed on the imaging surface into a charge, and outputs an electric signal corresponding to the charge.

An imaging lens according to a third aspect of the present technology includes a lens group including one or more lenses that form an optical image of an object on an imaging surface having a curved shape, in which when a maximum angle of view is 90 degrees or more, a first image height that is an image height in a case where a half angle of view is 40 degrees is Yw, a second image height that is an image height in a case where a half angle of view is a maximum half angle of view that is half of the maximum angle of view is Y, an optical total length that is a distance on an optical axis from an object-side surface of a lens closest to an object side to the imaging surface in the lens group is TL, and an optical distortion at the first image height is Dw, the following conditions are satisfied: 0.27≤(Yw/Y)²≤0.7, 0.3≤TL/2Y≤0.695, 0.001≤|Dw/Yw|≤0.08.

In the third aspect of the present technology, there is provided a lens group including one or more lenses that form an optical image of an object on an imaging surface having a curved shape. The maximum angle of view is 90 degrees or more. When a first image height that is an image height in a case where a half angle of view is 40 degrees is Yw, a second image height that is an image height in a case where a half angle of view is a maximum half angle of view that is half of the maximum angle of view is Y, an optical total length that is a distance on an optical axis from an object-side surface of a lens closest to an object side to the imaging surface in the lens group is TL, and an optical distortion at the first image height is Dw, the following conditions are satisfied: 0.27≤(Yw/Y)²≤0.7, 0.3≤TL/2Y≤0.695, 0.001≤|Dw/Yw|≤0.08.

An imaging device according to a fourth aspect of the present technology includes: a lens group including one or more lenses that form an optical image of an object on an imaging surface having a curved shape; an imaging lens configured such that, when a maximum angle of view is 90 degrees or more, a first image height that is an image height in a case where a half angle of view is 40 degrees is Yw, a second image height that is an image height in a case where a half angle of view is a maximum half angle of view that is half of the maximum angle of view is Y, an optical total length that is a distance on an optical axis from an object-side surface of a lens closest to an object side to the imaging surface in the lens group is TL, and an optical distortion at the first image height is Dw, the following conditions are satisfied: 0.27≤(Yw/Y)²≤0.7, 0.3≤TL/2Y≤0.695, 0.001≤|Dw/Yw|≤0.08; and an imaging element having the imaging surface, in which a pixel array section including a plurality of pixels is formed on the imaging surface, and the pixel includes one or more photoelectric conversion sections that converts light corresponding to the optical image formed on the imaging surface into a charge, and outputs an electric signal corresponding to the charge.

In the fourth aspect of the present technology, an imaging lens and an imaging element are provided. The imaging element includes a lens group including one or more lenses that form an optical image of an object on an imaging surface having a curved shape, and has a maximum angle of view of 90 degrees or more. When a first image height that is an image height in a case where a half angle of view is 40 degrees is Yw, a second image height that is an image height in a case where a half angle of view is a maximum half angle of view that is half of the maximum angle of view is Y, an optical total length that is a distance on an optical axis from an object-side surface of a lens closest to an object side to the imaging surface in the lens group is TL, and an optical distortion at the first image height is Dw, the following conditions are satisfied: 0.27≤(Yw/Y)²≤0.7, 0.3≤TL/2Y≤0.695, 0.001≤|Dw/Yw|≤0.08. The imaging element includes the imaging surface. A pixel array section including a plurality of pixels is formed on the imaging surface. The pixel includes one or more photoelectric conversion sections that convert light corresponding to the optical image formed on the imaging surface into a charge, and outputs an electric signal corresponding to the charge.

### BRIEF DESCRIPTION OF DRAWINGS

FIG. 1 is a diagram illustrating an external configuration example of a smartphone including an ultra-wide-angle camera as a first embodiment of an imaging device to which the present technology is applied.

FIG. 2 is a diagram illustrating a configuration example of the ultra-wide-angle camera in FIG. 1.

FIG. 3 is a diagram illustrating a configuration example of an imaging element.

FIG. 4 is a circuit diagram illustrating a circuit configuration example of a pixel.

FIG. 5 is a cross-sectional view illustrating a structure example of an imaging element.

FIG. 6 is a top view of an imaging element illustrating an arrangement example of pixels in FIG. 3.

FIG. 7 is a diagram for explaining an effect of the imaging element.

FIG. 8 is a diagram illustrating an example of an evaluation value of a same color sensitivity difference.

FIG. 9 is a diagram illustrating an example of FOVs of an ultra-wide-angle image and a wide-angle image.

FIG. 10 is a diagram for explaining a method of reading an electric signal in each imaging mode.

FIG. 11 is a graph illustrating a relationship between zoom magnification and resolution of a captured image.

FIG. 12 is a top view illustrating a detailed structure example of the base.

FIG. 13 is a diagram for explaining an example of a method of bonding imaging elements.

FIG. 14 is a diagram for explaining types of imaging lenses.

FIG. 15 is a cross-sectional view illustrating a first configuration example of the imaging lens.

FIG. 16 is a table illustrating examples of various setting values of the entire imaging lens in FIG. 15.

FIG. 17 is a table illustrating examples of various setting values of each lens, an aperture stop, an infrared cut filter, and an imaging surface in FIG. 15.

FIG. 18 is a table illustrating an example of aspherical data of each surface in FIG. 15.

FIG. 19 is a graph illustrating examples of spherical aberration, field curvature, and distortion aberration occurring in the imaging lens of FIG. 15.

FIG. 20 is a graph illustrating an example of lateral aberration occurring in the imaging lens of FIG. 15.

FIG. 21 is a cross-sectional view illustrating a second configuration example of the imaging lens.

FIG. 22 is a table illustrating examples of various setting values of the entire imaging lens in FIG. 21.

FIG. 23 is a table illustrating examples of various setting values of each lens, an aperture stop, an infrared cut filter, and an imaging surface in FIG. 21.

FIG. 24 is a table illustrating an example of aspherical data of each surface in FIG. 21.

FIG. 25 is a graph illustrating examples of spherical aberration, field curvature, and distortion aberration occurring in the imaging lens of FIG. 21.

FIG. 26 is a graph illustrating an example of lateral aberration occurring in the imaging lens of FIG. 21.

FIG. 27 is a cross-sectional view illustrating a third configuration example of the imaging lens.

FIG. 28 is a table illustrating examples of various setting values of the entire imaging lens in FIG. 27.

FIG. 29 is a table illustrating examples of various setting values of each lens, an aperture stop, an infrared cut filter, and an imaging surface in FIG. 27.

FIG. 30 is a table illustrating an example of aspherical data of each surface in FIG. 27.

FIG. 31 is a graph illustrating examples of spherical aberration, field curvature, and distortion aberration occurring in the imaging lens of FIG. 27.

FIG. 32 is a graph illustrating an example of lateral aberration occurring in the imaging lens of FIG. 27.

FIG. 33 is a cross-sectional view illustrating a fourth configuration example of the imaging lens.

FIG. 34 is a table illustrating examples of various setting values of the entire imaging lens in FIG. 33.

FIG. 35 is a table illustrating examples of various setting values of each lens, an aperture stop, an infrared cut filter, and an imaging surface in FIG. 33.

FIG. 36 is a table illustrating an example of aspherical data of each surface in FIG. 33.

FIG. 37 is a graph illustrating examples of spherical aberration, field curvature, and distortion aberration occurring in the imaging lens of FIG. 33.

FIG. 38 is a graph illustrating an example of lateral aberration occurring in the imaging lens of FIG. 33.

FIG. 39 is a cross-sectional view illustrating a fifth configuration example of the imaging lens.

FIG. 40 is a table illustrating examples of various setting values of the entire imaging lens in FIG. 39.

FIG. 41 is a table illustrating examples of various setting values of each lens, an aperture stop, an infrared cut filter, and an imaging surface in FIG. 39.

FIG. 42 is a table illustrating an example of aspherical data of each surface and an imaging surface in FIG. 39.

FIG. 43 is a graph illustrating examples of spherical aberration, field curvature, and distortion aberration occurring in the imaging lens of FIG. 39.

FIG. 44 is a graph illustrating an example of lateral aberration occurring in the imaging lens of FIG. 39.

FIG. 45 is a cross-sectional view illustrating a sixth configuration example of the imaging lens.

FIG. 46 is a table illustrating examples of various setting values of the entire imaging lens in FIG. 45.

FIG. 47 is a table illustrating examples of various setting values of each lens, an aperture stop, an infrared cut filter, and an imaging surface in FIG. 45.

FIG. 48 is a table illustrating an example of aspherical data of each surface in FIG. 45.

FIG. 49 is a graph illustrating examples of spherical aberration, field curvature, and distortion aberration occurring in the imaging lens of FIG. 45.

FIG. 50 is a graph illustrating an example of lateral aberration occurring in the imaging lens of FIG. 45.

FIG. 51 is a cross-sectional view illustrating a seventh configuration example of the imaging lens.

FIG. 52 is a table illustrating examples of various setting values of the entire imaging lens in FIG. 51.

FIG. 53 is a table illustrating examples of various setting values of each lens, an aperture stop, an infrared cut filter, and an imaging surface in FIG. 51.

FIG. 54 is a table illustrating an example of aspherical data of each surface in FIG. 51.

FIG. 55 is a graph illustrating examples of spherical aberration, field curvature, and distortion aberration occurring in the imaging lens of FIG. 51.

FIG. 56 is a graph illustrating an example of lateral aberration occurring in the imaging lens of FIG. 51.

FIG. 57 is a cross-sectional view illustrating an eighth configuration example of the imaging lens.

FIG. 58 is a table illustrating examples of various setting values of the entire imaging lens in FIG. 57.

FIG. 59 is a table illustrating examples of various setting values of each lens, an aperture stop, an infrared cut filter, and an imaging surface in FIG. 57.

FIG. 60 is a table illustrating an example of aspherical data of each surface in FIG. 57.

FIG. 61 is a graph illustrating examples of spherical aberration, field curvature, and distortion aberration occurring in the imaging lens of FIG. 57.

FIG. 62 is a graph illustrating an example of lateral aberration occurring in the imaging lens of FIG. 57.

FIG. 63 is a cross-sectional view illustrating a ninth configuration example of the imaging lens.

FIG. 64 is a table illustrating examples of various setting values of the entire imaging lens in FIG. 63.

FIG. 65 is a table illustrating examples of various setting values of each lens, an aperture stop, an infrared cut filter, and an imaging surface in FIG. 63.

FIG. 66 is a table illustrating an example of aspherical data of each surface in FIG. 63.

FIG. 67 is a graph illustrating examples of spherical aberration, field curvature, and distortion aberration occurring in the imaging lens of FIG. 63.

FIG. 68 is a graph illustrating an example of lateral aberration occurring in the imaging lens of FIG. 63.

FIG. 69 is a cross-sectional view illustrating a 10th configuration example of the imaging lens.

FIG. 70 is a table illustrating examples of various setting values of the entire imaging lens in FIG. 69.

FIG. 71 is a table illustrating examples of various setting values of each lens, the infrared cut filter, and the imaging surface in FIG. 69.

FIG. 72 is a table illustrating an example of aspherical data of each surface in FIG. 69.

FIG. 73 is a graph illustrating examples of spherical aberration, field curvature, and distortion aberration occurring in the imaging lens of FIG. 69.

FIG. 74 is a graph illustrating an example of lateral aberration occurring in the imaging lens of FIG. 69.

FIG. 75 is a cross-sectional view illustrating a 11th configuration example of the imaging lens.

FIG. 76 is a table illustrating examples of various setting values of the entire imaging lens in FIG. 75.

FIG. 77 is a table illustrating examples of various setting values of each lens, an aperture stop, an infrared cut filter, and an imaging surface in FIG. 75.

FIG. 78 is a table illustrating an example of aspherical data of each surface in FIG. 75.

FIG. 79 is a graph illustrating examples of spherical aberration, field curvature, and distortion aberration occurring in the imaging lens of FIG. 75.

FIG. 80 is a graph illustrating an example of lateral aberration occurring in the imaging lens of FIG. 75.

FIG. 81 is a cross-sectional view illustrating a 12th configuration example of the imaging lens.

FIG. 82 is a table illustrating examples of various setting values of the entire imaging lens in FIG. 81.

FIG. 83 is a table illustrating examples of various setting values of each lens, an aperture stop, an infrared cut filter, and an imaging surface in FIG. 81.

FIG. 84 is a table illustrating an example of aspherical data of each surface in FIG. 81.

FIG. 85 is a graph illustrating examples of spherical aberration, field curvature, and distortion aberration occurring in the imaging lens of FIG. 81.

FIG. 86 is a graph illustrating an example of lateral aberration occurring in the imaging lens of FIG. 81.

FIG. 87 is a table illustrating values of parameters or expressions in the imaging lens.

FIG. 88 is a top view of an imaging element illustrating another example of the arrangement of pixels in FIG. 3.

FIG. 89 is a diagram illustrating an external configuration example of a smartphone including an ultra-wide-angle camera as a second embodiment of an imaging device to which the present technology is applied.

FIG. 90 is a diagram illustrating a configuration example of an ultra-wide-angle sensor that is a third embodiment of an imaging device to which the present technology is applied.

FIG. 91 is a top view illustrating a configuration example of the imaging element in FIG. 90.

FIG. 92 is a diagram for explaining an effect of the imaging element in FIG. 90.

FIG. 93 is a top view illustrating another configuration example of the imaging element in FIG. 90.

FIG. 94 is a block diagram depicting an example of schematic configuration of a vehicle control system.

FIG. 95 is a diagram of assistance in explaining an example of installation positions of an imaging section.

### MODE FOR CARRYING OUT THE INVENTION

Modes for carrying out the present technology (hereinafter, referred to as embodiments) will be described below. Note that the description will be given in the following order.
1. First Embodiment (Smartphone in Which Ultra-Wide-Angle Camera and Wide-Angle Camera Are Shared)
2. Second Embodiment (Smartphone Individually Including Ultra-Wide-Angle Camera and Wide-Angle Camera)
3. Third Embodiment (Ultra-Wide-Angle Sensor for Generating Ultra-Wide-Angle Phase Difference Image)
4. Application Example to Mobile Body

Note that, in the drawings referred to in the following description, the same or similar parts are denoted by the same or similar reference signs. However, the drawings are schematic, and the relationship between the thickness and the plane dimension, the ratio of the thickness of each layer, and the like are different from the actual ones. In addition, the drawings may include portions having different dimensional relationships and ratios.

In addition, the definitions of directions such as up and down in the following description are merely definitions for convenience of description, and do not limit the technical idea of the present disclosure. For example, when an object is observed by rotating the object by 90°, the upper and lower sides are converted into left and right and read, and when the object is observed by rotating the object by 180°, the upper and lower sides are inverted and read.

### 1. First Embodiment

### <External Configuration Example of Smartphone>

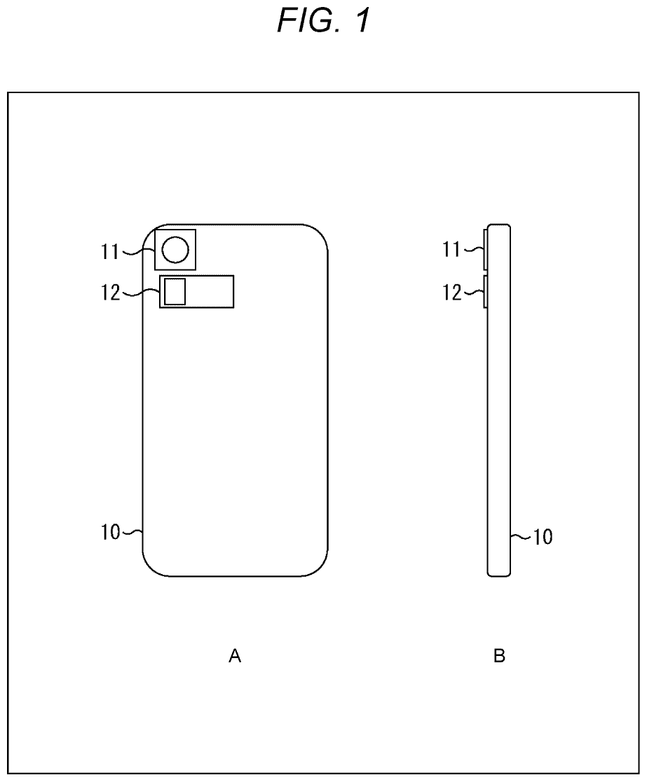

FIG. 1 is a diagram illustrating an external configuration example of a smartphone including an ultra-wide-angle camera as a first embodiment of an imaging device to which the present technology is applied.

A of FIG. 1 is a rear view of a smartphone 10, and B of FIG. 1 is a side view of the smartphone 10.

As illustrated in FIG. 1, the smartphone 10 includes an ultra-wide-angle camera 11 and a telephoto camera 12 as multi-view cameras. The ultra-wide-angle camera 11 is a camera in which an ultra-wide-angle camera and a wide-angle camera are shared. Specifically, the ultra-wide-angle camera 11 has, as imaging modes, an ultra-wide-angle mode in which an ultra-wide-angle image that is a captured image having an angle of view in a range from the first angle to the second angle is captured, and a wide-angle mode in which a wide-angle image that is a captured image having an angle of view smaller than the second angle is captured. The ultra-wide-angle camera 11 functions as an ultra-wide-angle camera in a case where imaging is performed in the ultra-wide-angle mode, and functions as a wide-angle camera in a case where imaging is performed in the wide-angle mode.

Note that the first angle is the maximum angle of view of the ultra-wide-angle camera 11 and is 90 degrees or more. The first angle can be, for example, 120 degrees or 134 degrees. The second angle may be less than the first angle, such as 56 degrees, 67 degrees, 80 degrees, or the like. The telephoto camera 12 may be a bending type telephoto camera in which an optical path is bent with a prism.

As described above, the ultra-wide-angle camera 11 of the smartphone 10 has functions of both the ultra-wide-angle camera and the wide-angle camera. Therefore, the manufacturing cost of the smartphone 10 can be suppressed as compared with the case where the smartphone 10 individually includes both the ultra-wide-angle camera and the wide-angle camera. In addition, it is possible to prevent the occurrence of unnatural parallax variation due to switching of the camera that performs imaging from one of the ultra-wide-angle camera and the wide-angle camera to the other according to the change of the magnification of the digital zoom.

### <Configuration Example of Ultra-Wide-Angle Camera>

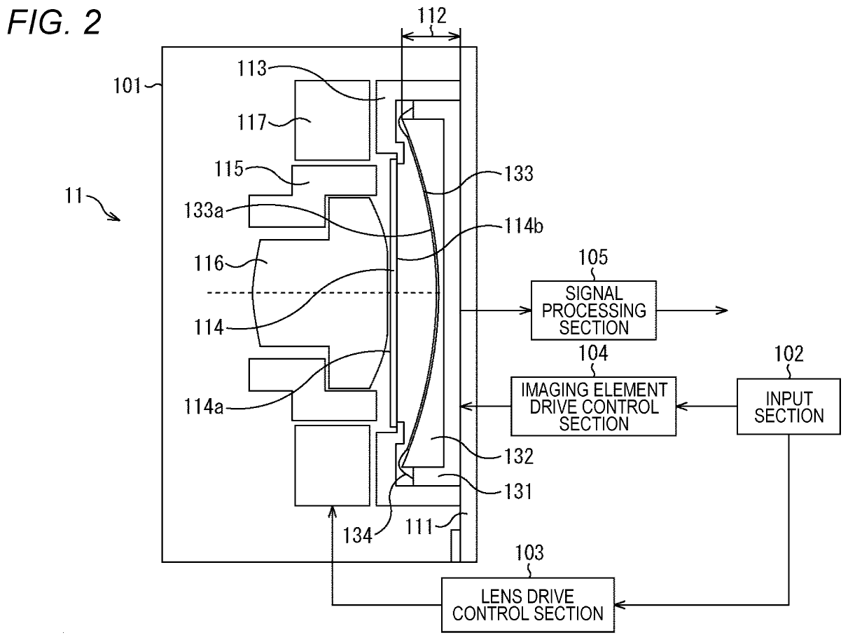

FIG. 2 is a diagram illustrating a configuration example of the ultra-wide-angle camera 11 in FIG. 1.

The ultra-wide-angle camera 11 in FIG. 2 includes an imaging section 101, an input section 102, a lens drive control section 103, an imaging element drive control section 104, and a signal processing section 105. In FIG. 2, in order to describe the configuration of the imaging section 101, a side cross section including the optical axis of the imaging section 101 is illustrated. A dotted line in FIG. 2 is an optical axis.

The imaging section 101 includes a circuit board 111, an imaging element section 112, a filter holder 113, an infrared cut filter 114, a lens holder 115, an imaging lens 116, and an actuator 117.

The circuit board 111 is a flexible printed board. The imaging element section 112 is packaged and provided on the circuit board 111. The imaging element section 112 includes a package 131, a base 132, an imaging element 133, and a wire 134.

The package 131 is provided on the circuit board 111 and is electrically connected to the circuit board 111. The base 132 is provided on the package 131 in order to hold the shape of the imaging element 133 in a shape curved concavely toward the object side (subject side). The object-side surface of the base 132 is curved concavely toward the object side in accordance with the shape of the imaging element 133. The imaging element 133 is bonded to the object-side surface of the base 132. As a result, both the object-side surface and the base 132 side surface of the imaging element 133 are curved concavely toward the object side.

The imaging element 133 is a charge-coupled device (CCD) sensor or a complementary metal oxide semiconductor (CMOS) image sensor formed on a thinned semiconductor substrate, and captures an image of an object.

Specifically, an imaging surface 133a is provided on the object-side surface of the imaging element 133. Therefore, the imaging surface 133a has a curved shape that is concave to the object side, that is, curved so as to fall to the object side from the optical center at an arbitrary position. The imaging surface 133a is desirably constituted by a spherical surface which is generally easy to manufacture, but may be constituted by an aspherical surface, a free-form surface, or the like depending on design or manufacturing convenience. In a case where the imaging surface 133a is an aspherical surface, the degree of freedom in correcting each aberration including field curvature can be further increased.

On the imaging surface 133a, an optical image of an object is formed by light incident from the object via the imaging lens 116. The imaging element 133 converts light corresponding to an optical image of an object formed on the imaging surface 133a into an electric signal in pixel units, and performs AD conversion or the like on the electric signal to generate an image signal that is a digital signal.

The imaging element 133 is electrically connected to a circuit formed on the upper surface of the package 131 by wire bonding using the wire 134. The image signal generated by the imaging element 133 is supplied to the signal processing section 105 via the circuit of the package 131, the circuit board 111, and the like. The imaging element 133 is driven on the basis of an imaging element drive control signal supplied from the imaging element drive control section 104 via the circuit board 111, a circuit of the package 131, and the like. For example, the imaging element 133 reads the electric signal of the effective pixel by the reading method on the basis of the imaging element drive control signal instructing the reading method of the electric signal and the effective pixel which is the pixel from which the electric signal is read out among all the pixels of the imaging element 133.

The filter holder 113 is formed so as to surround the periphery of the imaging element section 112, and holds the infrared cut filter 114. The filter holder 113 fixes the actuator 117.

The infrared cut filter 114 is a parallel flat filter having an object-side surface 114a and an imaging surface 133a side surface 114b. The infrared cut filter 114 transmits light other than infrared light in the light emitted from the imaging lens 116 and does not have optical power. The light transmitted through the infrared cut filter 114 is emitted to the imaging surface 133a.

Note that the infrared cut filter 114 may not be provided, or a band pass filter or the like may be provided instead of the infrared cut filter 114. The position of the infrared cut filter 114 can be set to any position that can be easily formed at the time of manufacturing.

The infrared cut filter 114 may be integrated with the lens or the imaging element 133 by multilayer coating, material addition, or surface application of an infrared absorbent or the like to the lens or the imaging element 133 constituting the imaging lens 116. The infrared cut filter 114 has a film shape, and may be integrated with a cover glass (not illustrated), a lens constituting the imaging lens 116, the imaging element 133, and the like by being bonded to the cover glass, the lens, the imaging element 133, and the like. In a case where the infrared cut filter 114 is integrated with a cover glass, a lens, the imaging element 133, or the like, it is possible to effectively utilize a space for back focus or to shorten the optical total length of the imaging lens 116.

The lens holder 115 holds the small imaging lens 116 on the object side of the imaging element 133. The imaging lens 116 is an ultra-wide-angle lens having a focal length shorter than that of a wide-angle lens having a focal length shorter than 50 mm (in terms of 35 mm), which is about the same as that of human eyes. Specifically, the imaging lens 116 is an ultra-wide-angle lens having a maximum angle of view of 90 degrees or more.

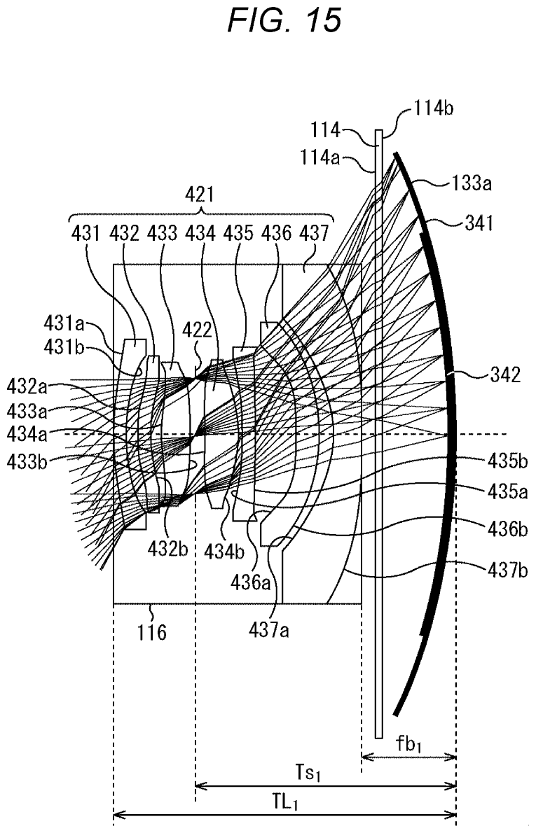

The configuration of the imaging lens 116 will be described with reference to FIGS. 15, 21, 27, 33, 39, 45, 51, 57, 63, 69, 75, and 81 to be described later. The imaging lens 116 condenses light from an object and forms an optical image on the imaging surface 133a. The actuator 117 drives a predetermined lens included in the imaging lens 116 in accordance with a lens drive control signal supplied from the lens drive control section 103.

In the imaging section 101 configured as described above, light from an object enters the imaging surface 133a via the imaging lens 116 and the infrared cut filter 114, and an optical image is formed on the imaging surface 133a. This optical image is converted into an electric signal by the imaging element 133 and captured.

The input section 102 receives an input from a user or the like, and supplies an instruction corresponding to the input to the lens drive control section 103 and the imaging element drive control section 104. For example, the input section 102 receives the input of the magnification of the digital zoom from the user, and supplies an instruction of the magnification to the imaging element drive control section 104.

The lens drive control section 103 generates a lens drive control signal in accordance with an instruction from the input section 102 and supplies the lens drive control signal to the actuator 117 to drive the imaging lens 116. For example, the lens drive control section 103 generates a lens drive control signal in response to an instruction of an angle of view or the like supplied from the input section 102, thereby driving the imaging lens 116 such that an optical image of the angle of view is formed on the imaging surface 133a.

The imaging element drive control section 104 generates an imaging element drive control signal in accordance with an instruction from the input section 102. For example, the imaging element drive control section 104 sets the imaging mode to the ultra-wide-angle mode or the wide-angle mode on the basis of the instruction of the magnification supplied from the input section 102. The imaging element drive control section 104 generates an imaging element drive control signal on the basis of the imaging mode and the magnification, and supplies the imaging element drive control signal to the imaging element 133 to drive the imaging element 133.

The signal processing section 105 holds the image signal output from the imaging element 133 in a built-in memory as necessary. The signal processing section 105 (image generation section) performs various types of signal processing such as remosaic processing on the image signal, and generates and outputs an ultra-wide-angle image or a wide-angle image.

The input section 102, the lens drive control section 103, the imaging element drive control section 104, and the signal processing section 105 may be arranged on the circuit board 111 or the package 131, or may be arranged on another substrate. The substrate of the signal processing section 105 and the semiconductor substrate constituting the imaging element 133 may be laminated.

In the example of FIG. 2, the circuit of the package 131 and the imaging element 133 are electrically connected by wire bonding, but may be electrically connected by a through electrode.

### <Configuration Example of Imaging Element>

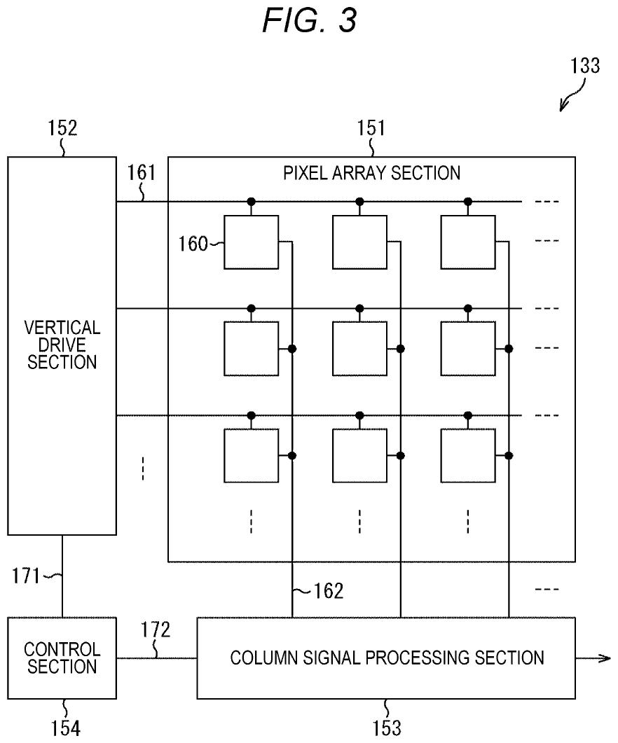

FIG. 3 is a diagram illustrating a configuration example of the imaging element 133 in FIG. 2.

The imaging element 133 in FIG. 3 includes a pixel array section 151, a vertical drive section 152, a column signal processing section 153, and a control section 154.

The pixel array section 151 is formed on the imaging surface 133a and includes a plurality of pixels 160 arranged in a matrix (two-dimensional lattice). The pixel 160 includes one photoelectric conversion section, and converts the emitted light into a charge. The pixel 160 also includes a pixel circuit that generates an electric signal based on the electric charge converted by the photoelectric conversion section. The generation of the electric signal is controlled by a control signal transmitted from the vertical drive section 152 via a signal line 161 to be described later.

In the pixel array section 151, the signal line 161 for transmitting a control signal of a pixel circuit is arranged for each of the pixels 160 in units of rows, and the same signal line 161 is connected to the pixels 160 in the same row. In the pixel array section 151, a signal line 162 for transmitting an electric signal generated by the pixel circuit is arranged for each pixel 160 in units of columns, and the same signal line 162 is connected to the pixels 160 in the same column. The photoelectric conversion section and the pixel circuit are formed on a semiconductor substrate.

The vertical drive section 152 generates a control signal of the pixel circuit of each pixel 160 in units of rows, and transmits the control signal to the pixel 160 via the signal line 161. The column signal processing section 153 performs various types of processing on the electric signal transmitted from each pixel 160 via the signal line 162. This processing includes, for example, analog-to-digital conversion for converting an analog electric signal generated in the pixel 160 into a digital image signal. The image signal obtained as a result of the processing by the column signal processing section 153 is supplied to the signal processing section 105 via the circuit board 111 and the like in FIG. 2.

The control section 154 controls the entire imaging element 133. Specifically, the control section 154 generates a control signal for controlling the vertical drive section 152, and supplies the control signal to the vertical drive section 152 via the signal line 171. The control section 154 generates a control signal for controlling the column signal processing section 153 and supplies the control signal to the column signal processing section 153 via the signal line 172.

### <Circuit Configuration Example of Pixel>

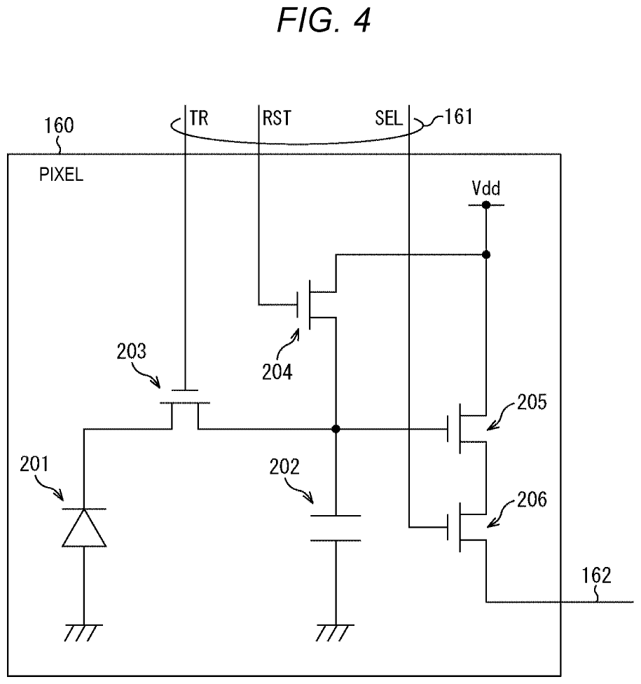

FIG. 4 is a circuit diagram illustrating a circuit configuration example of the pixel 160 in FIG. 3.

The pixel 160 in FIG. 4 includes a photoelectric conversion section 201, a charge holding section 202, and MOS transistors 203 to 206.

The photoelectric conversion section 201 includes a photodiode or the like, and generates a charge corresponding to the emitted light. The anode of the photoelectric conversion section 201 is grounded, and the cathode is connected to the source of the MOS transistor 203.

The charge holding section 202 and the MOS transistors 203 to 206 constitute a pixel circuit. The charge holding section 202 includes a capacitor. One end of the charge holding section 202 is connected to the drain of the MOS transistor 203, the source of the MOS transistor 204, and the gate of the MOS transistor 205. The other end of the charge holding section 202 is grounded.

The gate of the MOS transistor 203 is connected to the transfer signal line TR of the signal line 161. The drain of the MOS transistor 204 is connected to the power supply line Vdd, and the gate is connected to the reset signal line RST of the signal line 161. The drain of the MOS transistor 205 is connected to the power supply line Vdd, and the source is connected to the drain of the MOS transistor 206. The source of the MOS transistor 206 is connected to the signal line 162, and the gate is connected to the selection signal line SEL of the signal line 161.

In the pixel circuit configured as described above, the MOS transistor 203 transfers the charge generated by the photoelectric conversion section 201 to the charge holding section (floating diffusion (FD) (floating diffusion layer)) 202 on the basis of the control signal transmitted via the transfer signal line TR. The charge holding section 202 holds this charge. The MOS transistor 205 generates an electric signal based on the charge held in the charge holding section 202. The MOS transistor 206 reads (outputs) the electric signal to the column signal processing section 153 in FIG. 3 via the signal line 162 on the basis of the control signal transmitted via the selection signal line SEL.

The MOS transistor 204 discharges the charge held in the charge holding section 202 to the power supply line Vdd before the charge is transferred by the MOS transistor 203 on the basis of the control signal transmitted via the reset signal line RST. As a result, the charge holding section 202 is reset. Note that, at the time of the reset, the photoelectric conversion section 201 can also be reset by making the MOS transistor 203 conductive. As described above, the pixel circuit converts the charge generated by the photoelectric conversion section 201 into an electric signal.

### <Structure Example of Imaging Element>

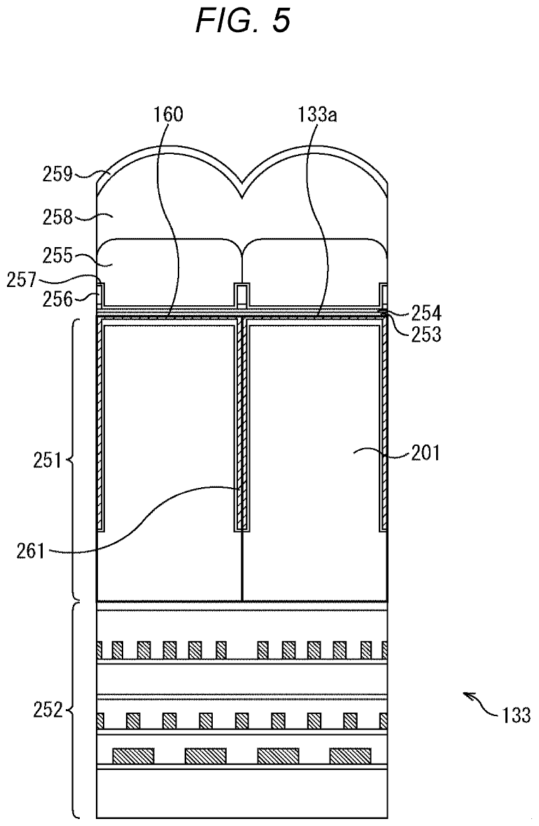

FIG. 5 is a cross-sectional view illustrating a structure example of the imaging element 133.

Note that, in FIG. 5, in order to simplify the illustration, only the regions of the two pixels 160 at the optical axis center in the imaging element 133 are illustrated.

The imaging element 133 in FIG. 5 is a back-illuminated imaging element. Therefore, in the imaging element 133, the wiring layer 252 is formed on the front surface side opposite to the back surface side on which the imaging surface 133a of the semiconductor substrate 251 is formed.

The semiconductor substrate 251 is constituted by, for example, a silicon substrate. The pixel array section 151 is formed on the semiconductor substrate 251. Specifically, on the semiconductor substrate 251, pixels 160 including a photoelectric conversion section 201 and a pixel circuit (not illustrated) are formed in a matrix.

The photoelectric conversion section 201 includes, for example, a pn junction type photodiode. In this case, the photoelectric conversion section 201 is configured by forming an n-type semiconductor region over the entire region in the thickness direction of the semiconductor substrate 251 and forming a p-type semiconductor region on the front surface side and the back surface side of the semiconductor substrate 251. The p-type semiconductor region also serves as a hole charge accumulation region for suppressing dark current.

The MOS transistor 203 constituting a pixel circuit (not illustrated) is configured by forming a gate electrode on the front surface side of an n-type source region and a drain region formed in a p-type semiconductor region on the front surface side of the semiconductor substrate 251 via a gate insulating film. In the semiconductor substrate 251, an element isolation portion 261 that isolates the adjacent pixels 160 is also formed.

The element isolation portion 261 is constituted by a p-type semiconductor region and is grounded, for example. A trench may be formed in a part of the element isolation portion 261, the fixed charge film 253 may be formed, and the insulating film 254 or the like may be embedded. As a result, crosstalk due to rolling of electrons can be blocked by the insulating film 254, and crosstalk as light can also be suppressed by interface reflection due to a difference in refractive index.

Although not illustrated, a support substrate that reinforces and supports the semiconductor substrate 251 and the like in a manufacturing process of the imaging element 133 is bonded to the semiconductor substrate 251 by plasma bonding or an adhesive material. The support substrate is constituted by, for example, a silicon substrate. Peripheral circuits such as the vertical drive section 152, the column signal processing section 153, and the control section 154 are formed on the support substrate. By forming the connection via between the semiconductor substrate 251 and the support substrate, it is possible to stack the peripheral circuits vertically and reduce the chip size of the imaging element 133. The support substrate can also include a logic circuit such as the signal processing section 105.

In the wiring layer 252, wirings such as the signal lines 161 and 162, the signal lines 171 and 172, and the power supply line Vdd are formed. The wiring layer 252 and the pixel circuit are connected by a via plug. The wiring layer 252 includes multiple layers, and the respective layers are connected by a via plug. The wiring of the wiring layer 252 can be constituted by, for example, a metal such as Al or Cu. The via plug can be constituted by, for example, a metal such as W or Cu. For insulation of the wiring layer 252, for example, SiO2 or the like can be used.

A fixed charge film 253 is formed on the semiconductor substrate 251. The fixed charge film 253 has a negative fixed charge due to a dipole of oxygen and plays a role of enhancing pinning. As a material of the fixed charge film 253, for example, an oxide or nitride containing at least one of Hf, Al, zirconium, Ta, or Ti can be used. The fixed charge film 253 can be formed by chemical vapor deposition (CVD), sputtering, and atomic layer deposition (ALD).

In a case where the fixed charge film 253 is formed by ALD, it is possible to simultaneously form SiO2 that reduces an interface state during film formation of the fixed charge film 253, which is preferable. As a material of the fixed charge film 253, an oxide or nitride containing at least one of lanthanum, cerium, neodymium, promethium, samarium, europium, gadolinium, terbium, dysprosium, holmium, thulium, ytterbium, lutetium, or yttrium can also be used. As a material of the fixed charge film 253, hafnium oxynitride or aluminum oxynitride can also be used. Silicon or nitrogen can also be added to the fixed charge film 253 in an amount that does not impair insulation. Accordingly, heat resistance and the like can be improved. The fixed charge film 253 desirably has a function as an antireflection film for the semiconductor substrate 251 by controlling the film thickness or laminating multiple layers.

On the fixed charge film 253, an insulating film 254 that suppresses deterioration of dark time characteristics is formed. From the viewpoint of antireflection, the insulating film 254 preferably has a refractive index lower than that of the upper film constituting the fixed charge film 253. As a material of the insulating film 254, for example, a composite material containing SiO2 as a main component, such as SiO₂, SiON, or SiOC, can be used.

On the insulating film 254, a color filter 255 that selectively transmits light of a predetermined color is formed for each pixel 160. As a material of the color filter 255, a pigment or a dye can be used. The color filter 255 may have a film thickness different for each color in consideration of color reproducibility by a spectral spectrum and a sensor sensitivity specification.

A light shielding film 256 that shields stray light leaking from the adjacent pixel 160 is formed between the color filters 255 of the adjacent pixels 160. As the material of the light shielding film 256, any material can be used as long as it is a material capable of shielding light, but Al, W, copper, or the like having a strong light shielding property and capable of being finely processed with high accuracy by etching or the like is preferable. As a material of the light shielding film 256, silver, gold, platinum, Mo, Cr, Ti, nickel, iron, tellurium, or the like, or an alloy containing these metals can also be used. The light shielding film 256 can also be configured by laminating a plurality of these materials. In order to enhance adhesion to the underlying insulating film 254, a barrier metal such as Ti, Ta, W, Co, Mo, alloys thereof, nitrides, oxides, or carbides thereof may be provided under the light shielding film 256.

Note that the light shielding film 256 may also serve as light shielding for the pixel 160 that determines the optical black level, and may also serve as light shielding for preventing noise to the peripheral circuit region. The light shielding film 256 is desirably grounded so as not to be destroyed by plasma damage due to accumulated charges during processing. The ground structure may be provided outside the effective region and electrically connected to the entire light shielding film 256.

On the light shielding film 256, a protective film 257 for avoiding a change in a mixing layer caused by contact between the light shielding film 256 and the color filter 255 or a change in the mixing layer caused in a reliability test is formed. As a material of the protective film 257, for example, a composite material containing SiO2 as a main component, such as SiO₂, SiON, or SiOC, can be used.

On the color filter 255, an on-chip lens 258 is formed in units of pixels 160. The on-chip lens 258 condenses the incident light on the photoelectric conversion section 201 so that the incident light is not vignetted on the light shielding film 256.

As a material of the on-chip lens 258, for example, an organic material such as a styrene resin, an acrylic resin, a styrene-acrylic resin, or a siloxane resin can be used. As a material of the on-chip lens 258, a material obtained by dispersing titanium oxide particles in the organic material or the polyimide resin can also be used. As a material of the on-chip lens 258, an inorganic material such as silicon nitride or silicon oxynitride can also be used.

An antireflection film 259 having a refractive index different from that of the on-chip lens 258 is formed on the surface of the on-chip lens 258.

### <Example of Pixel Arrangement>

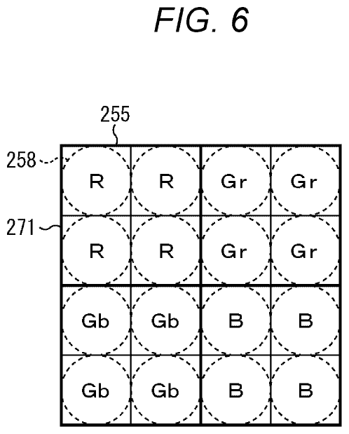

FIG. 6 is a top view of the imaging element 133 illustrating an arrangement example of the pixels 160 in FIG. 5.

Note that, in FIG. 6, in order to simplify the drawing, only a region of 4×4 pixels 160 arranged four in the row direction and four in the column direction in the imaging element 133 is illustrated, and the antireflection film 259 is omitted.

In the example of FIG. 6, the array of 4×4 pixels 160 is a Bayer array of a same color pixel group 271 including 2×2 pixels 160 having color filters 255 of the same color, that is, a Quad Bayer array. Specifically, the colors of the color filters 255 of the same color pixel group 271 including 2×2 pixels 160 at the upper left among the 4×4 pixels 160 are all red (R), and the colors of the color filters 255 of the same color pixel group 271 including 2×2 pixels 160 at the lower right are all blue (B). All the colors of the color filters 255 of the same color pixel group 271 including the upper right 2×2 pixels 160 and the same color pixel group 271 including the lower left 2×2 pixels 160 are green (Gr.Gb).

In a case where the pixel 160 has a Quad Bayer array as illustrated in FIG. 6, it is easy to add electric signals between adjacent pixels 160.

### <Description of Effect of Imaging Element>

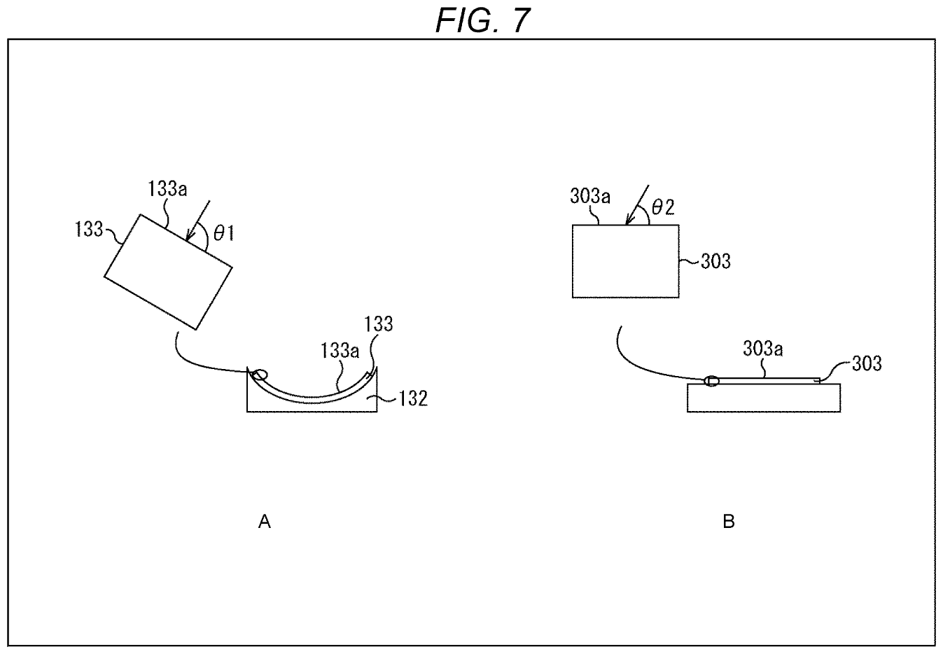

FIG. 7 is a diagram for explaining an effect of the imaging element 133.

A of FIG. 7 is a cross-sectional view of the imaging element 133 having a curved shape, and B of FIG. 7 is a cross-sectional view of the imaging element 303 having a planar shape.

As illustrated in A of FIG. 7, the imaging element 133 having a curved shape is curved, for example, in accordance with the incident angle (chief ray angle (CRA)) of light of each image height, so that the incident angle of light with respect to the imaging surface 133a can be made close to perpendicular on the entire imaging surface 133a. As a result, for example, the incident angle θ1 of the light with respect to the imaging surface 133a at the end portion of the imaging surface 133a (the end portion of the maximum angle of view in the ultra-wide-angle mode) becomes close to 90 degrees.

Therefore, it is possible to suppress the output step between the pixels 160 having the adjacent color filters 255 of the same color due to the anisotropy of color mixture caused by oblique incidence of light at the end portion of the imaging surface 133a, that is, the same color sensitivity difference. As a result, the signal processing section 105 can improve image quality deterioration such as stripes and artifacts occurring in the ultra-wide-angle image and the wide-angle image.

On the other hand, as illustrated in B of FIG. 7, even if the imaging element 303 having a planar shape has a pupil correction function of adjusting the positions of an on-chip lens, a color filter, a light shielding film, and the like according to each image height, the effect of the pupil correction function is limited. Therefore, the closer to the end portion of the imaging surface 303a, the smaller the incident angle of light with respect to the imaging surface 303a becomes than 90 degrees. For example, the incident angle θ2 of the light with respect to the imaging surface 133a at the end portion of the imaging surface 303a is smaller than 90 degrees.

As a result, image quality deterioration such as artifacts and shading occurs in the ultra-wide-angle image and the wide-angle image due to the anisotropy of color mixture caused by oblique incidence of light at the end portion of the imaging surface 303a. Furthermore, due to oblique incidence of light at the end portion of the imaging surface 303a, a sensitivity difference occurs between pixels having adjacent color filters of the same color depending on whether or not the color filters of the pixels adjacent to the pixel on the optical axis side are color filters of the same color.

### <Example of Evaluation Value of Same Color Sensitivity Difference>

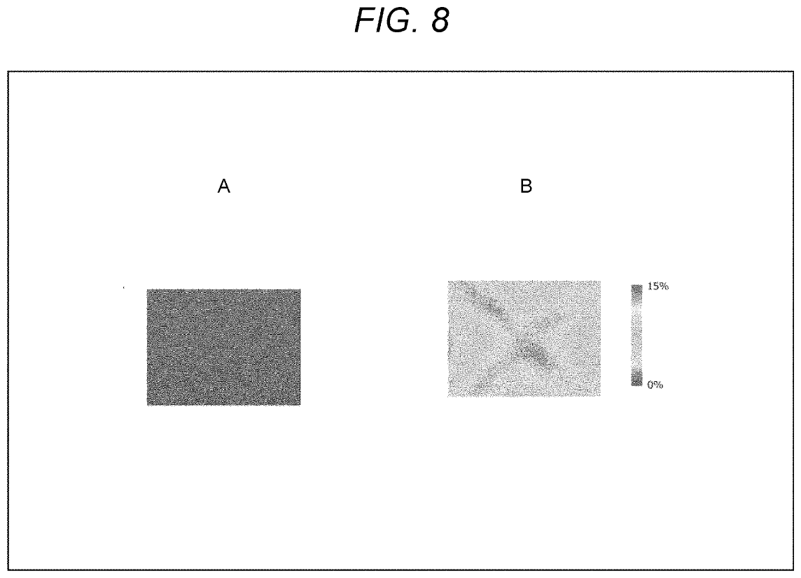

FIG. 8 is a diagram illustrating an example of evaluation values of the same color sensitivity differences between the imaging element 133 and the imaging element 303 in FIG. 7.

In the evaluation of FIG. 8, the pattern box covered with the red filter as the subject is imaged at the same wide-angle lens and in-focus position from the same distance and angle such that the entire angle of view falls within the pattern box. The reason why the color of the subject is set to red is that long-wavelength light reaches a deeper portion of the silicon substrate, so that a color mixture component is easily noticeable.

A of FIG. 8 is a heat map illustrating an evaluation value of the same color sensitivity difference at each position (image height) of the imaging surface 133a of the imaging element 133, and B of FIG. 8 is a heat map illustrating an evaluation value of the same color sensitivity difference at each position of the imaging surface 303a of the imaging element 303.

In the example of FIG. 8, the evaluation value of the same color sensitivity difference is a value representing a sensitivity difference in a same color pixel group including 2×2 pixels of a green color filter that is easily affected by color mixture from the pixels of the red color filter, and is calculated for each same color pixel group. Specifically, the evaluation value [%] is a value ((Max-Min)/ave×100) obtained by subtracting the minimum value Min from the maximum value Max of the pixel values of the pixels in the same color pixel group for each green pixel group and dividing the value by the average value ave of the pixel values by 100.

As illustrated in A of FIG. 8, in the imaging element 133, the evaluation value is less than 2% on the entire imaging surface 133a. On the other hand, as illustrated in B of FIG. 8, in the imaging element 303, the evaluation value exceeds 10% at the central end portion of the imaging surface 303a where the anisotropy of color mixture is strong.

As described above, in the imaging element 133, the same color sensitivity difference hardly occurs. Therefore, in the ultra-wide-angle image or the wide-angle image generated using the image signal output from the imaging element 133, image quality deterioration such as streaks due to the same color sensitivity difference hardly occurs.

### <Example of FOV of Ultra-Wide-Angle Image and Wide-Angle Image>

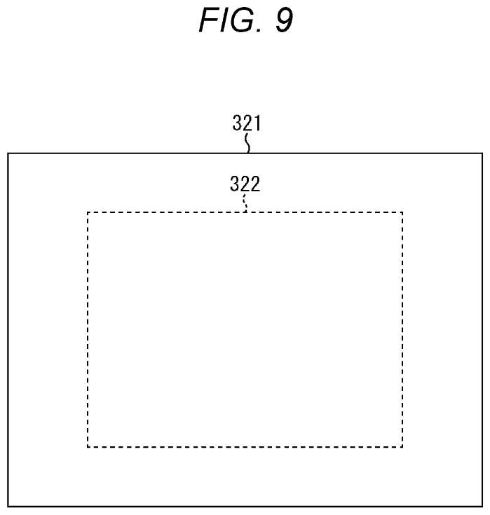

FIG. 9 is a diagram illustrating an example of a field of view (FOV) of an ultra-wide-angle image and a wide-angle image.

As illustrated in FIG. 9, the FOV of the ultra-wide-angle image having the first angle of view corresponding to the zoom magnification is a region 321 corresponding to the angle of view and imaged by all the pixels 160 of the imaging element 133. Meanwhile, the FOV of the wide-angle image in which the angle of view corresponding to the zoom magnification is the second angle is a region 322 corresponding to the angle of view and imaged by some pixels 160 of the imaging element 133.

### <Description of Reading Method of Each Imaging Mode>

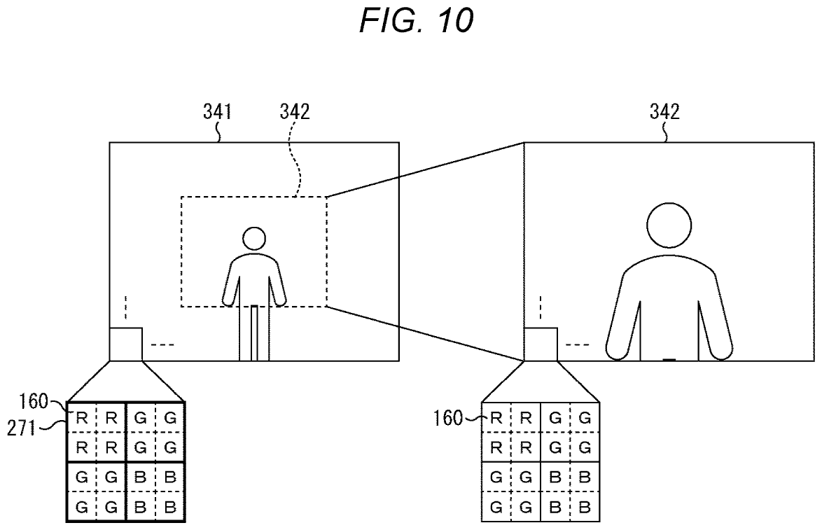

FIG. 10 is a diagram for explaining a method of reading the electric signal in each imaging mode.

In the example of FIG. 10, in a case where the zoom magnification is 1 or more and less than 2, the imaging mode is set to the ultra-wide-angle mode, and in a case where the zoom magnification is 2 or more, the imaging mode is set to the wide-angle mode. The angle of view, that is, the first angle in a case where the zoom magnification is 1 time is 134 degrees, and the effective pixel region 341, which is a region of effective pixels in this case, is configured by 16000×12000 pixels 160 arranged 16000 in the horizontal direction and 12000 in the vertical direction.

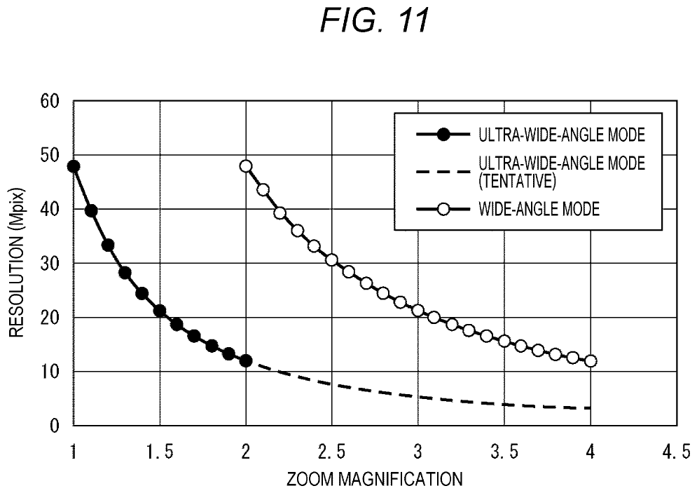

In a case where the zoom magnification is 2 times, the angle of view, that is, the second angle is 67 degrees. In this case, the effective pixel region 342, which is a region of effective pixels, is configured by 8000×6000 pixels 160 arranged 8000 in the horizontal direction and 6000 in the vertical direction, which are a part of the effective pixel region 341. It similarly applies to FIG. 11 described later.

The method of reading the electric signal in the ultra-wide-angle mode is a method of adding and reading the electric signals of each same color pixel group 271 for each pixel block including 4×4 pixels 160. Therefore, in the example of FIG. 10, the electric signals of the respective same color pixel groups 271 are added and read for each pixel block constituting the effective pixel region 341. As a result, the resolution of the ultra-wide-angle image is 48 M (=8000×6000) pixels. As described above, in the ultra-wide-angle mode, since the electric signals of the respective same color pixel groups 271 are added and read, the light amount at the low illuminance can be secured, and the signal/noise (S/N) ratio of the electric signals can be improved. As a result, the deterioration of the image quality of the ultra-wide-angle image can be improved.

As a method of adding and reading the electric signals of the respective same color pixel groups 271, for example, there is a method of sharing the charge holding sections 202 of the 2×2 pixels 160 constituting the same color pixel group 271 and reading the electric signals corresponding to the charges held in the charge holding sections 202. In this method, the charge holding section 202 functions as an addition section that adds electric signals of 2×2 pixels 160 constituting the same color pixel group 271. The sharing of the charge holding sections of 2×2 pixels, so-called pixel sharing, is described in, for example, Japanese Patent Application Laid-Open No. 2008-294218.

As a method of adding and reading the electric signals of the respective same color pixel groups 271, there is also a method of reading an electric signal for each pixel 160 and adding an image signal corresponding to the electric signal for each same color pixel group 271 by the signal processing section 105.

Note that the addition reading of the electric signals in the electric signal reading method in the ultra-wide-angle mode may be performed on all the pixel blocks or may be performed only on the pixel blocks in the peripheral portion. In a case where addition reading is performed only for the pixel blocks in the peripheral portion, resolution deterioration due to addition reading can be suppressed.

The method of reading the electric signal in the wide-angle mode is a method of individually reading the electric signal of each pixel 160. Therefore, in the example of FIG. 10, the electric signals of the pixels 160 constituting the effective pixel region 342 are individually read. As a result, the resolution of the wide-angle image is 48 M (=8000×6000) pixels. As described above, in the wide-angle mode, since the electric signal of each pixel 160 is individually read, it is possible to suppress the deterioration of the resolution of the wide-angle image.

### <Relationship Between Zoom Magnification and Resolution>

FIG. 11 is a graph illustrating a relationship between the zoom magnification and the resolution of the captured image.

In FIG. 11, the horizontal axis represents the zoom magnification, and the vertical axis represents the resolution [Mpix]. In the example of FIG. 11, the settable range of the zoom magnification is 1 time or more and 4 times or less.

As illustrated in FIG. 11, in a case where the zoom magnification is 1 or more and less than 2, the imaging mode is set to the ultra-wide-angle mode, and the electric signal is read by the reading method of the ultra-wide-angle mode. Therefore, in a case where the zoom magnification is 1 time, the resolution of the ultra-wide-angle image is 48 M pixels. Then, as the zoom magnification becomes larger than 1 time, it decreases from 48M pixels in inverse proportion to the square of the ratio of 1 time of the zoom magnification. Therefore, when the zoom magnification approaches 2 times, the resolution of the captured image approaches 12 M (=1/(2/1)²×48 M) pixels.

In a case where the zoom magnification is twice or more, the imaging mode is set to the wide-angle mode, and the electric signal is read by the reading method of the wide-angle mode. Therefore, in a case where the zoom magnification is 2 times, the resolution of the wide-angle image is 48 M pixels. As the zoom magnification becomes larger than 2 times, the resolution of the wide-angle image decreases from 48 M pixels in inverse proportion to the square of the ratio to 2 times the zoom magnification. Therefore, in a case where the zoom magnification is 4 times, the resolution of the wide-angle image is 12 M (=1/(4/2)²×48 M) pixels.

As described above, since the method of reading the electric signal differs depending on the imaging mode, it is possible to reduce the change in the resolution of the captured image accompanying the change in the zoom magnification.

On the other hand, in a case where the electric signal reading method is the same regardless of the imaging mode, as indicated by a dotted line in FIG. 11, the resolution of the wide-angle image in a case where the zoom magnification is 2 times or more decreases in inverse proportion to the square of the ratio of 1 time of the zoom magnification. Therefore, in a case where the zoom magnification is 4 times, the resolution of the wide-angle image is 3 M (=1/(4/1)²×48 M) pixels.

### <Detailed Structure Example of Base>

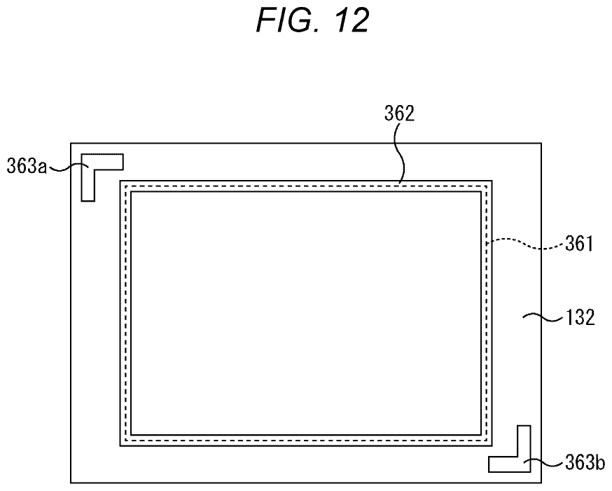

FIG. 12 is a top view illustrating a detailed structure example of the base 132.

As illustrated in FIG. 12, a groove-shaped resin pocket 362 for preventing the adhesive resin from overflowing is formed in the outer peripheral portion of the region 361 of the base 132 to which the imaging element 133 is bonded. Alignment marks 363a and 363b, which are marks for determining an adhesion position of the imaging element 133, are formed on an upper left side and a lower right side of the region 361 outside the resin pocket 362, respectively. With the alignment marks 363a and 363b, the bonding device that bonds the imaging element 133 to the base 132 can recognize the region 361 and bond the imaging element 133 to the region 361.

Note that the base 132 may be provided with a step or the like instead of the alignment marks 363a and 363b as long as it serves as a positioning guideline. The shape viewed from the upper surface of the base 132 is desirably a rectangular shape as illustrated in FIG. 12.

### <Method of Bonding Imaging Element>

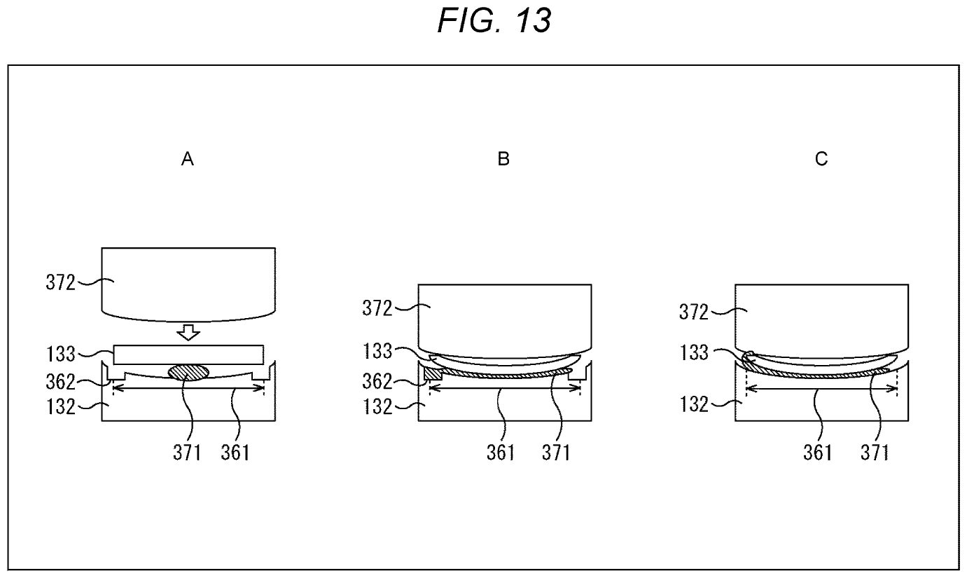

FIG. 13 is a diagram for explaining an example of a bonding method of the imaging element 133.

As illustrated in A of FIG. 13, the bonding device recognizes the region 361 of the concave curved surface of the base 132 by the alignment marks 363a and 363b, and drops the adhesive resin 371 near the center of the region 361. Then, the bonding device recognizes the region 361 by the alignment marks 363a and 363b, and disposes the imaging element 133 in the region 361 to which the adhesive resin 371 is dropped.

Next, as illustrated in B of FIG. 13, the bonding device bonds the imaging element 133 along the curved surface of the base 132 by pressing the imaging element 133 using a pressing portion 372. At this time, the excessive adhesive resin 371 crawls up toward the end portion of the imaging element 133. However, since the resin pocket 362 is provided in the outer peripheral portion of the region 361, the excessive adhesive resin 371 flows into the resin pocket 362.

On the other hand, as illustrated in C of FIG. 13, in a case where the resin pocket 362 is not provided in the base 132, the excessive adhesive resin 371 crawls up toward the end portion of the imaging element 133 and protrudes onto the base 132.

Note that the curing type of the adhesive resin 371 is not particularly limited, and may be an ultraviolet curing type, a temperature curing type, a time curing type, or the like. In a case where the curing type of the adhesive resin 371 is an ultraviolet curing type, a material having high ultraviolet transmittance is desirably used for the base 132. In a case where the curing type of the adhesive resin 371 is a temperature curing type, it is desirable to use a resin that cures at 260° C. or lower as the adhesive resin 371 in order to avoid damage to the imaging element 133 due to heat.

### <Description of Type of Imaging Lens>

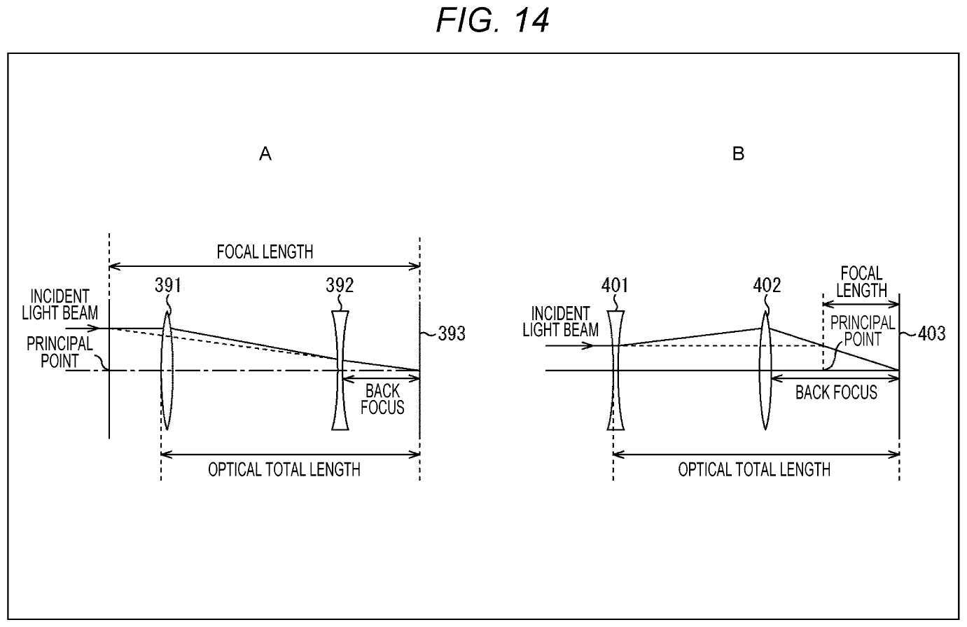

FIG. 14 is a diagram for explaining the types of imaging lenses.

In general, if the focal length of the imaging lens becomes shorter, that is, if the imaging lens becomes wider, the optical total length becomes shorter and the back focus also becomes shorter. However, depending on the type of imaging lens, the relationship between the focal length, the optical total length, and the back focus can vary.

Specifically, as a type of the imaging lens, there is a telephoto type including a convex lens 391 and a concave lens 392 in order from the object side as illustrated in A of FIG. 14.

In the telephoto type imaging lens, even in a case where the focal length is long, the optical total length can be shortened, and the height of the imaging section can be reduced. Therefore, the telephoto type imaging lens is used for a telephoto lens or the like of a digital single lens reflex camera (DSLR) in which a weight or size reduction effect is important.

However, in a telephoto type imaging lens, it is difficult to widen the angle or secure back focus and a peripheral light amount when the angle is widened. Therefore, in a case where a telephoto type imaging lens is adopted as an imaging lens of a standard camera of a mobile terminal such as a smartphone, it is possible to reduce the optical total length, that is, to reduce the height, but it is difficult to sufficiently widen the angle.

As a type of the imaging lens, as illustrated in B of FIG. 14, there is a retro-focus type including a concave lens 401 (negative lens) and a convex lens 402 in order from the object side.

In a retro-focus type imaging lens, it is relatively easy to secure back focus even at an ultra-wide-angle, that is, an ultra-short focal length. Therefore, a retro-focus type imaging lens is used for a digital single lens reflex having a long back focus, a wide-angle lens of a projector, or the like. In the retro-focus type imaging lens, it is easy to secure the peripheral light amount when the angle is widened.

However, in the retro-focus type imaging lens, the optical total length is increased, and barrel distortion is likely to occur. Note that this barrel distortion can be suppressed by increasing the number of lenses constituting the imaging lens.

As described above, in the imaging lens, there is a trade-off relationship between reduction in height of the imaging section, widening of angle, and securing of back focus.

Here, in the imaging element 133, the imaging surface 133a is curved. Therefore, in order to avoid physical interference with the imaging surface 133a, it is necessary to secure back focus (BF) as compared with a case where the imaging surface 133a is a flat surface. Therefore, as the imaging lens 116, a retro-focus type lens is used which can easily achieve wide-angle and back focus.

### <First Configuration Example of Imaging Lens>

FIG. 15 is a cross-sectional view illustrating a first configuration example of the imaging lens 116.

The imaging lens 116 in FIG. 15 includes a lens group 421 having optical power and an aperture stop 422.

The lens group 421 includes seven aspherical lenses 431 to 437. The seven lenses 431 to 437 are arranged in order from the object side (left side in FIG. 15) toward the imaging surface 133a side (right side in FIG. 15). The lens 431 has a surface 431a on the object side and a surface 431b on the imaging surface 133a side. Similarly to the lens 431, the lenses 432 to 437 also have surfaces 432a and 432b, surfaces 433a and 433b, surfaces 434a and 434b, surfaces 435a and 435b, surfaces 436a and 436b, and surfaces 437a and 437b, respectively.

The surfaces 431a to 437a and 431b to 436b are aspherical surfaces. Among the lenses 431 to 437, the surface 437b (final surface) on the imaging surface 133a side of the lens 437 closest to the imaging surface 133a is an aspherical surface that is concave toward the object side as a whole, in which the sign of the inclination of the surface is not inverted as it goes away from the optical axis. The aperture stop 422 is disposed between the lenses 433 and 434, and limits light incident on the lens 433 from the lens 434. In the example of FIG. 15, the imaging surface 133a is a spherical surface.

The light incident on the imaging lens 116 from the object is emitted via the lenses 431 to 437 and the infrared cut filter 114, and is condensed on the imaging surface 133a. The entire imaging surface 133a is the effective pixel region 341, and a partial region at the center of the imaging surface 133a is the effective pixel region 342.

Note that, hereinafter, the optical total length of the imaging lens 116, which is the distance on the optical axis from the surface 431a (foremost surface) closest to the object side of the lens 431 closest to the object side among the lenses 431 to 437 to the imaging surface 133a, is referred to as TL₁. The distance on the optical axis from the surface 437b to the imaging surface 133a is referred to as fb₁, and the distance on the optical axis from the aperture stop 422 to the imaging surface 133a is referred to as Ts₁.

In the present specification, when the distances on the optical axis such as the optical total length TL₁, the distance fb₁, and the distance Ts₁ are calculated, the air conversion length is used as the thickness of the parallel flat plate. It similarly applies to optical total lengths TL₁ to TL₁₂, distances fb₁ to fb₁₂, and distances Ts₁ to Ts₁₂ to be described later.

### <First Example of Various Setting Values of Entire Imaging Lens>

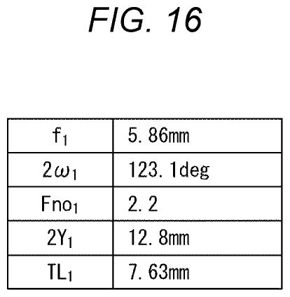

FIG. 16 is a table illustrating an example of various setting values of the entire imaging lens 116 in FIG. 15.

As illustrated in FIG. 16, a focal length (effective focal length (EFL)) f₁ of the entire imaging lens 116 in FIG. 15 is 5.86 mm. The maximum angle of view 2ω₁ of the imaging lens 116 is 123.1 deg. The f-number Fno₁ of the imaging lens 116 is 2.2, which is 2.5 or less. 2Y₁ that is twice the maximum image height (second image height) Y₁ that is the image height in a case where the half angle of view is the maximum half angle of view ω₁ that is half of the maximum angle of view 2ω₁, that is, the maximum diameter of the optical image is 12.8 mm, and the optical total length TL₁ is 7.63 mm.

### <First Example of Various Setting Values of Each Lens, Aperture Stop, Imaging Surface, and Infrared Cut Filter>

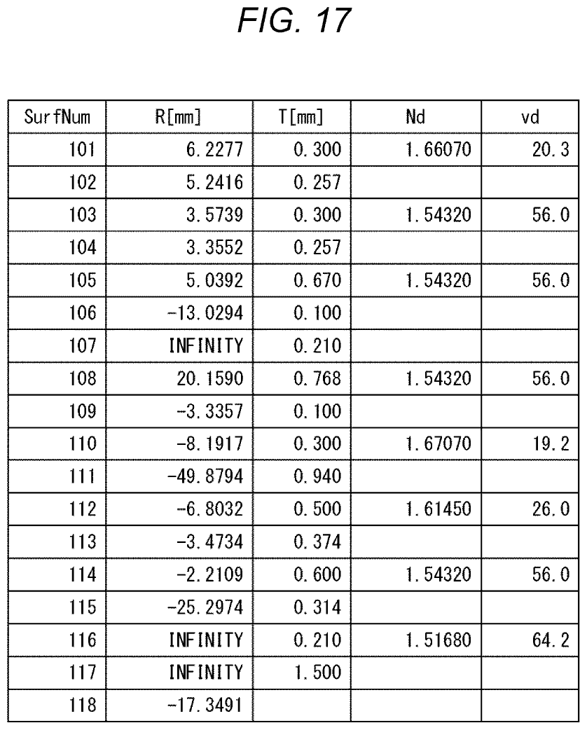

FIG. 17 is a table illustrating examples of various setting values of the lenses 431 to 437, the aperture stop 422, the infrared cut filter 114, and the imaging surface 133a of FIG. 15.

In the first row from the top of the table in FIG. 17, items corresponding to respective columns are described. The second and subsequent rows from the top correspond to the surfaces 431a to 437a and the surfaces 431b to 437b, the surface of the aperture stop 422, the surfaces 114a and 114b, and the imaging surface 133a, respectively. Each column corresponds to the items of SurfNum, the radius of curvature R [mm] of the center of the surface, the surface spacing T [mm] which is the interval on the optical axis with the next surface of SurfNum+1, the refractive index Nd with respect to the d-line (wavelength 587.6 nm), and the Abbe number vd at the d-line in order from the left.

SurfNum is a number assigned to each of the surfaces of the imaging lens 116, the surfaces 114a and 114b, and the imaging surface 133a. In the present specification, it is assumed that SurfNum from 101 to 106 is sequentially applied to the surfaces 431a, 431b, 432a, 432b, 433a, and 433b. SurfNum from 107 to 118 is sequentially applied to the surface of the aperture stop 422 in FIG. 15, the surfaces 434a, 434b, 435a, 435b, 436a, 436b, 437a, 437b, 114a, and 114b, and the imaging surface 133a. The Abbe number vd is obtained by Vd=(Nd−1)/(NF/NC) where the refractive index with respect to the F-line is NF and the refractive index with respect to the C-line is NC.

As illustrated in FIG. 17, the radius of curvature R of the surface 431a having SurfNum of 101 is 6.2277, and the surface spacing T with the surface 431b having SurfNum of 102 is 0.300. The refractive index Nd of the surface 431a is 1.66070, and the Abbe number vd is 20.3. The radius of curvature R of the surface 431b with SurfNum of 102 is 5.2416, and the surface spacing T from the surface 432a with SurfNum of 103 is 0.257.

Note that, although not described, the radius of curvature R, the surface spacing T, the refractive index Nd, and the Abbe number vd of each of the surfaces 432a to 437a are values illustrated in the table of FIG. 17. The radius of curvature R and the surface spacing T of the surfaces 432b to 437b are values illustrated in the table of FIG. 17.

Since the surfaces of the aperture stop 422 and the surfaces 114a and 114b are planar, the radius of curvature R corresponding to SurfNum of 107, 116 and 117 is infinite. Note that, although not described, the surface spacing T between the surface of the aperture stop 422 and the surface 114b, and the surface spacing T, the refractive index Nd, and the Abbe number vd of the surface 114a are values illustrated in the table of FIG. 17.

The radius of curvature R of the imaging surface 133a with SurfNum of 118 is −17.3491. Since there is no surface to which 119 following 118 is given as SurfNum, there is no surface spacing T.

### <First Example of Aspherical Data of Each Surface of Lens>

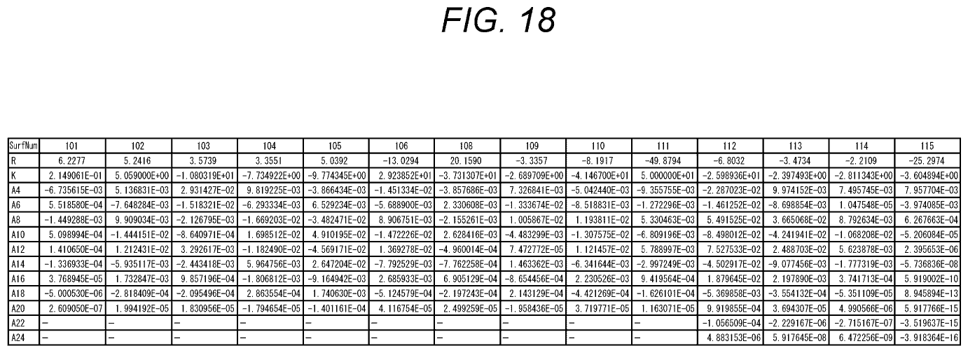

FIG. 18 is a table illustrating an example of aspherical data of the surfaces 431a to 437a and the surfaces 431b to 437b.

In the first column from the left of the table of FIG. 18, items corresponding to each row are described. The second and subsequent columns from the left correspond to the surfaces 431a, 431b, 432a, 432b, 433a, 433b, 434a, 434b, 435a, 435b, 436a, 436b, 437a, and 437b in order from the left. Each row corresponds to, from top to bottom, the following items: SurfNum, radius of curvature R, conic coefficient K, and nth-order aspherical coefficient An (n=2, 4, 6, 8, 10, 12, 14, 16, 18, 20, 22, 24).

Note that the conic coefficient K and the nth-order aspherical coefficient An are coefficients used when the sag amount of the aspherical surface expressed by the following expression (a) is obtained.

$$\begin{matrix}[ Math . 1 ] & \\ Z = \frac{{cr}^{2}}{1 + \sqrt{1 - ( 1 + K ) {c}^{2} {r}^{2}}} + \sum {Anr}^{n} & ( a )\end{matrix}$$

In Expression (a), z is a sag amount in a direction parallel to the optical axis, r is a distance in the radial direction, and c is a curvature, that is, a reciprocal of a radius of curvature R. K is a conic coefficient (conic constant), and An is a coefficient of rⁿ, that is, an nth-order aspherical coefficient. n is an integer of 1 or more and 30 or less.

As illustrated in FIG. 18, the radius of curvature R of the surface 431a having SurfNum of 101 is 6.2277, and the conic coefficient K is 2.149061×10⁻¹. The fourth-order aspherical coefficients A4, the sixth-order aspherical coefficients A6, and the eighth-order aspherical coefficients A8 are −6.735615×10⁻³, 5.518580×10⁻⁴, and −1.449288×10⁻³, respectively. The 10th order aspherical coefficient A10 and the 12th order aspherical coefficient A12 are 5.098994×10⁻⁴ and 1.410650×10⁻⁴, respectively. The 14th order aspherical coefficient A14, the 16th order aspherical coefficient A16, the 18th order aspherical coefficient A18, and the 20th order aspherical coefficient A20 are −1.336933×10⁻⁴, 3.768945×10⁻⁵, −5.000530×10⁻⁶, and 2.609050×10⁻⁷, respectively.

Note that, although not described, the radius of curvature R, the conic coefficient K, and the nth-order aspherical coefficients An (n=2, 4, 6, 8, 10, 12, 14, 16, 18, and 20) of the surfaces 432a to 435a and the surfaces 432b to 435b are values illustrated in the table of FIG. 18. The radius of curvature R, the conic coefficient K, and the nth-order aspherical coefficients An (n=2, 4, 6, 8, 10, 12, 14, 16, 18, 20, 22, and 24) of the surfaces 436a, 436b, 437a, and 437b are values illustrated in the table of FIG. 18.

### <First Example of Spherical Aberration, Field Curvature, and Distortion Aberration>

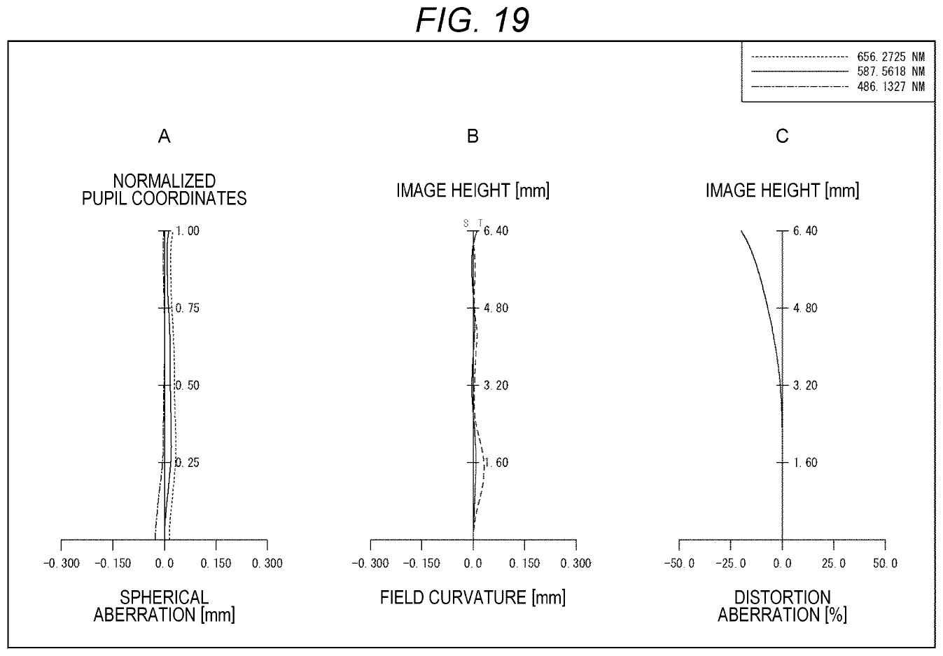

FIG. 19 is a graph illustrating examples of spherical aberration, field curvature, and distortion aberration occurring in the imaging lens 116 of FIG. 15.

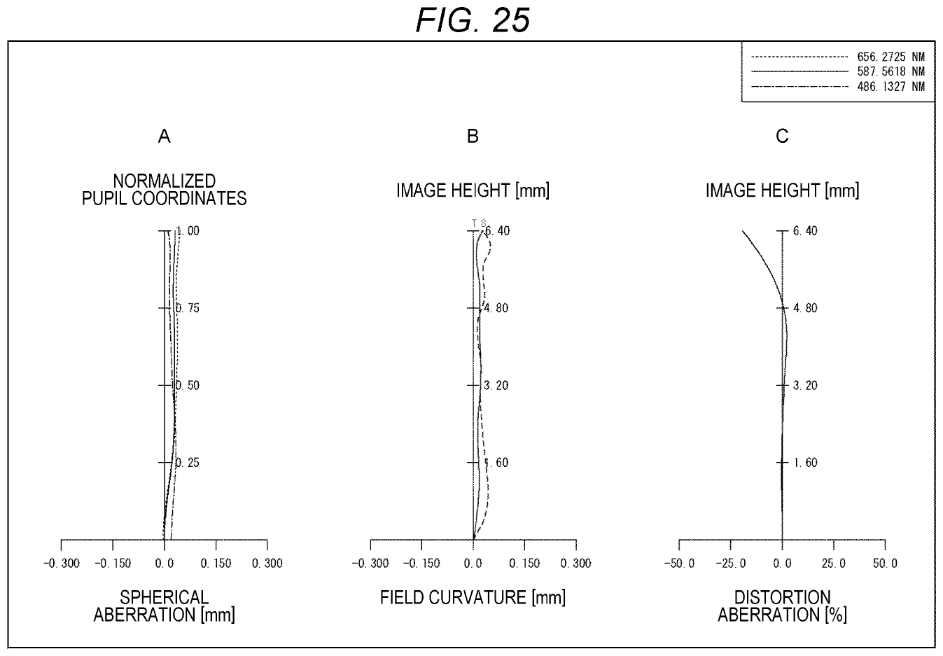

A of FIG. 19 is a graph illustrating spherical aberration for each wavelength of light having wavelengths of 486.1327 nm, 587.5618 nm, and 656.2725 nm, which occurs in the imaging lens 116 of FIG. 15. In the graph in A of FIG. 19, the horizontal axis represents spherical aberration [mm], and the vertical axis represents normalized pupil coordinates that are the ratio of the distance from the optical axis to the pupil diameter at the incident position of the light beam. It similarly applies to A in FIGS. 25, 31, 37, 43, 49, 55, 61, 67, 73, 79, and 85 to be described later.

B of FIG. 19 is a graph illustrating field curvature of light having a wavelength of 587.5618 nm generated in the imaging lens 116. In the graph in B of FIG. 19, the horizontal axis represents the field curvature [mm] in the sagittal direction or the tangential direction, and the vertical axis represents the image height [mm]. In B of FIG. 19, a solid line represents the relationship between the field curvature and the image height in the tangential direction, and a dotted line represents the relationship between the field curvature and the image height in the sagittal direction. It similarly applies to B in FIGS. 25, 31, 37, 43, 49, 55, 61, 67, 73, 79, and 85 to be described later.

C of FIG. 19 is a graph illustrating distortion aberration of light having a wavelength of 587.5618 nm, which occurs in the imaging lens 116. In the graph in C of FIG. 19, the horizontal axis represents the distortion aberration [%] and the vertical axis represents the image height [mm]. It similarly applies to C in FIGS. 25, 31, 37, 43, 49, 55, 61, 67, 73, 79, and 85 to be described later.

### <First Example of Lateral Aberration>

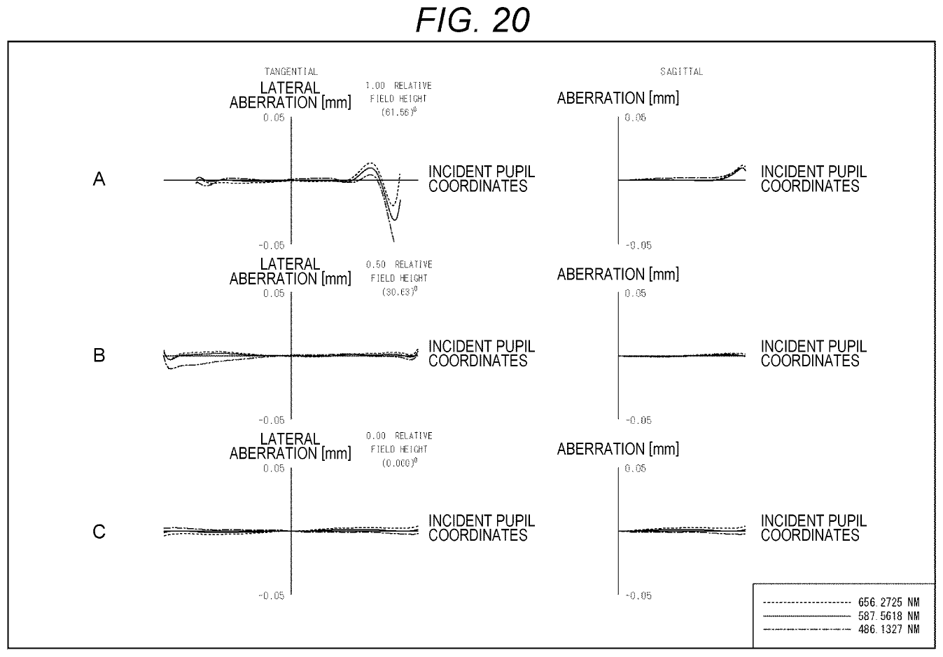

FIG. 20 is a graph illustrating an example of lateral aberration occurring in the imaging lens 116 of FIG. 15.

FIG. 20 is a graph illustrating lateral aberration for each wavelength of light having wavelengths of 486.1327 nm, 587.5618 nm, and 656.2725 nm, which occurs in imaging lens 116.

Specifically, the graphs on the left side in A to C of FIG. 20 represent the lateral aberration in the tangential direction at positions (position of image height in a case where half angle of view is 61.56°, 30.63°, 0°) where the image heights are 1.00 mm, 0.50 mm, and 0.00 mm, respectively. The graphs on the right side in A to C of FIG. 20 represent lateral aberrations in the sagittal direction at positions with image heights of 1.00 mm, 0.50 mm, and 0.00 mm, respectively.

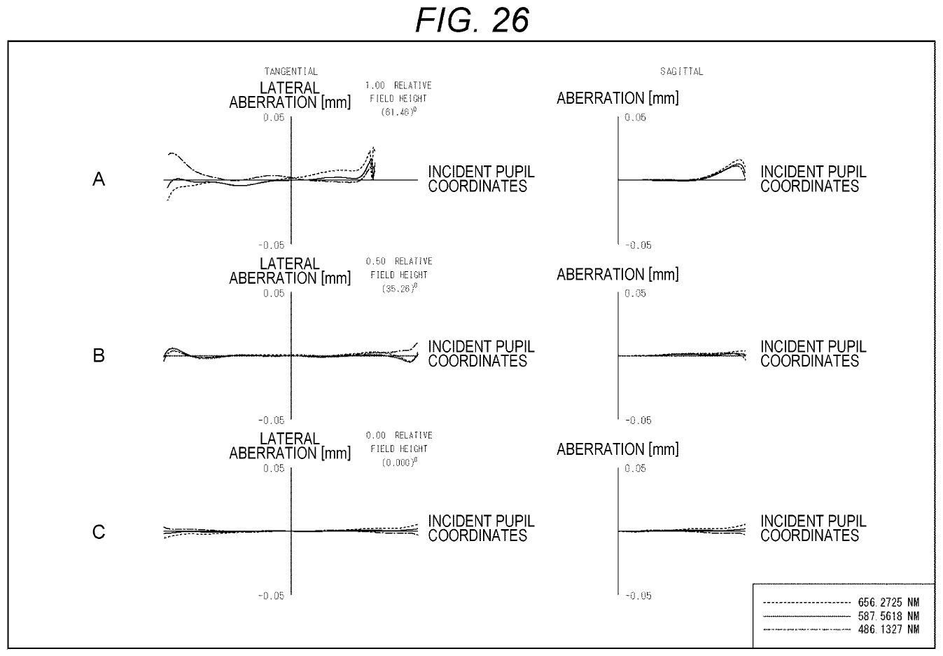

In the graphs in A to C of FIG. 20, the vertical axis represents the lateral aberration [mm], and the horizontal axis represents the incident pupil coordinates which are coordinates representing the position of the incident light beam in the direction perpendicular to the optical axis with the optical axis set to 0 as a ratio to the pupil diameter. It similarly applies to A to C in FIGS. 26, 32, 38, 44, 50, 56, 62, 68, 74, 80, and FIG. 86 to be described later.

As illustrated in FIGS. 19 and 20, good aberration correction is performed in the imaging lens 116 in FIG. 15, and the imaging lens 116 in FIG. 15 has good imaging quality.

### <Second Configuration Example of Imaging Lens>

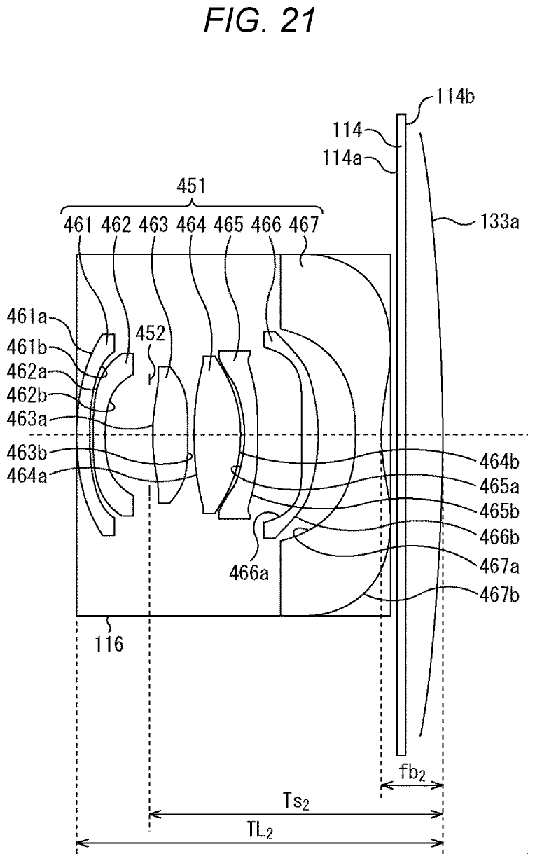

FIG. 21 is a cross-sectional view illustrating a second configuration example of the imaging lens 116.

The imaging lens 116 in FIG. 21 includes a lens group 451 and an aperture stop 452.

The lens group 451 includes seven aspherical lenses 461 to 467. The seven lenses 461 to 467 are arranged in order from the object side toward the imaging surface 133a side. The lens 461 has a surface 461a on the object side and a surface 461b on the imaging surface 133a side. Similarly to the lens 461, the lenses 462 to 467 also have surfaces 462a and 462b, surfaces 463a and 463b, surfaces 464a and 464b, surfaces 465a and 465b, surfaces 466a and 466b, and surfaces 467a and 467b, respectively.

The surfaces 461a to 467a and 461b to 467b are aspherical surfaces. The aperture stop 452 is disposed between the lenses 462 and 463, and limits light incident on the lens 462 from the lens 463. In the example of FIG. 21, the imaging surface 133a is a spherical surface.

The light incident on the imaging lens 116 from the object is emitted via the lenses 461 to 467 and the infrared cut filter 114, and is condensed on the imaging surface 133a.

Note that, hereinafter, the optical total length of the imaging lens 116, which is the distance on the optical axis from the surface 461a (foremost surface) closest to the object side of the lens 461 closest to the object side among the lenses 461 to 467 to the imaging surface 133a, is referred to as TL₂. The distance on the optical axis from the surface 467b to the imaging surface 133a is referred to as fb₂, and the distance on the optical axis from the aperture stop 452 to the imaging surface 133a is referred to as Ts₂.

### <Second Example of Various Setting Values of Entire Imaging Lens>

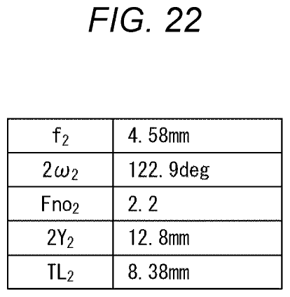

FIG. 22 is a table illustrating an example of various setting values of the entire imaging lens 116 in FIG. 21.

As illustrated in FIG. 22, a focal length f2 of the entire imaging lens 116 in FIG. 21 is 4.58 mm. The maximum angle of view 2ω₂ of the imaging lens 116 is 122.9 deg. The f-number Fno₂ of the imaging lens 116 is 2.2, which is 2.5 or less. 2Y₂, which is twice the maximum image height Y₂, is 12.8 mm, and the optical total length TL₂ is 8.38 mm.

### <Second Example of Various Setting Values of Each Lens, Aperture Stop, Imaging Surface, and Infrared Cut Filter>

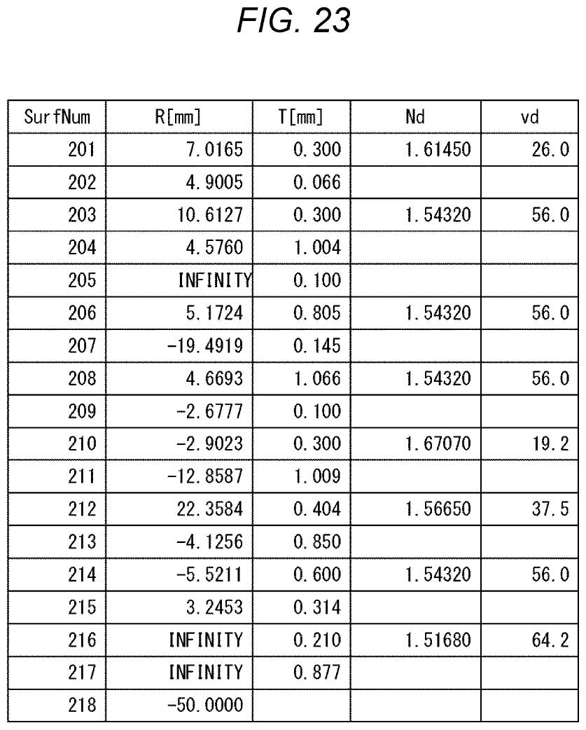

FIG. 23 is a table illustrating examples of various setting values of the lenses 461 to 467, the aperture stop 452, the infrared cut filter 114, and the imaging surface 133a of FIG. 21.

In the first row from the top of the table in FIG. 23, items corresponding to respective columns are described. The second and subsequent rows from the top correspond to the surfaces 461a to 467a and the surfaces 461b to 467b, the surface of the aperture stop 452, the surfaces 114a and 114b, and the imaging surface 133a, respectively. Each column in FIG. 23 is similar to each column in FIG. 17.

In the present specification, it is assumed that surface numbers from 201 to 205 are sequentially assigned to the surfaces 461a, 461b, 462a, and 462b and the surface of the aperture stop 452. It is assumed that surface numbers from 206 to 218 are sequentially assigned to the surfaces 463a, 463b, 464a, 464b, 465a, 465b, 466a, 466b, 467a, 467b, 114a, and 114b, and the imaging surface 133a.

Note that, although not described, the radius of curvature R, the surface spacing T, the refractive index Nd, and the Abbe number vd of each of the surfaces 461a to 467a are values illustrated in the table of FIG. 23. The radius of curvature R and the surface spacing T of the surfaces 461b to 467b are values illustrated in the table of FIG. 23.

Since the surfaces of the aperture stop 452 and the surfaces 114a and 114b are planar, the radius of curvature R corresponding to SurfNum of 205, 216 and 217 is infinite. Note that, although not described, the surface spacing T between the surface of the aperture stop 452 and the surface 114b, and the surface spacing T, the refractive index Nd, and the Abbe number vd of the surface 114a are values illustrated in the table of FIG. 23.

The radius of curvature R of the imaging surface 133a with SurfNum of 218 is −50.000. Since there is no surface to which 219 following 218 is given as SurfNum, there is no surface spacing T.

### <Second Example of Aspherical Data of Each Surface of Lens>

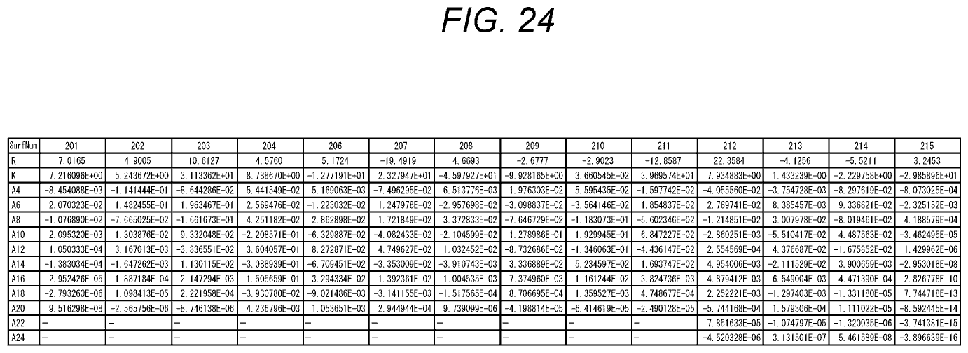

FIG. 24 is a table illustrating an example of aspherical data of the surfaces 461a to 467a and the surfaces 461b to 467b.

In the first column from the left of the table of FIG. 24, items corresponding to each row are described. The second and subsequent columns from the left correspond to the surfaces 461a, 461b, 462a, 462b, 463a, 463b, 464a, 464b, 465a, 465b, 466a, 466b, 467a, and 467b in order from the left. Each row in FIG. 24 is similar to each row in FIG. 18.

Note that, although not described, the radius of curvature R, the conic coefficient K, and the nth-order aspherical coefficients An (n=2, 4, 6, 8, 10, 12, 14, 16, 18, and 20) of the surfaces 461a to 465a and the surfaces 461b to 465b are values illustrated in the table of FIG. 24. The radius of curvature R, the conic coefficient K, and the nth-order aspherical coefficient An (n=2, 4, 6, 8, 10, 12, 14, 16, 18, 20, 22, and 24) of the surfaces 466a, 466b, 467a, and 467b are values illustrated in the table of FIG. 24.

### <Second Example of Spherical Aberration, Field Curvature, and Distortion Aberration>

FIG. 25 is a graph illustrating examples of spherical aberration, field curvature, and distortion aberration occurring in the imaging lens 116 of FIG. 21.

A of FIG. 25 is a graph illustrating spherical aberration for each wavelength of light having wavelengths of 486.1327 nm, 587.5618 nm, and 656.2725 nm, which occurs in the imaging lens 116 of FIG. 21. B of FIG. 25 is a graph illustrating field curvature of light having a wavelength of 587.5618 nm generated in the imaging lens 116. C of FIG. 25 is a graph illustrating distortion aberration of light having a wavelength of 587.5618 nm, which occurs in the imaging lens 116.

### <Second Example of Lateral Aberration>

FIG. 26 is a graph illustrating an example of lateral aberration occurring in the imaging lens 116 of FIG. 21.

FIG. 26 is a graph illustrating lateral aberration for each wavelength of light having wavelengths of 486.1327 nm, 587.5618 nm, and 656.2725 nm, which occurs in imaging lens 116.

Specifically, the graphs on the left side in A to C of FIG. 26 represent the lateral aberration in the tangential direction at positions (position of image height in a case where half angle of view is 61.46°, 35.26°, 0°) where the image heights are 1.00 mm, 0.50 mm, and 0.00 mm, respectively. The graphs on the right side in A to C of FIG. 26 represent lateral aberrations in the sagittal direction at positions with image heights of 1.00 mm, 0.50 mm, and 0.00 mm, respectively.

As illustrated in FIGS. 25 and 26, good aberration correction is performed in the imaging lens 116 in FIG. 21, and the imaging lens 116 in FIG. 21 has good imaging quality.

### <Third Configuration Example of Imaging Lens>

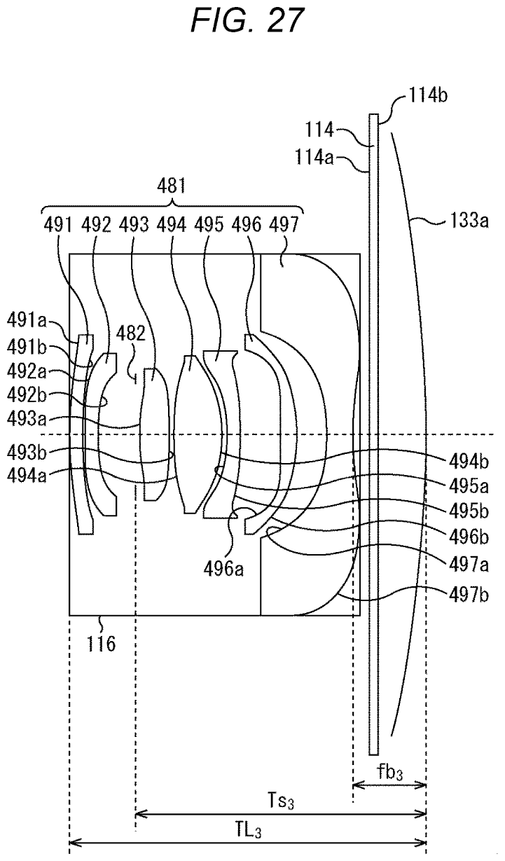

FIG. 27 is a cross-sectional view illustrating a third configuration example of the imaging lens 116.

The imaging lens 116 in FIG. 27 includes a lens group 481 and an aperture stop 482.

The lens group 481 includes seven aspherical lenses 491 to 497. The seven lenses 491 to 497 are arranged in order from the object side toward the imaging surface 133a side. The lens 491 has a surface 491a on the object side and a surface 491b on the imaging surface 133a side. Similarly to the lens 491, the lenses 492 to 497 also have surfaces 492a and 492b, surfaces 493a and 493b, surfaces 494a and 494b, surfaces 495a and 495b, surfaces 496a and 496b, and surfaces 497a and 497b, respectively.

The surfaces 491a to 497a and 491b to 497b are aspherical surfaces. The aperture stop 482 is disposed between the lenses 492 and 493, and limits light incident on the lens 492 from the lens 493. In the example of FIG. 27, the imaging surface 133a is a spherical surface.

The light incident on the imaging lens 116 from the object is emitted via the lenses 491 to 497 and the infrared cut filter 114, and is condensed on the imaging surface 133a.

Note that, hereinafter, the optical total length of the imaging lens 116, which is the distance on the optical axis from the surface 491a (foremost surface) closest to the object side of the lens 491 closest to the object side among the lenses 491 to 497 to the imaging surface 133a, is referred to as TL₃. The distance on the optical axis from the surface 497b to the imaging surface 133a is referred to as fb₃, and the distance on the optical axis from the aperture stop 482 to the imaging surface 133a is referred to as Ts₃.

### <Third Example of Various Setting Values of Entire Imaging Lens>

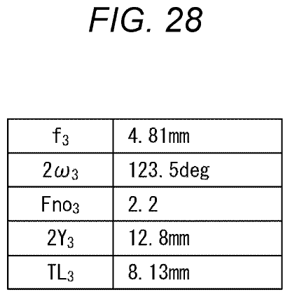

FIG. 28 is a table illustrating an example of various setting values of the entire imaging lens 116 in FIG. 27.

As illustrated in FIG. 28, a focal length f3 of the entire imaging lens 116 in FIG. 27 is 4.81 mm. The maximum angle of view 2ω₃ of the imaging lens 116 is 123.5 deg. The f-number Fno₃ of the imaging lens 116 is 2.2, which is 2.5 or less. 2Y₃, which is twice the maximum image height Y₃, is 12.8 mm, and the optical total length TL₃ is 8.13 mm.

### <Third Example of Various Setting Values of Each Lens, Aperture Stop, Imaging Surface, and Infrared Cut Filter>

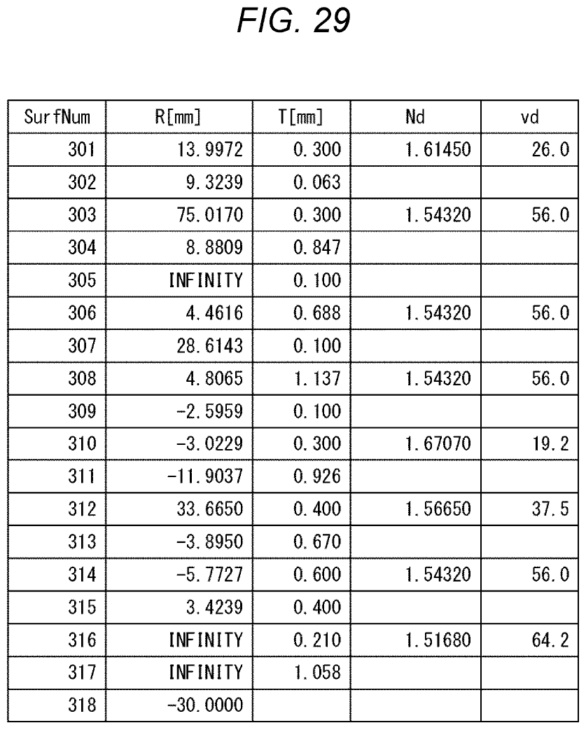

FIG. 29 is a table illustrating examples of various setting values of the lenses 491 to 497, the aperture stop 482, the infrared cut filter 114, and the imaging surface 133a of FIG. 27.

In the first row from the top of the table in FIG. 29, items corresponding to respective columns are described. The second and subsequent rows from the top correspond to the surfaces 491a to 497a and the surfaces 491b to 497b, the surface of the aperture stop 482, the surfaces 114a and 114b, and the imaging surface 133a, respectively. Each column in FIG. 29 is similar to each column in FIG. 17.

In the present specification, it is assumed that surface numbers from 301 to 304 are sequentially assigned to the surfaces 491a, 491b, 492a, and 492b. It is assumed that surface numbers from 305 to 318 are sequentially assigned to the surface of the aperture stop 482, the surfaces 493a, 493b, 494a, 494b, 495a, 495b, 496a, 496b, 497a, 497b, 114a, and 114b, and the imaging surface 133a.

Note that, although not described, the radius of curvature R, the surface spacing T, the refractive index Nd, and the Abbe number vd of each of the surfaces 491a to 497a are values illustrated in the table of FIG. 29. The radius of curvature R and the surface spacing T of the surfaces 491b to 497b are values illustrated in the table of FIG. 29.

Since the surfaces of the aperture stop 482 and the surfaces 114a and 114b are planar, the radius of curvature R corresponding to SurfNum of 305, 316 and 317 is infinite. Note that, although not described, the surface spacing T between the surface of the aperture stop 482 and the surface 114b, and the surface spacing T, the refractive index Nd, and the Abbe number vd of the surface 114a are values illustrated in the table of FIG. 29.

The radius of curvature R of the imaging surface 133a with SurfNum of 318 is −30.000. Since there is no surface to which 319 following 318 is given as SurfNum, there is no surface spacing T.

### <Third Example of Aspherical Data of Each Surface of Lens>

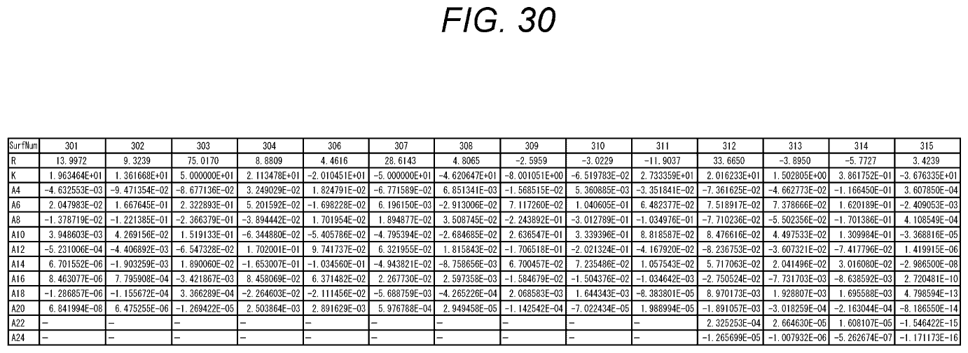

FIG. 30 is a table illustrating an example of aspherical data of the surfaces 491a to 497a and the surfaces 491b to 497b.

In the first column from the left of the table of FIG. 30, items corresponding to each row are described. The second and subsequent columns from the left correspond to the surfaces 491a, 491b, 492a, 492b, 493a, 493b, 494a, 494b, 495a, 495b, 496a, 496b, 497a, and 497b in order from the left. Each row in FIG. 30 is similar to each row in FIG. 18.

Note that, although not described, the radius of curvature R, the conic coefficient K, and the nth-order aspherical coefficients An (n=2, 4, 6, 8, 10, 12, 14, 16, 18, and 20) of the surfaces 491a to 495a and the surfaces 491b to 495b are values illustrated in the table of FIG. 30. The radius of curvature R, the conic coefficient K, and the nth-order aspherical coefficient An (n=2, 4, 6, 8, 10, 12, 14, 16, 18, 20, 22, and 24) of the surfaces 496a, 496b, 497a, and 497b are values illustrated in the table of FIG. 30.

### <Third Example of Spherical Aberration, Field Curvature, and Distortion Aberration>

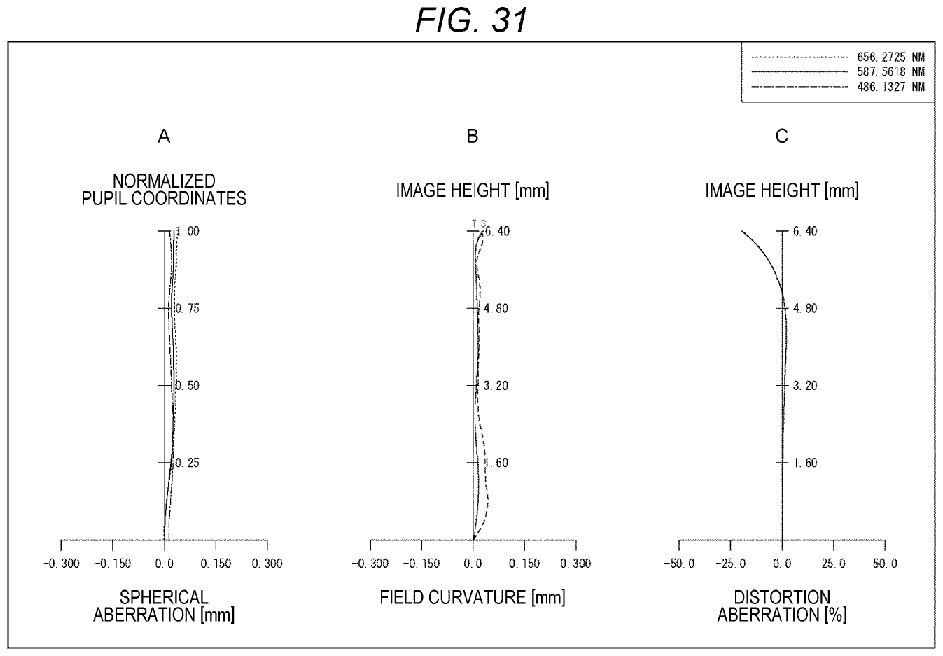

FIG. 31 is a graph illustrating examples of spherical aberration, field curvature, and distortion aberration occurring in the imaging lens 116 of FIG. 27.

A of FIG. 31 is a graph illustrating spherical aberration for each wavelength of light having wavelengths of 486.1327 nm, 587.5618 nm, and 656.2725 nm, which occurs in the imaging lens 116 of FIG. 27. B of FIG. 31 is a graph illustrating field curvature of light having a wavelength of 587.5618 nm generated in the imaging lens 116. C of FIG. 31 is a graph illustrating distortion aberration of light having a wavelength of 587.5618 nm, which occurs in the imaging lens 116.

### <Third Example of Lateral Aberration>

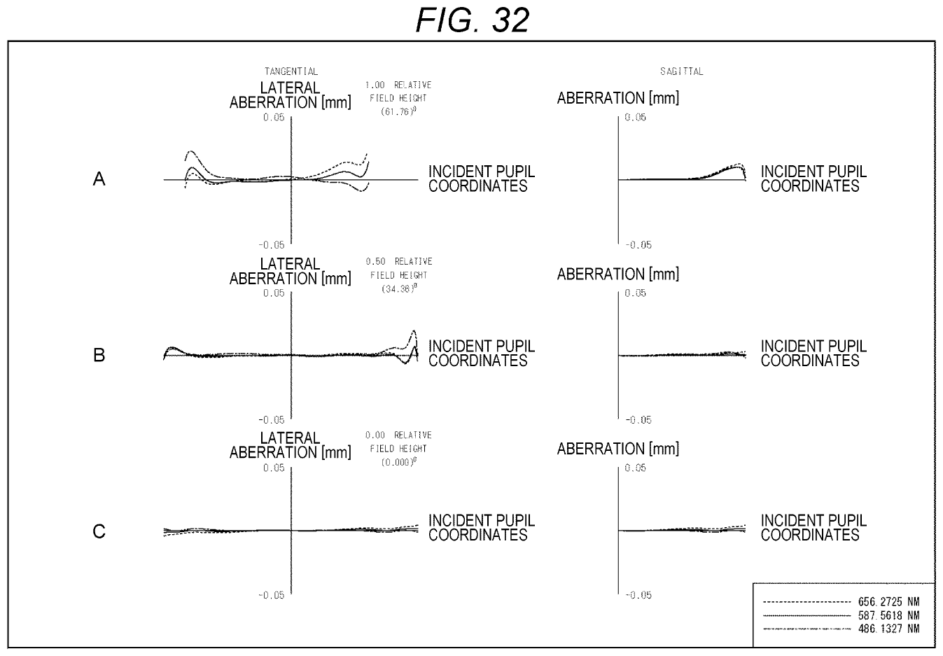

FIG. 32 is a graph illustrating an example of lateral aberration occurring in the imaging lens 116 of FIG. 27.

FIG. 32 is a graph illustrating lateral aberration for each wavelength of light having wavelengths of 486.1327 nm, 587.5618 nm, and 656.2725 nm, which occurs in imaging lens 116.

Specifically, the graphs on the left side in A to C of FIG. 32 represent the lateral aberration in the tangential direction at positions (position of image height in a case where half angle of view is 61.76°, 34.366°, 0°) where the image heights are 1.00 mm, 0.50 mm, and 0.00 mm, respectively. The graphs on the right side in A to C of FIG. 32 represent lateral aberrations in the sagittal direction at positions with image heights of 1.00 mm, 0.50 mm, and 0.00 mm, respectively.

As illustrated in FIGS. 31 and 32, good aberration correction is performed in the imaging lens 116 in FIG. 27, and the imaging lens 116 in FIG. 27 has good imaging quality.

### <Fourth Configuration Example of Imaging Lens>

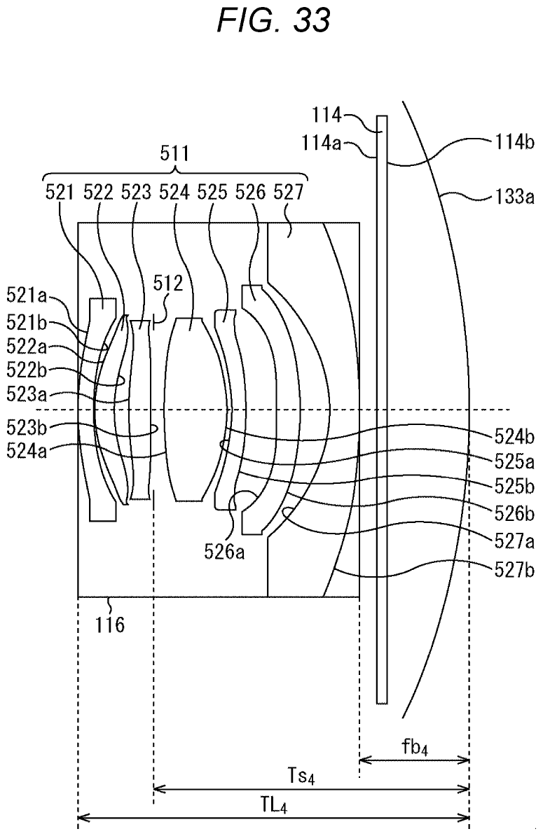

FIG. 33 is a cross-sectional view illustrating a fourth configuration example of the imaging lens 116.

The imaging lens 116 in FIG. 33 includes a lens group 511 and an aperture stop 512.

The lens group 511 includes seven aspherical lenses 521 to 527. The seven lenses 521 to 527 are arranged in order from the object side toward the imaging surface 133a side. The lens 521 has a surface 521a on the object side and a surface 521b on the imaging surface 133a side. Similarly to the lens 521, the lenses 522 to 527 also have surfaces 522a and 522b, surfaces 523a and 523b, surfaces 524a and 524b, surfaces 525a and 525b, surfaces 526a and 526b, and surfaces 527a and 527b, respectively.

The surfaces 521a to 527a and 521b to 526b are aspherical surfaces. Among the lenses 521 to 527, the surface 527b (final surface) on the imaging surface 133a side of the lens 527 closest to the imaging surface 133a is an aspherical surface that is concave toward the object side as a whole and whose surface inclination is not inverted as it goes away from the optical axis. The aperture stop 512 is disposed between the lenses 523 and 524, and limits light incident on the lens 523 from the lens 524. In the example of FIG. 33, the imaging surface 133a is a spherical surface.

The light incident on the imaging lens 116 from the object is emitted via the lenses 521 to 527 and the infrared cut filter 114, and is condensed on the imaging surface 133a.

Note that, hereinafter, the optical total length of the imaging lens 116, which is the distance on the optical axis from the surface 521a (foremost surface) closest to the object side of the lens 521 closest to the object side among the lenses 521 to 527 to the imaging surface 133a, is referred to as TL₄. The distance on the optical axis from the surface 527b to the imaging surface 133a is referred to as fb₄, and the distance on the optical axis from the aperture stop 512 to the imaging surface 133a is referred to as Ts₄.

### <Fourth Example of Various Setting Values of Entire Imaging Lens>

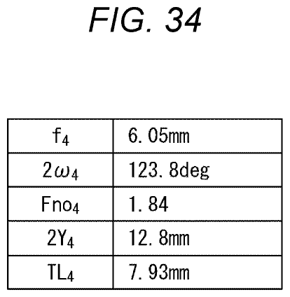

FIG. 34 is a table illustrating an example of various setting values of the entire imaging lens 116 in FIG. 33.

As illustrated in FIG. 34, a focal length f4 of the entire imaging lens 116 in FIG. 33 is 6.05 mm. The maximum angle of view 2ω₄ of the imaging lens 116 is 123.8 deg. The f-number Fno₄ of the imaging lens 116 is 1.84, which is 2.5 or less. 2Y₄, which is twice the maximum image height Y₄, is 12.8 mm, and the optical total length TL₄ is 7.93 mm.

### <Fourth Example of Various Setting Values of Each Lens, Aperture Stop, Imaging Surface, and Infrared Cut Filter>

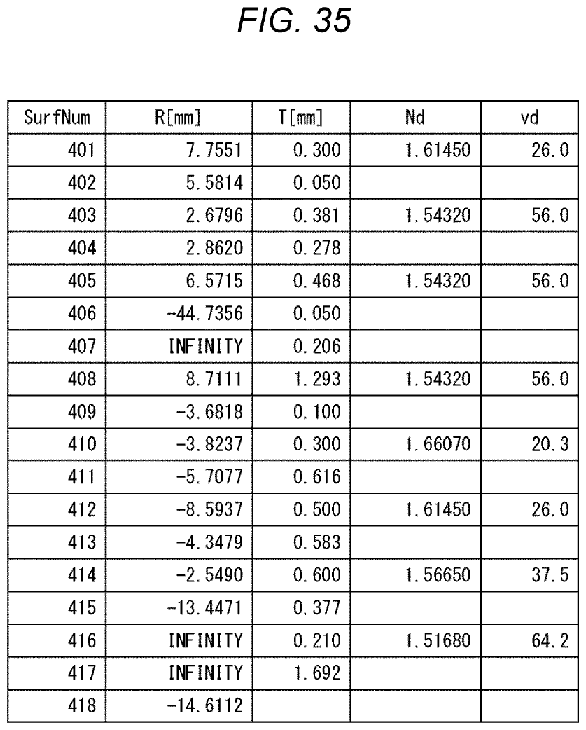

FIG. 35 is a table illustrating examples of various setting values of the lenses 521 to 527, the aperture stop 512, the infrared cut filter 114, and the imaging surface 133a of FIG. 33.

In the first row from the top of the table in FIG. 35, items corresponding to respective columns are described. The second and subsequent rows from the top correspond to the surfaces 521a to 527a and the surfaces 521b to 527b, the surface of the aperture stop 512, the surfaces 114a and 114b, and the imaging surface 133a, respectively. Each column in FIG. 35 is similar to each column in FIG. 17.

In the present specification, it is assumed that surface numbers from 401 to 406 are sequentially assigned to the surfaces 521a, 521b, 522a, 522b, 523a, and 523b. It is assumed that surface numbers from 407 to 418 are sequentially assigned to the surface of the aperture stop 512, the surfaces 524a, 524b, 525a, 525b, 526a, 526b, 527a, 527b, 114a, and 114b, and the imaging surface 133a.

Note that, although not described, the radius of curvature R, the surface spacing T, the refractive index Nd, and the Abbe number vd of each of the surfaces 521a to 527a are values illustrated in the table of FIG. 35. The radius of curvature R and the surface spacing T of the surfaces 521b to 527b are values illustrated in the table of FIG. 35.

Since the surfaces of the aperture stop 512 and the surfaces 114a and 114b are planar, the radius of curvature R corresponding to SurfNum of 407, 416 and 417 is infinite. Note that, although not described, the surface spacing T between the surface of the aperture stop 512 and the surface 114b, and the surface spacing T, the refractive index Nd, and the Abbe number vd of the surface 114a are values illustrated in the table of FIG. 35.

The radius of curvature R of the imaging surface 133a with SurfNum of 418 is −14.6122. Since there is no surface to which 419 following 418 is given as SurfNum, there is no surface spacing T.

### <Fourth Example of Aspherical Data of Each Surface of Lens>

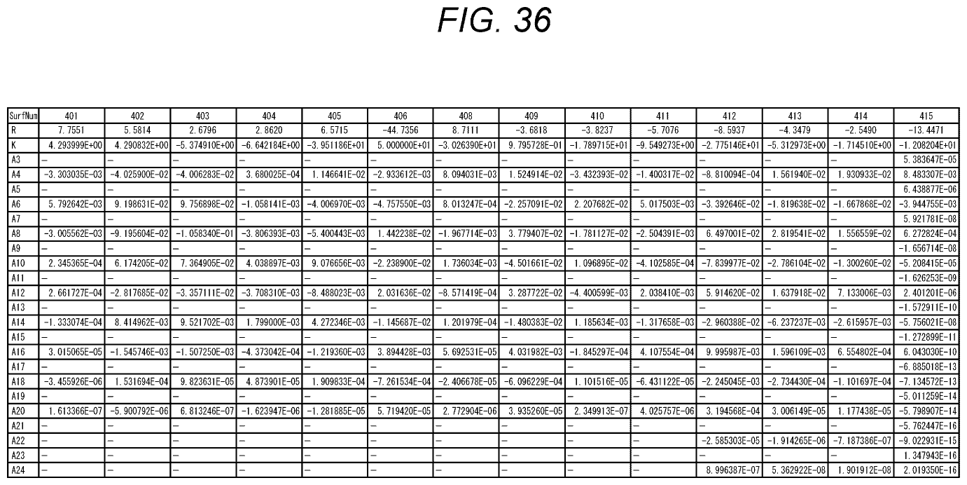

FIG. 36 is a table illustrating an example of aspherical data of the surfaces 521a to 527a and the surfaces 521b to 527b.

In the first column from the left of the table of FIG. 36, items corresponding to each row are described. The second and subsequent columns from the left correspond to the surfaces 521a, 521b, 522a, 522b, 523a, 523b, 524a, 524b, 525a, 525b, 526a, 526b, 527a, and 527b in order from the left. Each row in FIG. 36 corresponds to the items of SurfNum, the radius of curvature R, the conic coefficient K, and the third-order aspherical coefficients A3 to 24th order aspherical coefficients A24 in order from the top.

Note that, although not described, the radius of curvature R, the conic coefficient K, and the nth-order aspherical coefficients An (n=4, 6, 8, 10, 12, 14, 16, 18, and 20) of the surfaces 521a to 525a and the surfaces 521b to 525b are values illustrated in the table of FIG. 36. The radius of curvature R, the conic coefficient K, and the nth-order aspherical coefficient An (n=4, 6, 8, 10, 12, 14, 16, 18, 20, 22, and 24) of the surfaces 526a, 526b, and 527a are values illustrated in the table of FIG. 36. The radius of curvature R, the conic coefficient K, and the third-order aspherical coefficients A3 to 24th order aspherical coefficients A24 of the surface 527b are values illustrated in the table of FIG. 36.

### <Fourth Example of Spherical Aberration, Field Curvature, and Distortion Aberration>

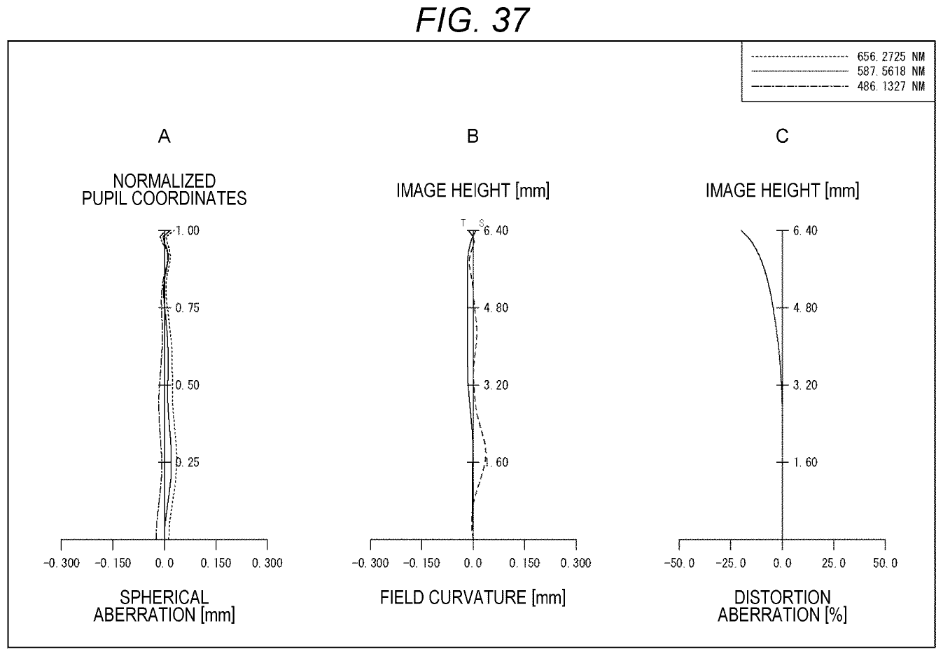

FIG. 37 is a graph illustrating examples of spherical aberration, field curvature, and distortion aberration occurring in the imaging lens 116 of FIG. 33.

A of FIG. 37 is a graph illustrating spherical aberration for each wavelength of light having wavelengths of 486.1327 nm, 587.5618 nm, and 656.2725 nm, which occurs in the imaging lens 116 of FIG. 33. B of FIG. 37 is a graph illustrating field curvature of light having a wavelength of 587.5618 nm generated in the imaging lens 116. C of FIG. 37 is a graph illustrating distortion aberration of light having a wavelength of 587.5618 nm, which occurs in the imaging lens 116.

### <Fourth Example of Lateral Aberration>

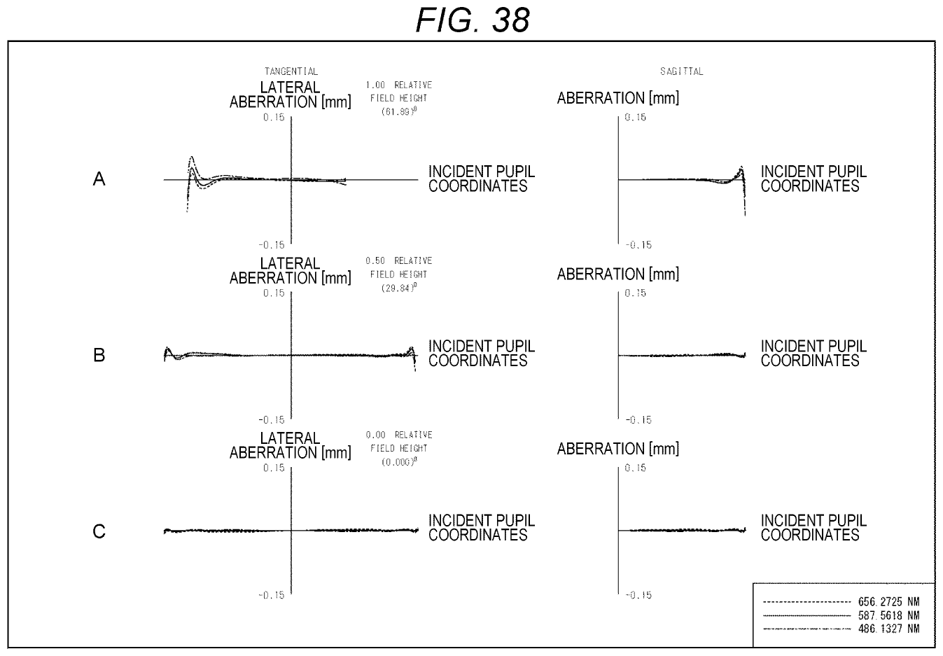

FIG. 38 is a graph illustrating an example of lateral aberration occurring in the imaging lens 116 of FIG. 33.

FIG. 38 is a graph illustrating lateral aberration for each wavelength of light having wavelengths of 486.1327 nm, 587.5618 nm, and 656.2725 nm, which occurs in imaging lens 116.

Specifically, the graphs on the left side in A to C of FIG. 38 represent the lateral aberration in the tangential direction at positions (position of image height in a case where half angle of view is 61.89°, 29.84°, 0°) where the image heights are 1.00 mm, 0.50 mm, and 0.00 mm, respectively. The graphs on the right side in A to C of FIG. 38 represent lateral aberrations in the sagittal direction at positions with image heights of 1.00 mm, 0.50 mm, and 0.00 mm, respectively.

As illustrated in FIGS. 37 and 38, good aberration correction is performed in the imaging lens 116 in FIG. 33, and the imaging lens 116 in FIG. 33 has good imaging quality.

### <Fifth Configuration Example of Imaging Lens>

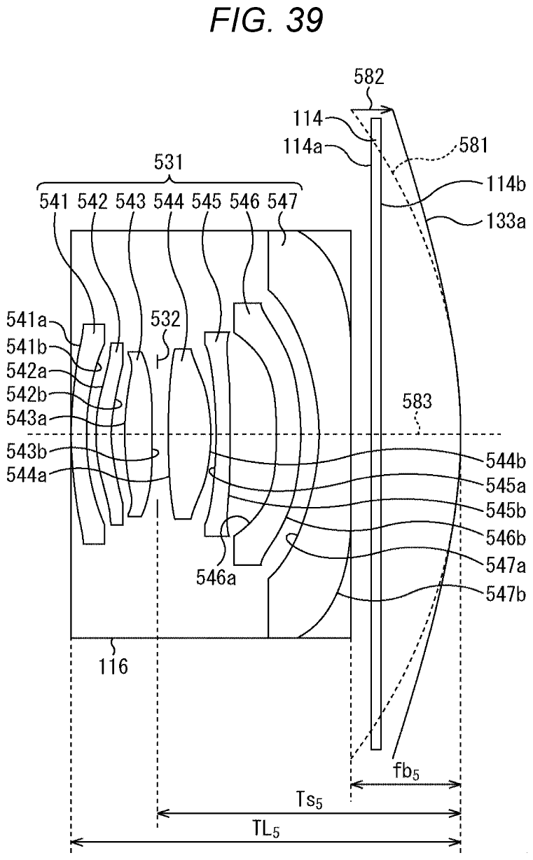

FIG. 39 is a cross-sectional view illustrating a fifth configuration example of the imaging lens 116.

The imaging lens 116 in FIG. 39 includes a lens group 531 and an aperture stop 532.

The lens group 531 includes seven aspherical lenses 541 to 547. The seven lenses 541 to 547 are arranged in order from the object side toward the imaging surface 133a side. The lens 541 has a surface 541a on the object side and a surface 541b on the imaging surface 133a side. Similarly to the lens 541, the lenses 542 to 547 also have surfaces 542a and 542b, surfaces 543a and 543b, surfaces 544a and 544b, surfaces 545a and 545b, surfaces 546a and 546b, and surfaces 547a and 547b, respectively.

The surfaces 541a to 547a and 541b to 546b are aspherical surfaces. Among the lenses 541 to 547, the surface 547b (final surface) on the imaging surface 133a side of the lens 547 closest to the imaging surface 133a is an aspherical surface that is concave toward the object side as a whole and whose surface inclination is not inverted as it goes away from the optical axis. The aperture stop 532 is disposed between the lenses 543 and 544, and limits light incident on the lens 543 from the lens 544.

In the example of FIG. 39, the imaging surface 133a is an aspherical surface in which the displacement amount 552 in the direction away from the imaging lens 116 with respect to the spherical surface 551, that is, in the right direction of FIG. 39 increases as the distance from the optical axis 553 increases. This makes it easy to achieve both field curvature correction with a low image height and a high image height. In addition, it is possible to secure a space between the imaging lens 116 or the infrared cut filter 114 and the imaging surface 133a while shortening the optical total length TL₅. As a result, arrangement of mechanical members such as the filter holder 113 is facilitated. As the curvature decreases with distance from the optical axis 553, wire bonding or the like using the wire 134 can be easily performed.

Note that the optical total length TL₅ is a distance on the optical axis 553 from a surface 541a (foremost surface) closest to the object side of the lens 541 closest to the object side among the lenses 541 to 547 to the imaging surface 133a.

The light incident on the imaging lens 116 from the object is emitted via the lenses 541 to 547 and the infrared cut filter 114, and is condensed on the imaging surface 133a.

Note that, hereinafter, the distance on the optical axis 553 from the surface 547b to the imaging surface 133a is referred to as fb₅, and the distance on the optical axis 553 from the aperture stop 532 to the imaging surface 133a is referred to as Ts₅.

### <Fifth Example of Various Setting Values of Entire Imaging Lens>

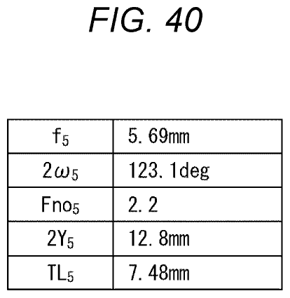

FIG. 40 is a table illustrating an example of various setting values of the entire imaging lens 116 in FIG. 39.

As illustrated in FIG. 40, a focal length f₅ of the entire imaging lens 116 in FIG. 39 is 5.69 mm. The maximum angle of view 2ω₅ of the imaging lens 116 is 123.1 deg. The f-number Fno₅ of the imaging lens 116 is 2.2, which is 2.5 or less. 2Y₅, which is twice the maximum image height Y₅, is 12.8 mm, and the optical total length TL₅ is 7.48 mm.

### <Fifth Example of Various Setting Values of Each Lens, Aperture Stop, Imaging Surface, and Infrared Cut Filter>

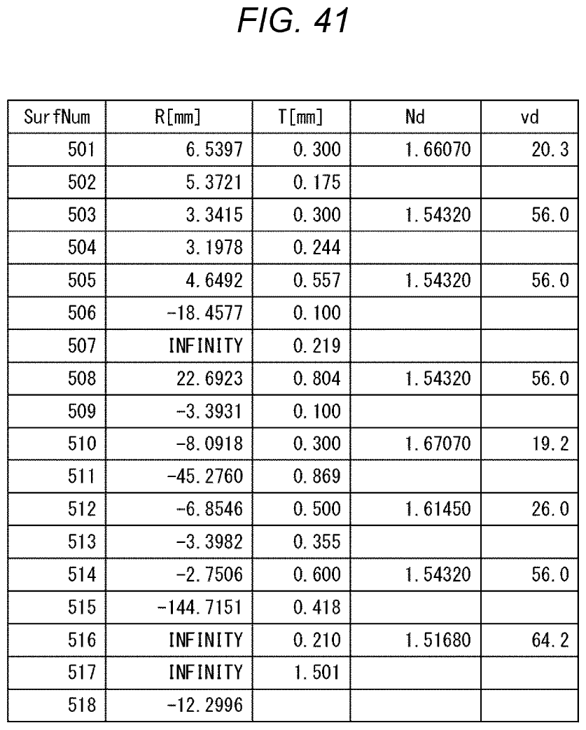

FIG. 41 is a table illustrating examples of various setting values of the lenses 541 to 547, the aperture stop 532, the infrared cut filter 114, and the imaging surface 133a of FIG. 39.

In the first row from the top of the table in FIG. 41, items corresponding to respective columns are described. The second and subsequent rows from the top correspond to the surfaces 541a to 547a and the surfaces 541b to 547b, the surface of the aperture stop 532, the surfaces 114a and 114b, and the imaging surface 133a, respectively. Each column in FIG. 41 is similar to each column in FIG. 17.

In the present specification, it is assumed that surface numbers from 501 to 506 are sequentially assigned to the surfaces 541a, 541b, 542a, 542b, 543a, and 543b. It is assumed that surface numbers from 507 to 518 are sequentially assigned to the surface of the aperture stop 532, the surfaces 544a, 544b, 545a, 545b, 546a, 546b, 547a, 547b, 114a, and 114b, and the imaging surface 133a.

Note that, although not described, the radius of curvature R, the surface spacing T, the refractive index Nd, and the Abbe number vd of each of the surfaces 541a to 547a are values illustrated in the table of FIG. 41. The radius of curvature R and the surface spacing T of the surfaces 541b to 547b are values illustrated in the table of FIG. 41.

Since the surfaces of the aperture stop 532 and the surfaces 114a and 114b are planar, the radius of curvature R corresponding to SurfNum of 507, 516 and 517 is infinite. Note that, although not described, the surface spacing T between the surface of the aperture stop 532 and the surface 114b, and the surface spacing T, the refractive index Nd, and the Abbe number vd of the surface 114a are values illustrated in the table of FIG. 41.

The radius of curvature R of the imaging surface 133a with SurfNum of 518 is −12.2996. Since there is no surface to which 519 following 518 is given as SurfNum, there is no surface spacing T.

### <Fifth Example of Aspherical Data of Each Surface of Lens and Imaging Surface>

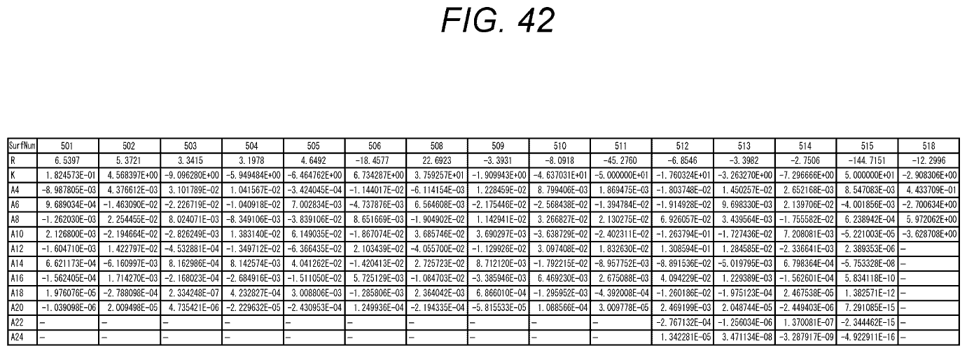

FIG. 42 is a table illustrating an example of aspherical data of the surfaces 541a to 547a and the surfaces 541b to 547b, and the imaging surface 133a of FIG. 39.

In the first column from the left of the table of FIG. 42, items corresponding to each row are described. The second and subsequent columns from the left correspond to the surfaces 541a, 541b, 542a, 542b, 543a, 543b, 544a, 544b, 545a, 545b, 546a, 546b, 547a, and 547b, and the imaging surface 133a in FIG. 39 in order from the left. Each row in FIG. 42 is similar to each row in FIG. 18.

Note that, although not described, the radius of curvature R, the conic coefficient K, and the nth-order aspherical coefficients An (n=2, 4, 6, 8, 10, 12, 14, 16, 18, and 20) of the surfaces 541a to 545a and the surfaces 541b to 545b are values illustrated in the table of FIG. 42. The radius of curvature R, the conic coefficient K, and the nth-order aspherical coefficient An (n=2, 4, 6, 8, 10, 12, 14, 16, 18, 20, 22, and 24) of the surfaces 546a, 546b, 547a, and 547b are values illustrated in the table of FIG. 42. The radius of curvature R, the conic coefficient K, and the nth-order aspherical coefficient An (n=4, 6, 8, and 10) of the imaging surface 133a are values illustrated in the table of FIG. 42.

### <Fifth Example of Spherical Aberration, Field Curvature, and Distortion Aberration>

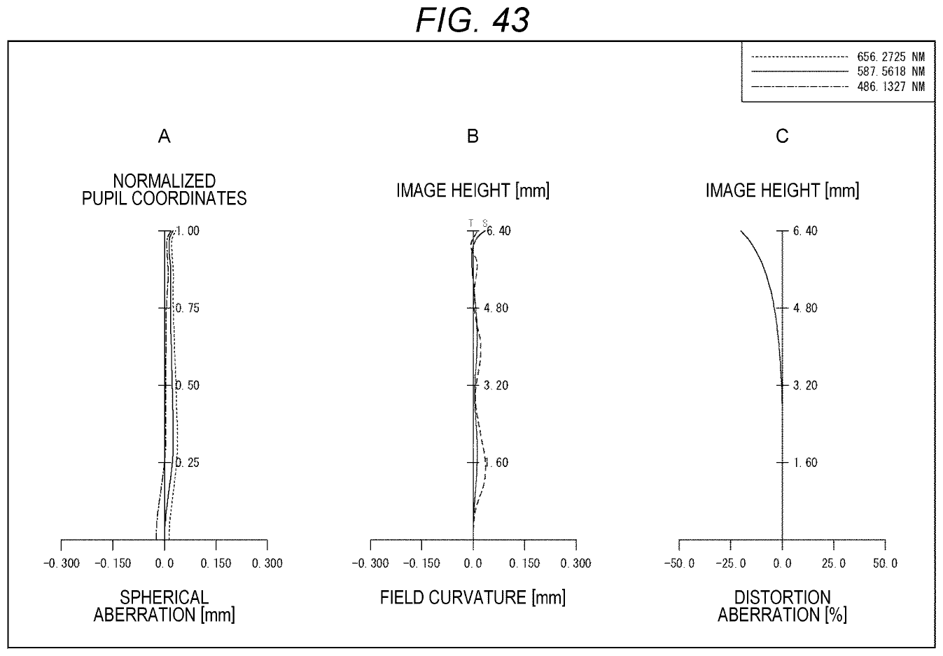

FIG. 43 is a graph illustrating examples of spherical aberration, field curvature, and distortion aberration occurring in the imaging lens 116 of FIG. 39.

A of FIG. 43 is a graph illustrating spherical aberration for each wavelength of light having wavelengths of 486.1327 nm, 587.5618 nm, and 656.2725 nm, which occurs in the imaging lens 116 of FIG. 39. B of FIG. 43 is a graph illustrating field curvature of light having a wavelength of 587.5618 nm generated in the imaging lens 116. C of FIG. 43 is a graph illustrating distortion aberration of light having a wavelength of 587.5618 nm, which occurs in the imaging lens 116.

### <Fifth Example of Lateral Aberration>

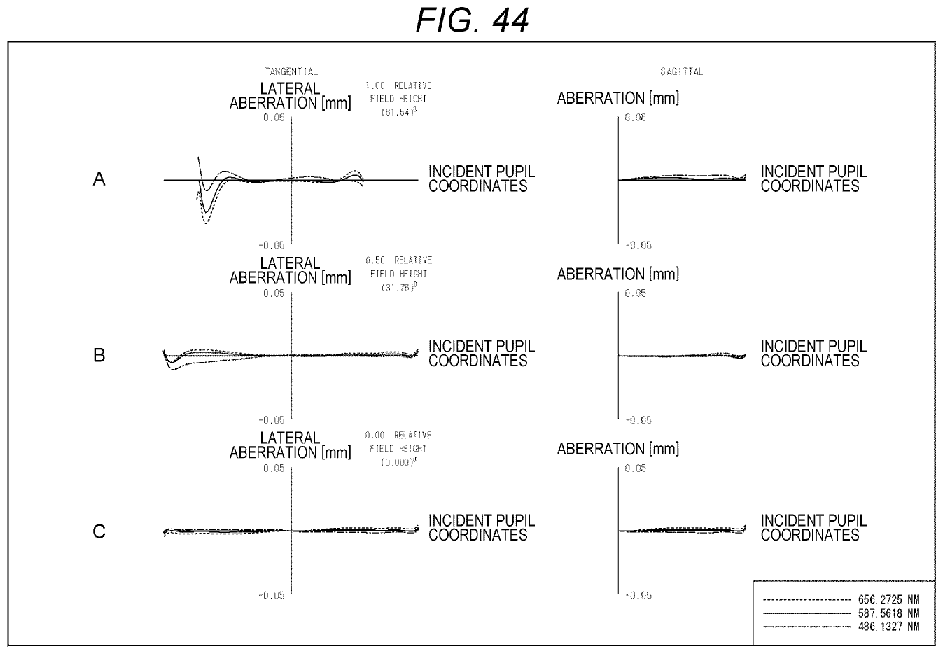

FIG. 44 is a graph illustrating an example of lateral aberration occurring in the imaging lens 116 of FIG. 39.

FIG. 44 is a graph illustrating lateral aberration for each wavelength of light having wavelengths of 486.1327 nm, 587.5618 nm, and 656.2725 nm, which occurs in imaging lens 116.

Specifically, the graphs on the left side in A to C of FIG. 44 represent the lateral aberration in the tangential direction at positions (position of image height in a case where half angle of view is 61.54°, 31.76°, 0°) where the image heights are 1.00 mm, 0.50 mm, and 0.00 mm, respectively. The graphs on the right side in A to C of FIG. 44 represent lateral aberrations in the sagittal direction at positions with image heights of 1.00 mm, 0.50 mm, and 0.00 mm, respectively.

As illustrated in FIGS. 43 and 44, good aberration correction is performed in the imaging lens 116 in FIG. 39, and the imaging lens 116 in FIG. 39 has good imaging quality.

### <Sixth Configuration Example of Imaging Lens>

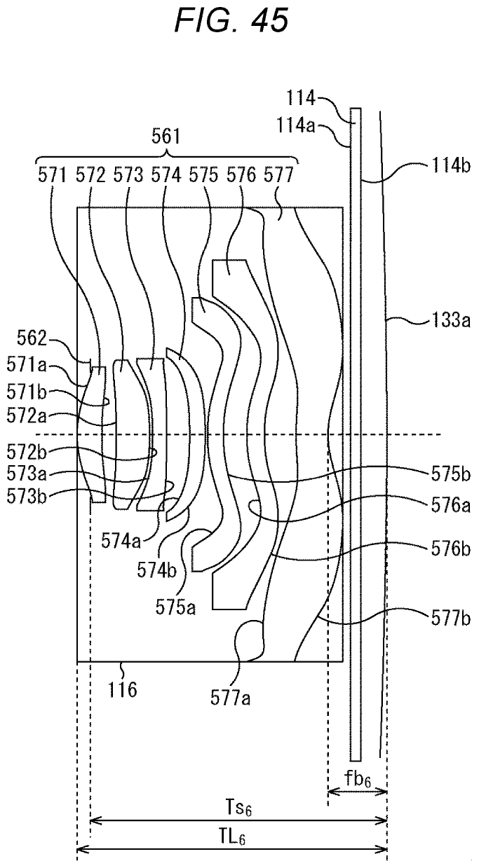

FIG. 45 is a cross-sectional view illustrating a sixth configuration example of the imaging lens 116.

The imaging lens 116 in FIG. 45 includes a lens group 561 and an aperture stop 562.

The lens group 561 includes seven aspherical lenses 571 to 577. The seven lenses 571 to 577 are arranged in order from the object side toward the imaging surface 133a side. The lens 571 has a surface 571a on the object side and a surface 571b on the imaging surface 133a side. Similarly to the lens 571, the lenses 572 to 577 also have surfaces 572a and 572b, surfaces 573a and 573b, surfaces 574a and 574b, surfaces 575a and 575b, surfaces 576a and 576b, and surfaces 577a and 577b, respectively.

The surfaces 571a to 577a and 571b to 577b are aspherical surfaces. The aperture stop 562 is disposed closer to the object side than the lens 571, and limits light incident on the lens 571. In the example of FIG. 45, the imaging surface 133a is a spherical surface.

The light incident on the imaging lens 116 from the object is emitted via the lenses 571 to 577 and the infrared cut filter 114, and is condensed on the imaging surface 133a.

Note that, hereinafter, the optical total length of the imaging lens 116, which is the distance on the optical axis from the surface 571a (foremost surface) closest to the object side of the lens 571 closest to the object side among the lenses 571 to 577 to the imaging surface 133a, is referred to as TL₆. The distance on the optical axis from the surface 577b to the imaging surface 133a is referred to as fb₆, and the distance on the optical axis from the aperture stop 562 to the imaging surface 133a is referred to as Ts₆.

### <Sixth Example of Various Setting Values of Entire Imaging Lens>

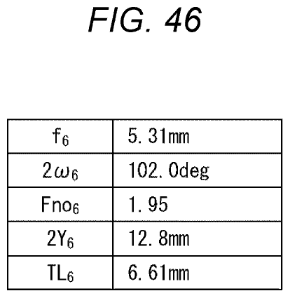

FIG. 46 is a table illustrating an example of various setting values of the entire imaging lens 116 in FIG. 45.

As illustrated in FIG. 46, a focal length f6 of the entire imaging lens 116 in FIG. 45 is 5.31 mm. The maximum angle of view 2ω₆ of the imaging lens 116 is 102.0 deg. The f-number Fno₆ of the imaging lens 116 is 1.95, which is 2.5 or less. 2Y₂, which is twice the maximum image height Y₆, is 12.8 mm, and the optical total length TL₆ is 6.61 mm.

### <Sixth Example of Various Setting Values of Each Lens, Aperture Stop, Imaging Surface, and Infrared Cut Filter>

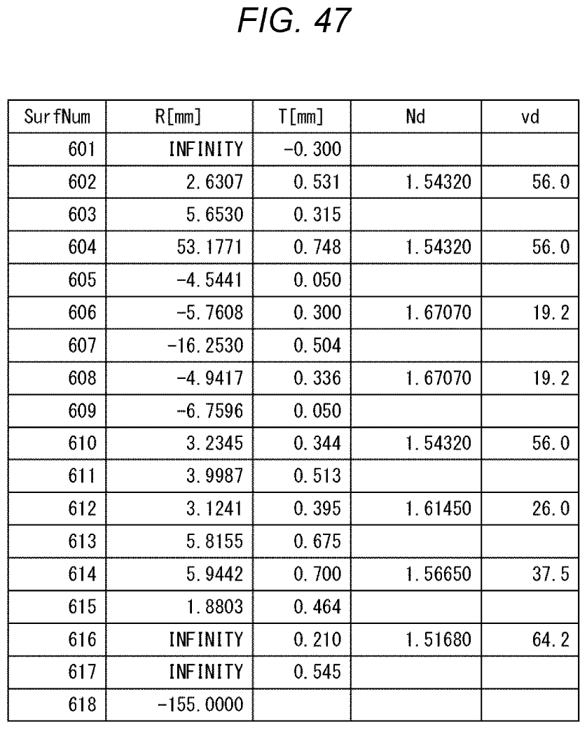

FIG. 47 is a table illustrating examples of various setting values of the lenses 571 to 577, the aperture stop 562, the infrared cut filter 114, and the imaging surface 133a of FIG. 45.

In the first row from the top of the table in FIG. 47, items corresponding to respective columns are described. The second and subsequent rows from the top correspond to the surfaces of the aperture stop 562, the surfaces 571a to 577a and the surfaces 571b to 577b, the surfaces 114a and 114b, and the imaging surface 133a, respectively. Each column in FIG. 47 is similar to each column in FIG. 17.

In the present specification, it is assumed that surface numbers from 601 to 605 are sequentially assigned to the surface of the aperture stop 562 and the surfaces 571a, 571b, 572a, and 572b. It is assumed that surface numbers from 606 to 618 are sequentially assigned to the surfaces 573a, 573b, 574a, 574b, 575a, 575b, 576a, 576b, 577a, 577b, 114a, and 114b, and the imaging surface 133a.

Note that, although not described, the radius of curvature R, the surface spacing T, the refractive index Nd, and the Abbe number vd of each of the surfaces 571a to 577a are values illustrated in the table of FIG. 47. The radius of curvature R and the surface spacing T of the surfaces 571b to 577b are values illustrated in the table of FIG. 47.

Since the surfaces of the aperture stop 562 and the surfaces 114a and 114b are planar, the radius of curvature R corresponding to SurfNum of 601, 616 and 617 is infinite. Note that, although not described, the surface spacing T between the surface of the aperture stop 562 and the surface 114b, and the surface spacing T, the refractive index Nd, and the Abbe number vd of the surface 114a are values illustrated in the table of FIG. 47.

The radius of curvature R of the imaging surface 133a with SurfNum of 618 is −155.000. Since there is no surface to which 619 following 618 is given as SurfNum, there is no surface spacing T.

### <Sixth Example of Aspherical Data of Each Surface of Lens>

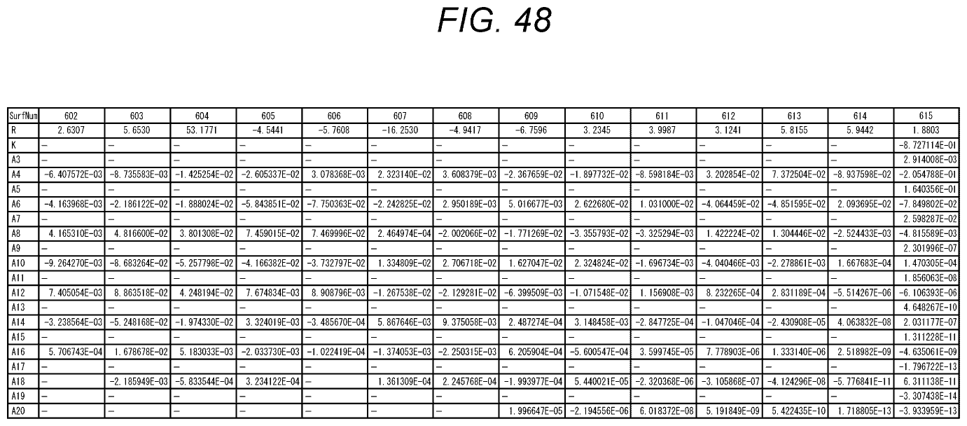

FIG. 48 is a table illustrating an example of aspherical data of the surfaces 571a to 577a and the surfaces 571b to 577b.

In the first column from the left of the table of FIG. 48, items corresponding to each row are described. The second and subsequent columns from the left correspond to the surfaces 571a, 571b, 572a, 572b, 573a, 573b, 574a, 574b, 575a, 575b, 576a, 576b, 577a, and 577b in order from the left. Each row in FIG. 48 corresponds to the items of SurfNum, the radius of curvature R, the conic coefficient K, and the third-order aspherical coefficients A3 to 20th order aspherical coefficients A20 in order from the top.

Note that, although not described, the radius of curvature R and the nth-order aspherical coefficients An (n=4, 6, 8, 10, 12, 14, and 16) of the surfaces 571a and 573a are values illustrated in the table of FIG. 48. The radius of curvature R and the nth-order aspherical coefficients An (n=4, 6, 8, 10, 12, 14, 16, and 18) of the surfaces 571b to 573b, 572a, and 574a are values illustrated in the table of FIG. 48. The radius of curvature R and the nth-order aspherical coefficients An (n=4, 6, 8, 10, 12, 14, 16, 18, and 20) of the surfaces 575a to 577a and 574b to 576b are values illustrated in the table of FIG. 48. The radius of curvature R, the conic coefficient K, and the third-order aspherical coefficients A3 to 20th order aspherical coefficients A20 of the surface 577b are values illustrated in the table of FIG. 48.

### <Sixth Example of Spherical Aberration, Field Curvature, and Distortion Aberration>

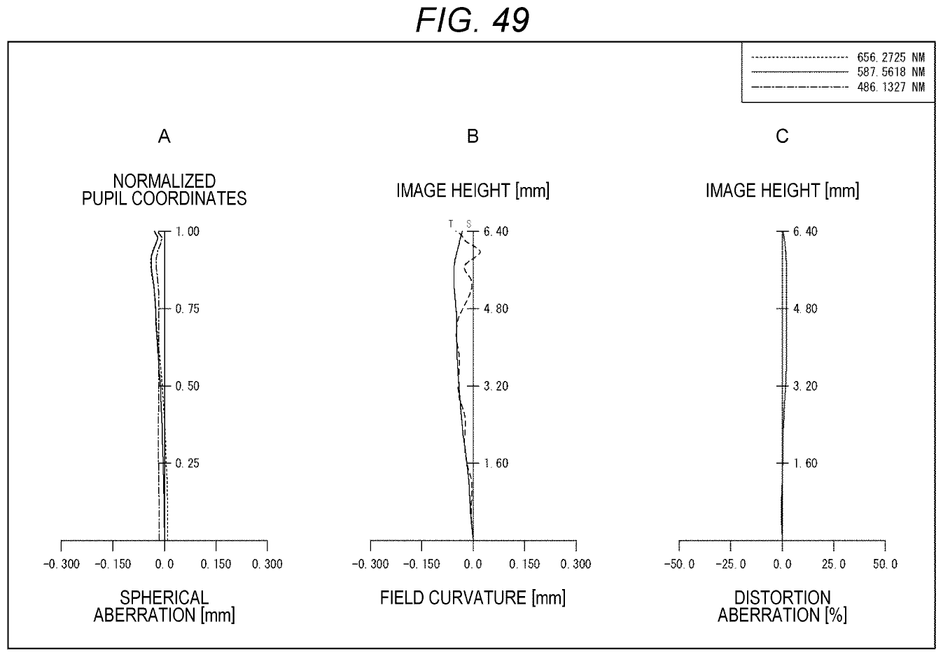

FIG. 49 is a graph illustrating examples of spherical aberration, field curvature, and distortion aberration occurring in the imaging lens 116 of FIG. 45.

A of FIG. 49 is a graph illustrating spherical aberration for each wavelength of light having wavelengths of 486.1327 nm, 587.5618 nm, and 656.2725 nm, which occurs in the imaging lens 116 of FIG. 45. B of FIG. 49 is a graph illustrating field curvature of light having a wavelength of 587.5618 nm generated in the imaging lens 116. C of FIG. 49 is a graph illustrating distortion aberration of light having a wavelength of 587.5618 nm, which occurs in the imaging lens 116.

### <Sixth Example of Lateral Aberration>

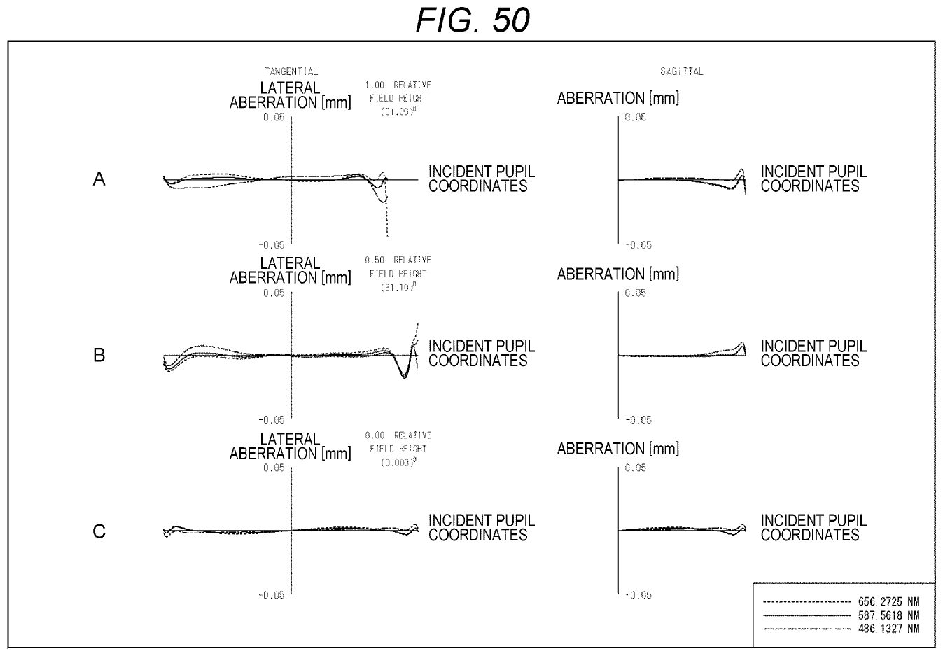

FIG. 50 is a graph illustrating an example of lateral aberration occurring in the imaging lens 116 of FIG. 45.

FIG. 50 is a graph illustrating lateral aberration for each wavelength of light having wavelengths of 486.1327 nm, 587.5618 nm, and 656.2725 nm, which occurs in imaging lens 116.

Specifically, the graphs on the left side in A to C of FIG. 50 represent the lateral aberration in the tangential direction at positions (position of image height in a case where half angle of view is 51.00°, 31.10°, 0°) where the image heights are 1.00 mm, 0.65 mm, and 0.00 mm, respectively. The graphs on the right side in A to C of FIG. 50 represent lateral aberrations in the sagittal direction at positions with image heights of 1.00 mm, 0.65 mm, and 0.00 mm, respectively.

As illustrated in FIGS. 49 and 50, good aberration correction is performed in the imaging lens 116 in FIG. 45, and the imaging lens 116 in FIG. 45 has good imaging quality.

### <Seventh Configuration Example of Imaging Lens>

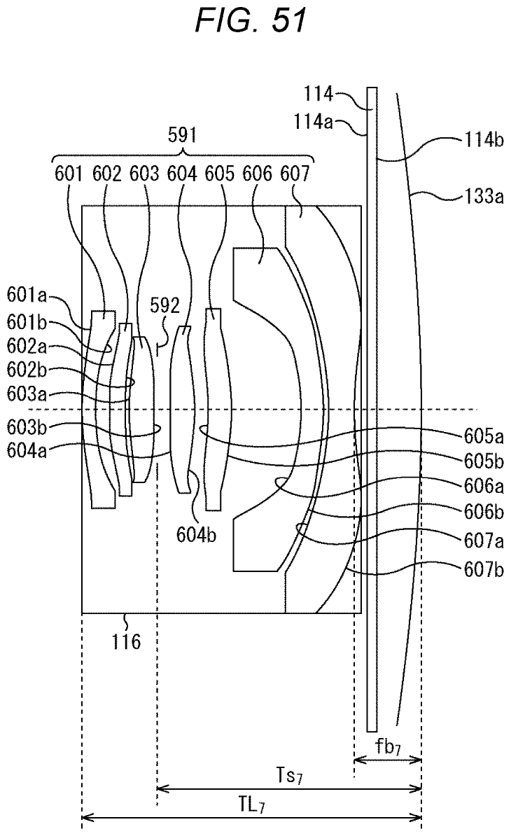

FIG. 51 is a cross-sectional view illustrating a seventh configuration example of the imaging lens 116.

The imaging lens 116 in FIG. 51 includes a lens group 591 and an aperture stop 592.

The lens group 591 includes seven aspherical lenses 601 to 607. The seven lenses 601 to 607 are arranged in order from the object side toward the imaging surface 133a side. The lens 601 has a surface 601a on the object side and a surface 601b on the imaging surface 133a side. Similarly to the lens 601, the lenses 602 to 607 also have surfaces 602a and 602b, surfaces 603a and 603b, surfaces 604a and 604b, surfaces 605a and 605b, surfaces 606a and 606b, and surfaces 607a and 607b, respectively.

The surfaces 601a to 607a and 601b to 607b are aspherical surfaces. The aperture stop 592 is disposed between the lenses 603 and 604, and limits light incident on the lens 603 from the lens 604. In the example of FIG. 51, the imaging surface 133a is a spherical surface.

The light incident on the imaging lens 116 from the object is emitted via the lenses 601 to 607 and the infrared cut filter 114, and is condensed on the imaging surface 133a.

Note that, hereinafter, the optical total length of the imaging lens 116, which is the distance on the optical axis from the surface 601a (foremost surface) closest to the object side of the lens 601 closest to the object side among the lenses 601 to 607 to the imaging surface 133a, is referred to as TL₇. The distance on the optical axis from the surface 607b to the imaging surface 133a is referred to as fb₇, and the distance on the optical axis from the aperture stop 592 to the imaging surface 133a is referred to as Ts₇.

### <Seventh Example of Various Setting Values of Entire Imaging Lens>

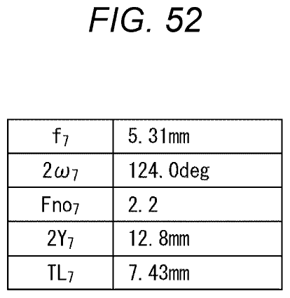

FIG. 52 is a table illustrating an example of various setting values of the entire imaging lens 116 in FIG. 51.

As illustrated in FIG. 52, a focal length f7 of the entire imaging lens 116 in FIG. 51 is 5.31 mm. The maximum angle of view 2ω₇ of the imaging lens 116 is 124.0 deg. The f-number Fno₇ of the imaging lens 116 is 2.2, which is 2.5 or less. 2Y₇, which is twice the maximum image height Y₇, is 12.8 mm, and the optical total length TL₇ is 7.43 mm.

### <Seventh Example of Various Setting Values of Each Lens, Aperture Stop, Imaging Surface, and Infrared Cut Filter>

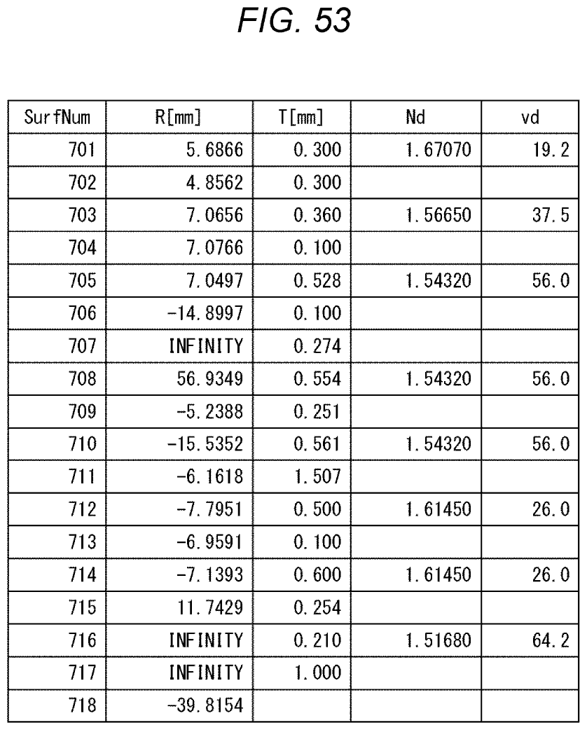

FIG. 53 is a table illustrating examples of various setting values of the lenses 601 to 607, the aperture stop 592, the infrared cut filter 114, and the imaging surface 133a of FIG. 51.

In the first row from the top of the table in FIG. 53, items corresponding to respective columns are described. The second and subsequent rows from the top correspond to the surfaces 601a to 607a and the surfaces 601b to 607b, the surface of the aperture stop 592, the surfaces 114a and 114b, and the imaging surface 133a, respectively. Each column in FIG. 53 is similar to each column in FIG. 17.

In the present specification, it is assumed that surface numbers from 701 to 706 are sequentially assigned to the surfaces 601a, 601b, 602a, 602b, 603a, and 603b. It is assumed that surface numbers from 707 to 718 are sequentially assigned to the surface of the aperture stop 592, the surfaces 604a, 604b, 605a, 605b, 606a, 606b, 607a, 607b, 114a, and 114b, and the imaging surface 133a.

Note that, although not described, the radius of curvature R, the surface spacing T, the refractive index Nd, and the Abbe number vd of each of the surfaces 601a to 607a are values illustrated in the table of FIG. 53. The radius of curvature R and the surface spacing T of the surfaces 601b to 607b are values illustrated in the table of FIG. 53.

Since the surfaces of the aperture stop 592 and the surfaces 114a and 114b are planar, the radius of curvature R corresponding to SurfNum of 707, 716 and 717 is infinite. Note that, although not described, the surface spacing T between the surface of the aperture stop 592 and the surface 114b, and the surface spacing T, the refractive index Nd, and the Abbe number vd of the surface 114a are values illustrated in the table of FIG. 53.

The radius of curvature R of the imaging surface 133a with SurfNum of 718 is −39.8154. Since there is no surface to which 719 following 718 is given as SurfNum, there is no surface spacing T.

### <Seventh Example of Aspherical Data of Each Surface of Lens>

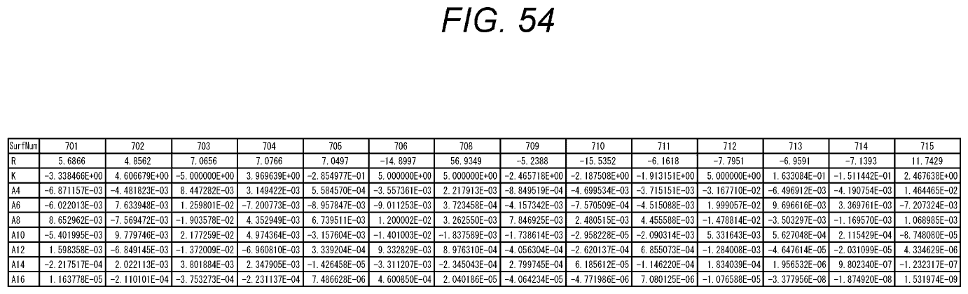

FIG. 54 is a table illustrating an example of aspherical data of the surfaces 601a to 607a and the surfaces 601b to 607b.

In the first column from the left of the table of FIG. 54, items corresponding to each row are described. The second and subsequent columns from the left correspond to the surfaces 601a, 601b, 602a, 602b, 603a, 603b, 604a, 604b, 605a, 605b, 606a, 606b, 607a, and 607b in order from the left. Each row in FIG. 54 corresponds to the items of SurfNum, the radius of curvature R, the conic coefficient K, and the nth-order aspherical coefficient An (n=4, 6, 8, 10, 12, 14, and 16) in order from the top.

Note that, although not described, the radius of curvature R, the conic coefficient K, and the nth-order aspherical coefficients An (n=4, 6, 8, 10, 12, 14, and 16) of the surfaces 601a to 607a and the surfaces 601b to 607b are values illustrated in the table of FIG. 54.

### <Seventh Example of Spherical Aberration, Field Curvature, and Distortion Aberration>

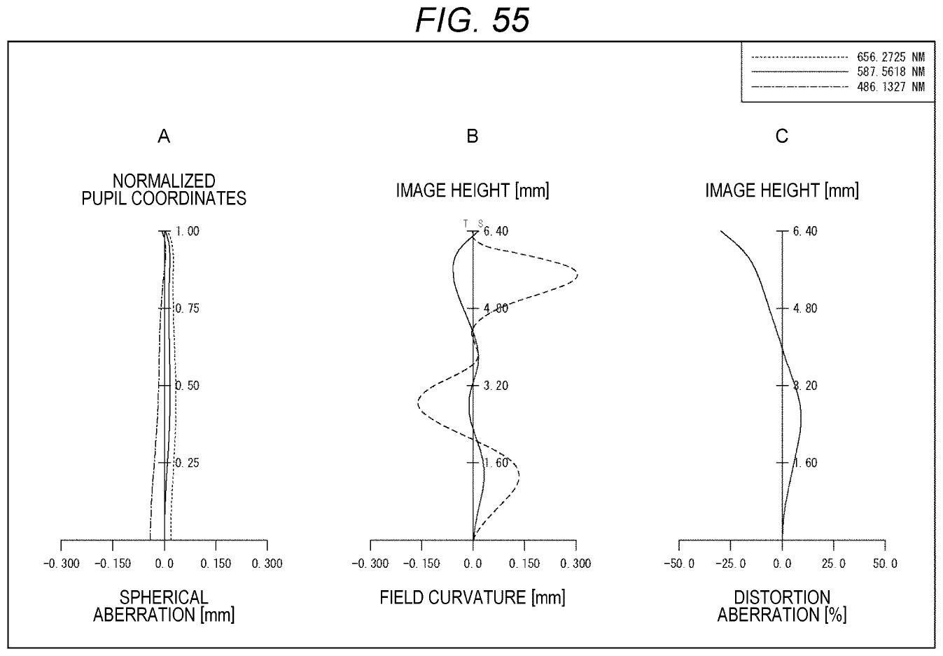

FIG. 55 is a graph illustrating examples of spherical aberration, field curvature, and distortion aberration occurring in the imaging lens 116 of FIG. 51.

A of FIG. 55 is a graph illustrating spherical aberration for each wavelength of light having wavelengths of 486.1327 nm, 587.5618 nm, and 656.2725 nm, which occurs in the imaging lens 116 of FIG. 51. B of FIG. 55 is a graph illustrating field curvature of light having a wavelength of 587.5618 nm generated in the imaging lens 116. C of FIG. 55 is a graph illustrating distortion aberration of light having a wavelength of 587.5618 nm, which occurs in the imaging lens 116.

### <Seventh Example of Lateral Aberration>

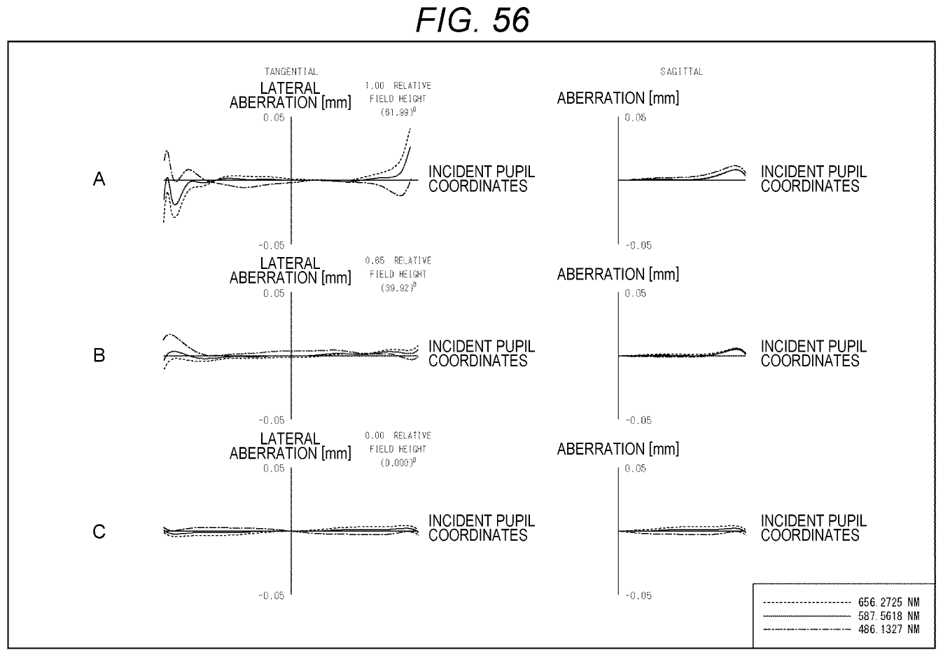

FIG. 56 is a graph illustrating an example of lateral aberration occurring in the imaging lens 116 of FIG. 51.

FIG. 56 is a graph illustrating lateral aberration for each wavelength of light having wavelengths of 486.1327 nm, 587.5618 nm, and 656.2725 nm, which occurs in imaging lens 116.

Specifically, the graphs on the left side in A to C of FIG. 56 represent the lateral aberration in the tangential direction at positions (position of image height in a case where half angle of view is 61.99°, 39.92°, 0°) where the image heights are 1.00 mm, 0.65 mm, and 0.00 mm, respectively. The graphs on the right side in A to C of FIG. 56 represent lateral aberrations in the sagittal direction at positions with image heights of 1.00 mm, 0.65 mm, and 0.00 mm, respectively.

As illustrated in FIGS. 55 and 56, good aberration correction is performed in the imaging lens 116 in FIG. 51, and the imaging lens 116 in FIG. 51 has good imaging quality.

### <Eighth Configuration Example of Imaging Lens>

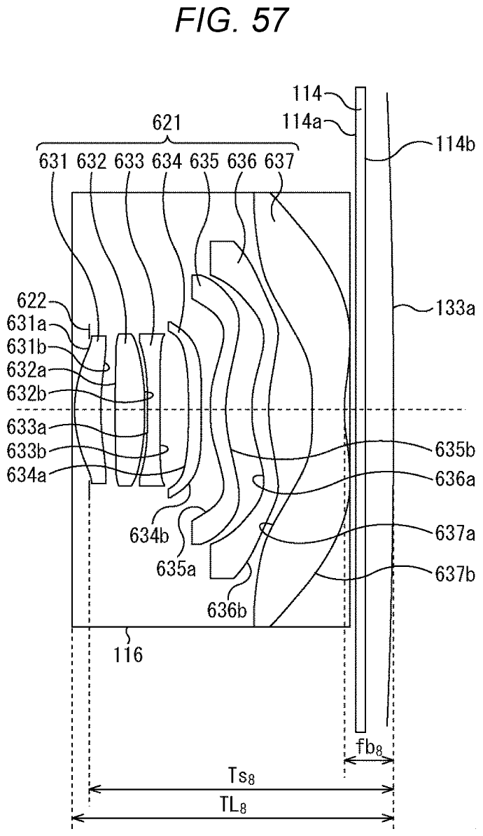

FIG. 57 is a cross-sectional view illustrating an eighth configuration example of the imaging lens 116.

The imaging lens 116 in FIG. 57 includes a lens group 621 and an aperture stop 622.

The lens group 621 includes seven aspherical lenses 631 to 637. The seven lenses 631 to 637 are arranged in order from the object side toward the imaging surface 133a side. The lens 631 has a surface 631a on the object side and a surface 631b on the imaging surface 133a side. Similarly to the lens 631, the lenses 632 to 637 also have surfaces 632a and 632b, surfaces 633a and 633b, surfaces 634a and 634b, surfaces 635a and 635b, surfaces 636a and 636b, and surfaces 637a and 637b, respectively.

The surfaces 631a to 637a and 631b to 637b are aspherical surfaces. The aperture stop 622 is disposed closer to the object side than the lens 631, and limits light incident on the lens 631. In the example of FIG. 57, the imaging surface 133a is a spherical surface.

The light incident on the imaging lens 116 from the object is emitted via the lenses 631 to 637 and the infrared cut filter 114, and is condensed on the imaging surface 133a.

Note that, hereinafter, the optical total length of the imaging lens 116, which is the distance on the optical axis from the surface 631a (foremost surface) closest to the object side of the lens 631 closest to the object side among the lenses 631 to 637 to the imaging surface 133a, is referred to as TL₈. The distance on the optical axis from the surface 637b to the imaging surface 133a is referred to as fb₈, and the distance on the optical axis from the aperture stop 622 to the imaging surface 133a is referred to as Ts₈.

### <Eighth Example of Various Setting Values of Entire Imaging Lens>

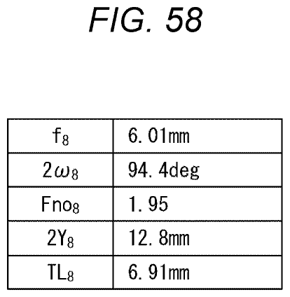

FIG. 58 is a table illustrating an example of various setting values of the entire imaging lens 116 in FIG. 57.

As illustrated in FIG. 58, a focal length f₈ of the entire imaging lens 116 in FIG. 57 is 6.01 mm. The maximum angle of view 2ω₈ of the imaging lens 116 is 94.4 deg. The f-number Fno₈ of the imaging lens 116 is 1.95, which is 2.5 or less. 2Y₈, which is twice the maximum image height Y₈, is 12.8 mm, and the optical total length TL₈ is 6.91 mm.

### <Eighth Example of Various Setting Values of Each Lens, Aperture Stop, Imaging Surface, and Infrared Cut Filter>

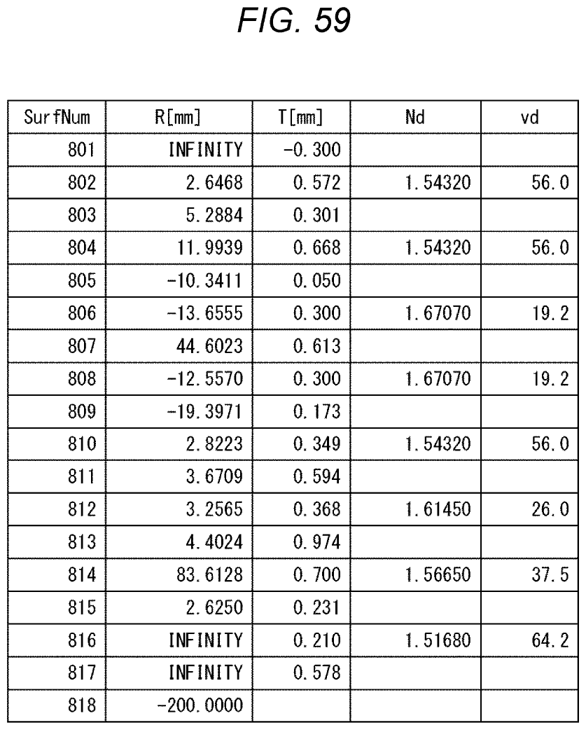

FIG. 59 is a table illustrating examples of various setting values of the lenses 631 to 637, the aperture stop 622, the infrared cut filter 114, and the imaging surface 133a of FIG. 57.

In the first row from the top of the table in FIG. 59, items corresponding to respective columns are described. The second and subsequent rows from the top correspond to the surfaces of the aperture stop 622, the surfaces 631a to 637a and the surfaces 631b to 637b, the surfaces 114a and 114b, and the imaging surface 133a, respectively. Each column in FIG. 59 is similar to each column in FIG. 17.

In the present specification, it is assumed that surface numbers from 801 to 805 are sequentially assigned to the surface of the aperture stop 622 and the surfaces 631a, 631b, 632a, and 632b. It is assumed that surface numbers from 806 to 818 are sequentially assigned to the surfaces 633a, 633b, 634a, 634b, 635a, 635b, 636a, 636b, 637a, 637b, 114a, and 114b, and the imaging surface 133a.

Note that, although not described, the radius of curvature R, the surface spacing T, the refractive index Nd, and the Abbe number vd of each of the surfaces 631a to 637a are values illustrated in the table of FIG. 59. The radius of curvature R and the surface spacing T of the surfaces 631b to 637b are values illustrated in the table of FIG. 59.

Since the surfaces of the aperture stop 622 and the surfaces 114a and 114b are planar, the radius of curvature R corresponding to SurfNum of 801, 816 and 817 is infinite. Note that, although not described, the surface spacing T between the surface of the aperture stop 622 and the surface 114b, and the surface spacing T, the refractive index Nd, and the Abbe number vd of the surface 114a are values illustrated in the table of FIG. 59.

The radius of curvature R of the imaging surface 133a with SurfNum of 818 is −200.000. Since there is no surface to which 819 following 818 is given as SurfNum, there is no surface spacing T.

### <Eighth Example of Aspherical Data of Each Surface of Lens>

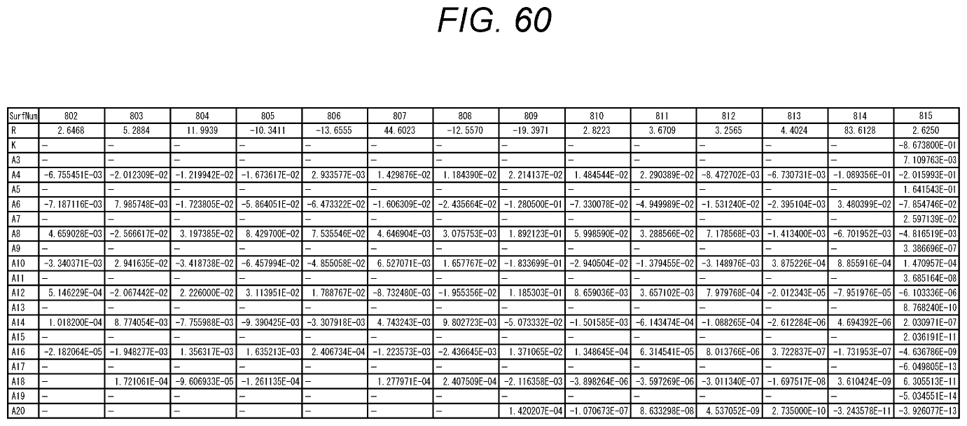

FIG. 60 is a table illustrating an example of aspherical data of the surfaces 631a to 637a and the surfaces 631b to 637b.

In the first column from the left of the table of FIG. 60, items corresponding to each row are described. The second and subsequent columns from the left correspond to the surfaces 631a, 631b, 632a, 632b, 633a, 633b, 634a, 634b, 635a, 635b, 636a, 636b, 637a, and 637b in order from the left. Each row in FIG. 60 is similar to each row in FIG. 48.

Note that, although not described, the radius of curvature R and the nth-order aspherical coefficients An (n=4, 6, 8, 10, 12, 14, and 16) of the surfaces 631a and 633a are values illustrated in the table of FIG. 60. The radius of curvature R and the nth-order aspherical coefficients An (n=4, 6, 8, 10, 12, 14, 16, and 18) of the surfaces 631b to 633b, 632a, and 634a are values illustrated in the table of FIG. 60. The radius of curvature R and the nth-order aspherical coefficients An (n=4, 6, 8, 10, 12, 14, 16, 18, and 20) of the surfaces 635a to 637a and 634b to 636b are values illustrated in the table of FIG. 60. The radius of curvature R, the conic coefficient K, and the third-order aspherical coefficients A3 to 20th order aspherical coefficients A20 of the surface 637b are values illustrated in the table of FIG. 60.

### <Eighth Example of Spherical Aberration, Field Curvature, and Distortion Aberration>

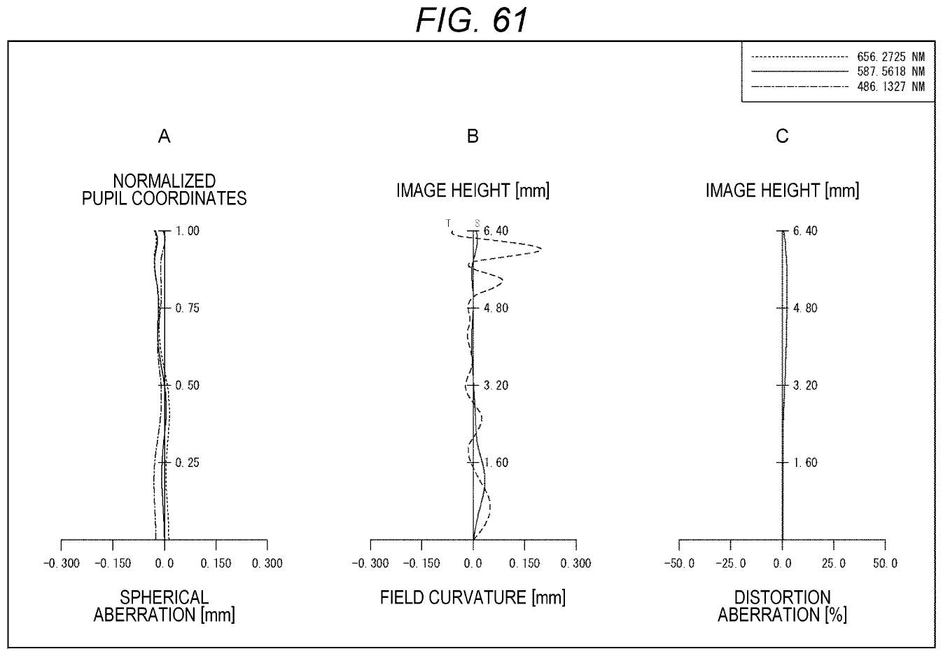

FIG. 61 is a graph illustrating examples of spherical aberration, field curvature, and distortion aberration occurring in the imaging lens 116 of FIG. 57.

A of FIG. 61 is a graph illustrating spherical aberration for each wavelength of light having wavelengths of 486.1327 nm, 587.5618 nm, and 656.2725 nm, which occurs in the imaging lens 116 of FIG. 57. B of FIG. 61 is a graph illustrating field curvature of light having a wavelength of 587.5618 nm generated in the imaging lens 116. C of FIG. 61 is a graph illustrating distortion aberration of light having a wavelength of 587.5618 nm, which occurs in the imaging lens 116.

### <Eighth Example of Lateral Aberration>

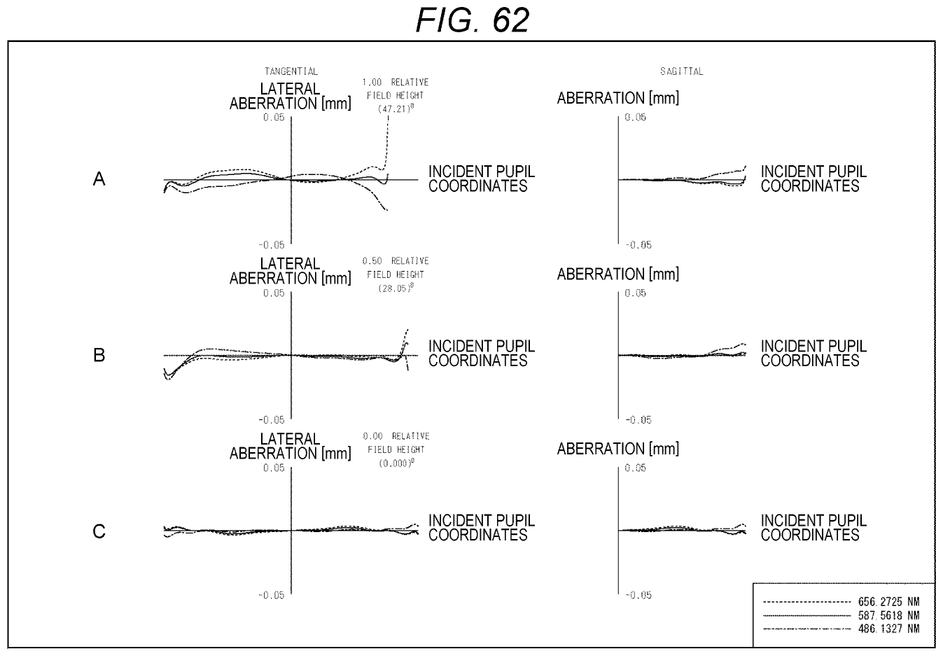

FIG. 62 is a graph illustrating an example of lateral aberration occurring in the imaging lens 116 of FIG. 57.

FIG. 62 is a graph illustrating lateral aberration for each wavelength of light having wavelengths of 486.1327 nm, 587.5618 nm, and 656.2725 nm, which occurs in imaging lens 116.

Specifically, the graphs on the left side in A to C of FIG. 62 represent the lateral aberration in the tangential direction at positions (position of image height in a case where half angle of view is 47, 21°, 28.05°, 0°) where the image heights are 1.00 mm, 0.50 mm, and 0.00 mm, respectively. The graphs on the right side in A to C of FIG. 62 represent lateral aberrations in the sagittal direction at positions with image heights of 1.00 mm, 0.50 mm, and 0.00 mm, respectively.

As illustrated in FIGS. 61 and 62, good aberration correction is performed in the imaging lens 116 in FIG. 57, and the imaging lens 116 in FIG. 57 has good imaging quality.

### <Ninth Configuration Example of Imaging Lens>

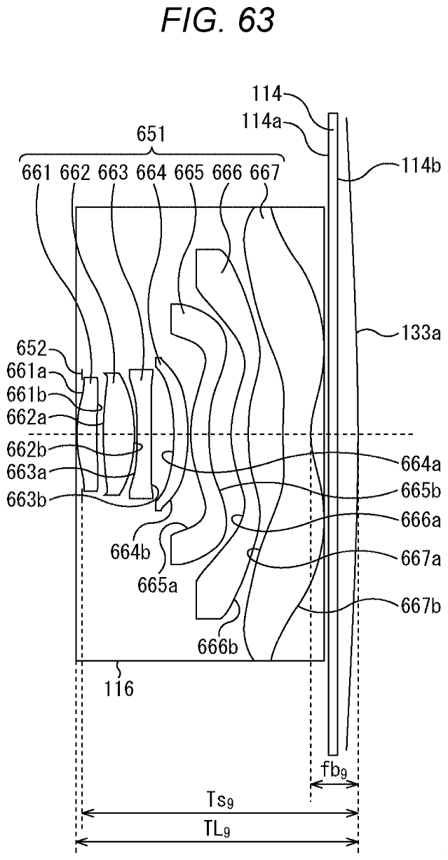

FIG. 63 is a cross-sectional view illustrating a ninth configuration example of the imaging lens 116.

The imaging lens 116 in FIG. 63 includes a lens group 651 and an aperture stop 652.

The lens group 651 includes seven aspherical lenses 661 to 667. The seven lenses 661 to 667 are arranged in order from the object side toward the imaging surface 133a side. The lens 661 has a surface 661a on the object side and a surface 661b on the imaging surface 133a side. Similarly to the lens 661, the lenses 662 to 667 also have surfaces 662a and 662b, surfaces 663a and 663b, surfaces 664a and 664b, surfaces 665a and 665b, surfaces 666a and 666b, and surfaces 667a and 667b, respectively.

The surfaces 661a to 667a and 661b to 667b are aspherical surfaces. The aperture stop 652 is disposed closer to the object side than the lens 661, and limits light incident on the lens 661. In the example of FIG. 63, the imaging surface 133a is a spherical surface.

The light incident on the imaging lens 116 from the object is emitted via the lenses 661 to 667 and the infrared cut filter 114, and is condensed on the imaging surface 133a.

Note that, hereinafter, the optical total length of the imaging lens 116, which is the distance on the optical axis from the surface 661a (foremost surface) closest to the object side of the lens 661 closest to the object side among the lenses 661 to 667 to the imaging surface 133a, is referred to as TL₉. The distance on the optical axis from the surface 667b to the imaging surface 133a is referred to as fb₉, and the distance on the optical axis from the aperture stop 652 to the imaging surface 133a is referred to as Ts₉.

### <Ninth Example of Various Setting Values of Entire Imaging Lens>

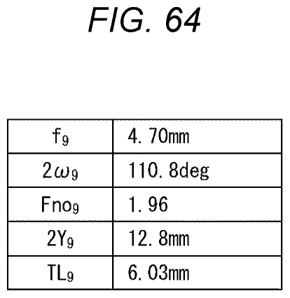

FIG. 64 is a table illustrating an example of various setting values of the entire imaging lens 116 in FIG. 63.

As illustrated in FIG. 64, a focal length f9 of the entire imaging lens 116 in FIG. 63 is 4.70 mm. The maximum angle of view 2ω₉ of the imaging lens 116 is 110.8 deg. The F-number Fno₉ of the imaging lens 116 is 1.96, which is 2.5 or less. 2Y₉, which is twice the maximum image height Y₉, is 12.8 mm, and the optical total length TL₉ is 6.03 mm.

### <Ninth Example of Various Setting Values of Each Lens, Aperture Stop, Imaging Surface, and Infrared Cut Filter>

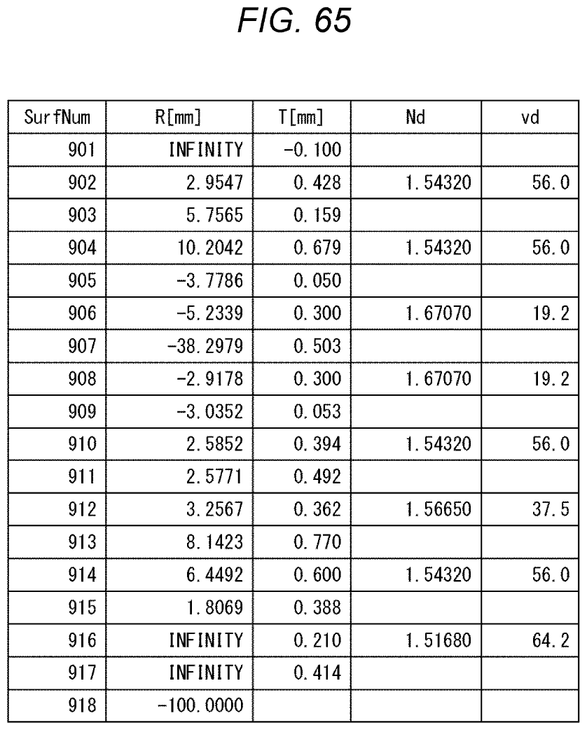

FIG. 65 is a table illustrating examples of various setting values of the lenses 661 to 667, the aperture stop 652, the infrared cut filter 114, and the imaging surface 133a of FIG. 63.

In the first row from the top of the table in FIG. 65, items corresponding to respective columns are described. The second and subsequent rows from the top correspond to the surfaces of the aperture stop 652, the surfaces 661a to 667a and the surfaces 661b to 667b, the surfaces 114a and 114b, and the imaging surface 133a, respectively. Each column in FIG. 65 is similar to each column in FIG. 17.

In the present specification, it is assumed that surface numbers from 901 to 905 are sequentially assigned to the surface of the aperture stop 652 and the surfaces 661a, 661b, 662a, and 662b. It is assumed that surface numbers from 906 to 918 are sequentially assigned to the surfaces 663a, 663b, 664a, 664b, 665a, 665b, 666a, 666b, 667a, 667b, 114a, and 114b, and the imaging surface 133a.

Note that, although not described, the radius of curvature R, the surface spacing T, the refractive index Nd, and the Abbe number vd of each of the surfaces 661a to 667a are values illustrated in the table of FIG. 65. The radius of curvature R and the surface spacing T of the surfaces 661b to 667b are values illustrated in the table of FIG. 65.

Since the surfaces of the aperture stop 652 and the surfaces 114a and 114b are planar, the radius of curvature R corresponding to SurfNum of 901, 916 and 917 is infinite. Note that, although not described, the surface spacing T between the surface of the aperture stop 652 and the surface 114b, and the surface spacing T, the refractive index Nd, and the Abbe number vd of the surface 114a are values illustrated in the table of FIG. 65.

The radius of curvature R of the imaging surface 133a with SurfNum of 918 is −100.000. Since there is no surface to which 919 following 918 is given as SurfNum, there is no surface spacing T.

### <Ninth Example of Aspherical Data of Each Surface of Lens>

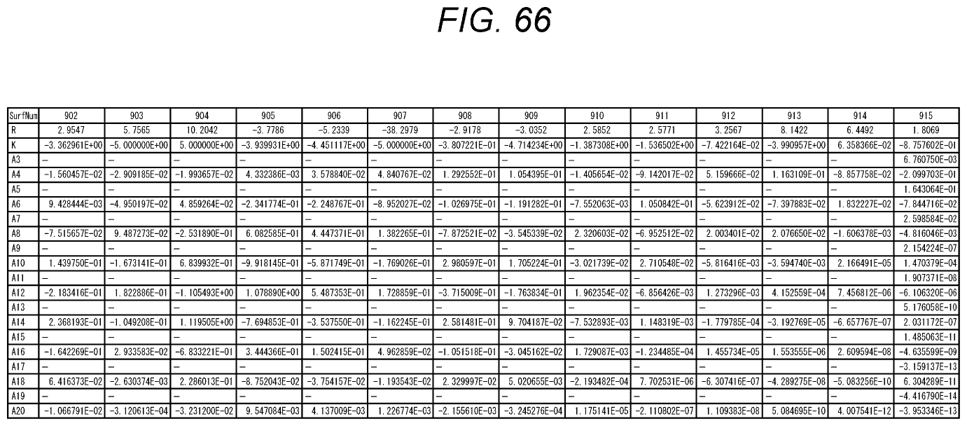

FIG. 66 is a table illustrating an example of aspherical data of the surfaces 661a to 667a and the surfaces 661b to 667b.

In the first column from the left of the table of FIG. 66, items corresponding to each row are described. The second and subsequent columns from the left correspond to the surfaces 661a, 661b, 662a, 662b, 663a, 663b, 664a, 664b, 665a, 665b, 666a, 666b, 667a, and 667b in order from the left. Each row in FIG. 66 is similar to each row in FIG. 48.

Note that, although not described, the radius of curvature R, the conic coefficient K, and the nth-order aspherical coefficients An (n=4, 6, 8, 10, 12, 14, 16, 18, and 20) of the surfaces 661a to 667a and the surfaces 661b to 666b are values illustrated in the table of FIG. 66. The radius of curvature R, the conic coefficient K, and the third-order aspherical coefficients A3 to 20th order aspherical coefficients A20 of the surface 667b are values illustrated in the table of FIG. 66.

### <Ninth Example of Spherical Aberration, Field Curvature, and Distortion Aberration>

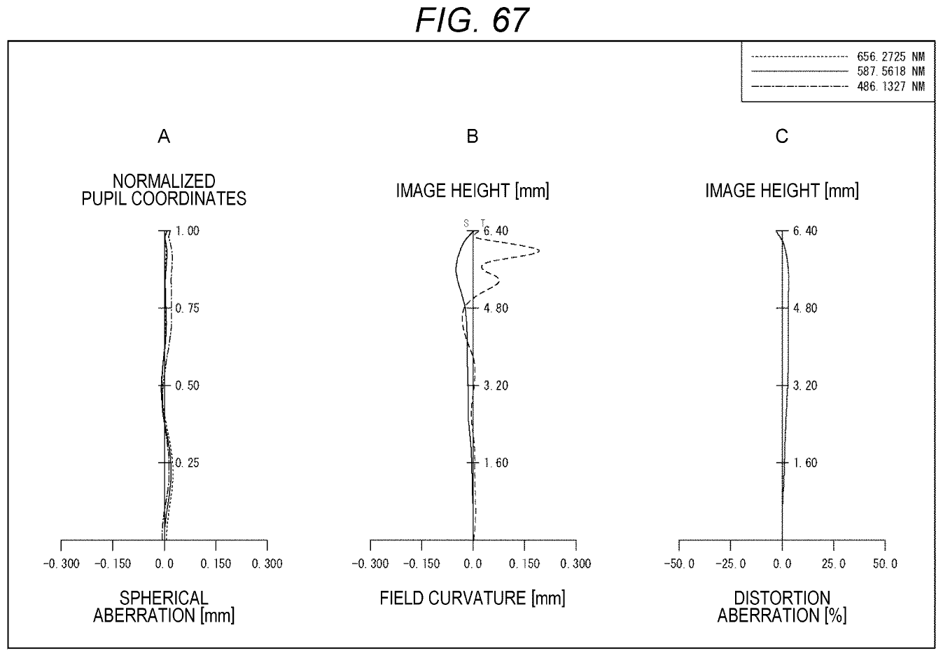

FIG. 67 is a graph illustrating examples of spherical aberration, field curvature, and distortion aberration occurring in the imaging lens 116 of FIG. 63.

A of FIG. 67 is a graph illustrating spherical aberration for each wavelength of light having wavelengths of 486.1327 nm, 587.5618 nm, and 656.2725 nm, which occurs in the imaging lens 116 of FIG. 63. B of FIG. 67 is a graph illustrating field curvature of light having a wavelength of 587.5618 nm generated in the imaging lens 116. C of FIG. 67 is a graph illustrating distortion aberration of light having a wavelength of 587.5618 nm, which occurs in the imaging lens 116.

### <Ninth Example of Lateral Aberration>

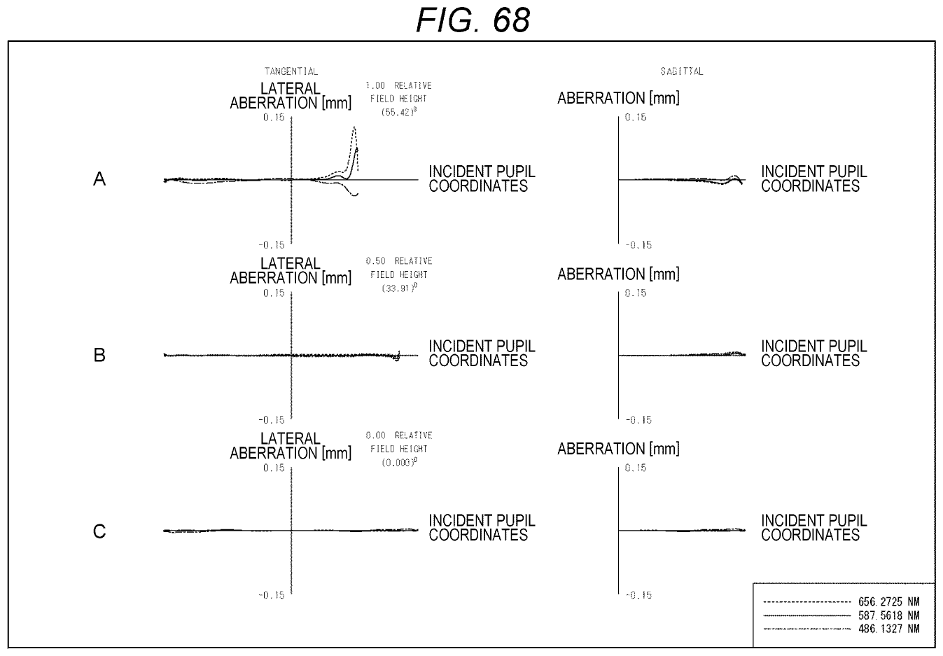

FIG. 68 is a graph illustrating an example of lateral aberration occurring in the imaging lens 116 of FIG. 63.

FIG. 68 is a graph illustrating lateral aberration for each wavelength of light having wavelengths of 486.1327 nm, 587.5618 nm, and 656.2725 nm, which occurs in imaging lens 116.

Specifically, the graphs on the left side in A to C of FIG. 68 represent the lateral aberration in the tangential direction at positions (position of image height in a case where half angle of view is 55.42°, 33.91°, 0°) where the image heights are 1.00 mm, 0.50 mm, and 0.00 mm, respectively. The graphs on the right side in A to C of FIG. 68 represent lateral aberrations in the sagittal direction at positions with image heights of 1.00 mm, 0.50 mm, and 0.00 mm, respectively.

As illustrated in FIGS. 67 and 68, good aberration correction is performed in the imaging lens 116 in FIG. 63, and the imaging lens 116 in FIG. 63 has good imaging quality.

### <10th Configuration Example of Imaging Lens>

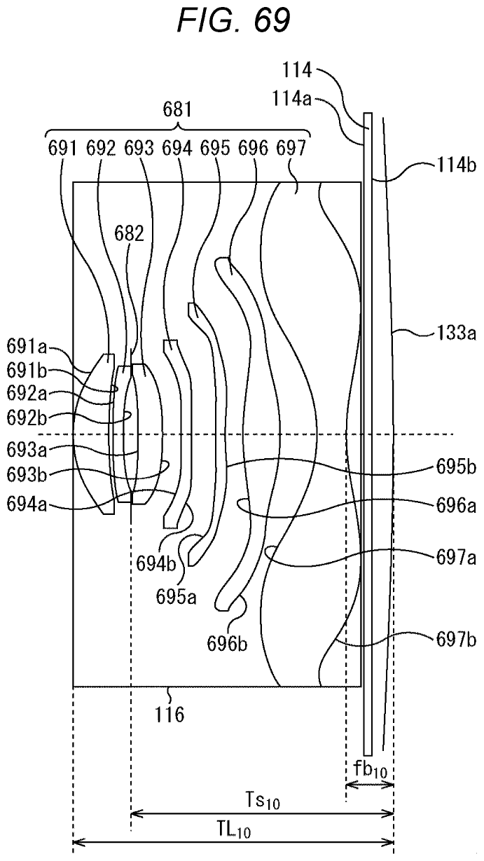

FIG. 69 is a cross-sectional view illustrating a 10th configuration example of the imaging lens 116.

The imaging lens 116 in FIG. 69 includes a lens group 681 and an aperture stop 682.

The lens group 681 includes seven aspherical lenses 691 to 697. The seven lenses 691 to 697 are arranged in order from the object side toward the imaging surface 133a side. The lens 691 has a surface 691a on the object side and a surface 691b on the imaging surface 133a side. Similarly to the lens 691, the lenses 692 to 697 also have surfaces 692a and 692b, surfaces 693a and 693b, surfaces 694a and 694b, surfaces 695a and 695b, surfaces 696a and 696b, and surfaces 697a and 697b, respectively. The aperture stop 682 is disposed at the position of the surface 692b, and limits light incident on the lens 692 from the lens 693.

The surfaces 691a to 697a and 691b to 697b are aspherical surfaces. In the example of FIG. 69, the imaging surface 133a is a spherical surface.

The light incident on the imaging lens 116 from the object is emitted via the lenses 691 to 697 and the infrared cut filter 114, and is condensed on the imaging surface 133a.

Note that, hereinafter, the optical total length of the imaging lens 116, which is the distance on the optical axis from the surface 691a (foremost surface) closest to the object side of the lens 691 closest to the object side among the lenses 691 to 697 to the imaging surface 133a, is referred to as TL₁₀. The distance on the optical axis from the surface 697b to the imaging surface 133a is referred to as fb₁₀, and the distance on the optical axis from the aperture stop 682 to the imaging surface 133a is referred to as Ts₁₀.

### <10th Example of Various Setting Values of Entire Imaging Lens>

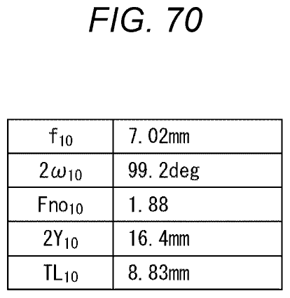

FIG. 70 is a table illustrating an example of various setting values of the entire imaging lens 116 in FIG. 69.

As illustrated in FIG. 70, a focal length f₁₀ of the entire imaging lens 116 in FIG. 69 is 7.02 mm. The maximum angle of view 2ω₁₀ of the imaging lens 116 is 99.2 deg. The f-number Fno₁₀ of the imaging lens 116 is 1.88, which is 2.5 or less. 2Y₁₀, which is twice the maximum image height Y₁₀, is 16.4 mm, and the optical total length TL₁₀ is 8.83 mm.

### <10th Example of Various Setting Values of Each Lens, Imaging Surface, and Infrared Cut Filter>

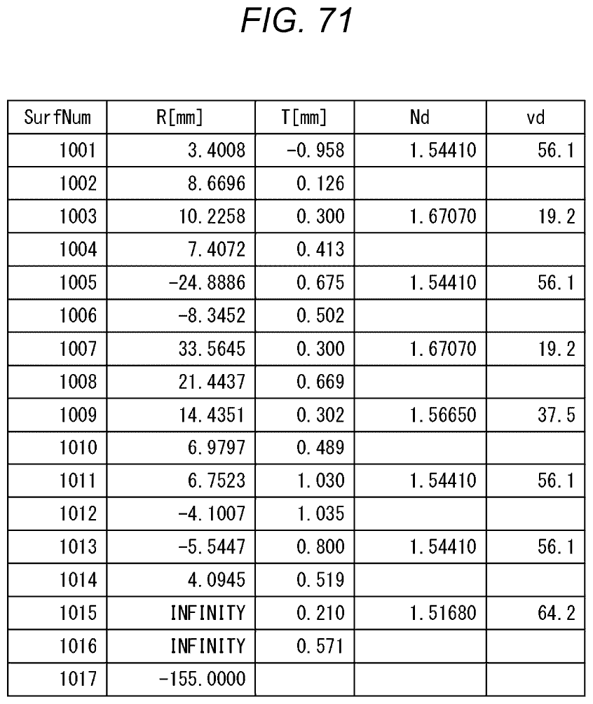

FIG. 71 is a table illustrating examples of various setting values of the lenses 691 to 697, the infrared cut filter 114, and the imaging surface 133a of FIG. 69.

In the first row from the top of the table in FIG. 71, items corresponding to respective columns are described. The second and subsequent rows from the top correspond to the surfaces 691a to 697a and the surfaces 691b to 697b, the surfaces 114a and 114b, and the imaging surface 133a, respectively. Each column in FIG. 71 is similar to each column in FIG. 17.

In the present specification, it is assumed that surface numbers from 1,001 to 1,004 are sequentially assigned to the surfaces 691a, 691b, 692a, and 692b. It is assumed that surface numbers from 1005 to 1017 are sequentially assigned to the surfaces 693a, 693b, 694a, 694b, 695a, 695b, 696a, 696b, 697a, 697b, 114a, and 114b, and the imaging surface 133a.

Note that, although not described, the radius of curvature R, the surface spacing T, the refractive index Nd, and the Abbe number vd of each of the surfaces 691a to 697a are values illustrated in the table of FIG. 71. The radius of curvature R and the surface spacing T of the surfaces 691b to 697b are values illustrated in the table of FIG. 71.

Since the surfaces 114a and 114b are planar, the radius of curvature R corresponding to SurfNum of 1015 and 1016 is infinite. Note that, although not described, the surface spacing T of the surface 114b, the surface spacing T of the surface 114a, the refractive index Nd, and the Abbe number vd are values illustrated in the table of FIG. 71.

The radius of curvature R of the imaging surface 133a with SurfNum of 1017 is −155.000. Since there is no surface to which 1018 following 1017 is given as SurfNum, there is no surface spacing T.

### <10th Example of Aspherical Data of Each Surface of Lens>

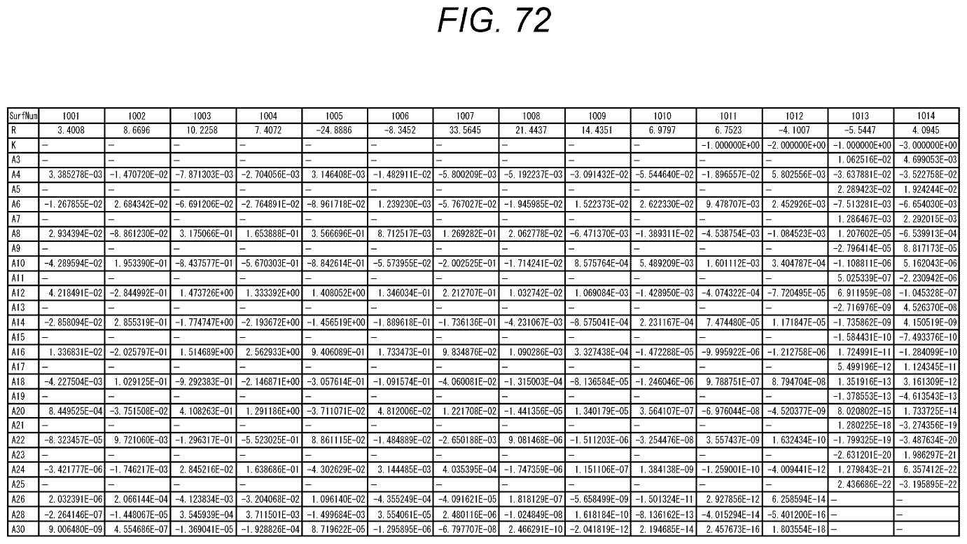

FIG. 72 is a table illustrating an example of aspherical data of the surfaces 691a to 697a and the surfaces 691b to 697b.

In the first column from the left of the table of FIG. 72, items corresponding to each row are described. The second and subsequent columns from the left correspond to the surfaces 691a, 691b, 692a, 692b, 693a, 693b, 694a, 694b, 695a, 695b, 696a, 696b, 697a, and 697b in order from the left. Each row in FIG. 72 corresponds to the items of SurfNum, the radius of curvature R, the conic coefficient K, the third-order aspherical coefficient A3 to the 26th order aspherical coefficient A26, the 28th order aspherical coefficient A28, and the 30th order aspherical coefficient A30 in order from the top.

Note that, although not described, the radius of curvature R and the nth-order aspherical coefficients An (n=4, 6, 8, 10, 12, 14, 16, 18, 20, 22, 24, 26, 28, and 30) of the surfaces 691a to 695a and the surfaces 691b to 695b are values illustrated in the table of FIG. 72. The radius of curvature R, the conic coefficient K, and the nth-order aspherical coefficients An (n=4, 6, 8, 10, 12, 14, 16, 18, 20, 22, 24, 26, 28, and 30) of the surfaces 696a and 696b are values illustrated in the table of FIG. 72. The radius of curvature R, the conic coefficient K, and the third-order aspherical coefficients A3 to 25 order aspherical coefficients A25 of the surfaces 697a and 697b are values illustrated in the table of FIG. 72.

### <10th Example of Spherical Aberration, Field Curvature, and Distortion Aberration>

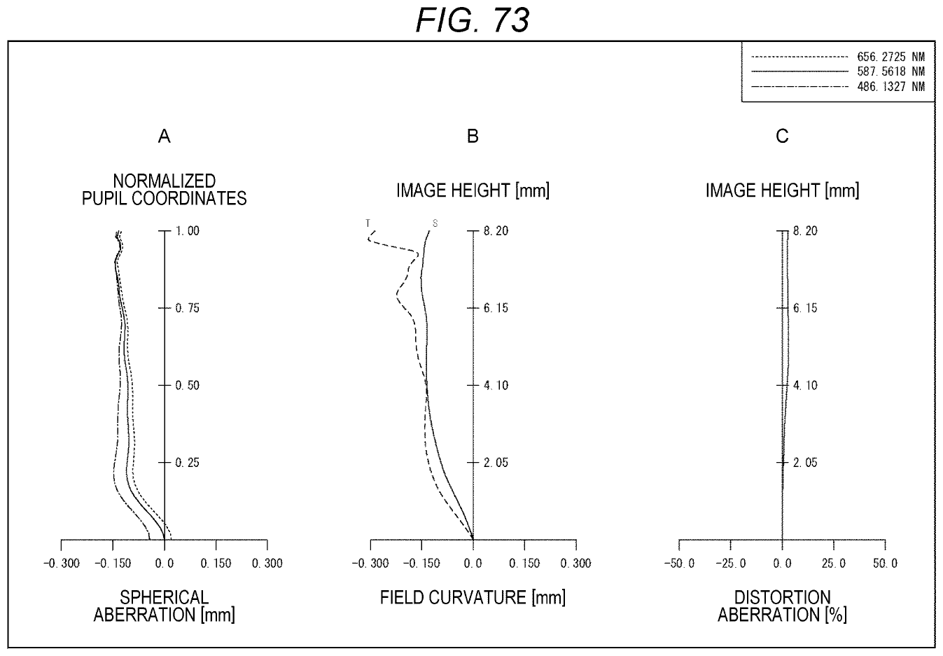

FIG. 73 is a graph illustrating examples of spherical aberration, field curvature, and distortion aberration occurring in the imaging lens 116 of FIG. 69.

A of FIG. 73 is a graph illustrating spherical aberration for each wavelength of light having wavelengths of 486.1327 nm, 587.5618 nm, and 656.2725 nm, which occurs in the imaging lens 116 of FIG. 69. B of FIG. 73 is a graph illustrating field curvature of light having a wavelength of 587.5618 nm generated in the imaging lens 116. C of FIG. 73 is a graph illustrating distortion aberration of light having a wavelength of 587.5618 nm, which occurs in the imaging lens 116.

### <10th Example of Lateral Aberration>

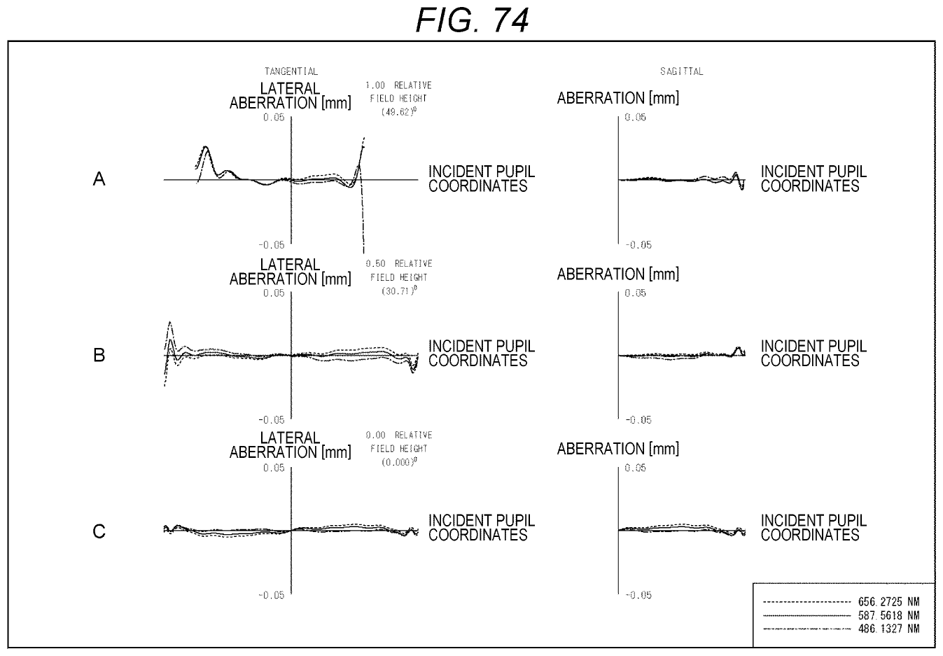

FIG. 74 is a graph illustrating an example of lateral aberration occurring in the imaging lens 116 of FIG. 69.

FIG. 74 is a graph illustrating lateral aberration for each wavelength of light having wavelengths of 486.1327 nm, 587.5618 nm, and 656.2725 nm, which occurs in imaging lens 116.

Specifically, the graphs on the left side in A to C of FIG. 74 represent the lateral aberration in the tangential direction at positions (position of image height in a case where half angle of view is 49.62°, 30.71°, 0°) where the image heights are 1.00 mm, 0.50 mm, and 0.00 mm, respectively. The graphs on the right side in A to C of FIG. 74 represent lateral aberrations in the sagittal direction at positions with image heights of 1.00 mm, 0.50 mm, and 0.00 mm, respectively.

As illustrated in FIGS. 73 and 74, good aberration correction is performed in the imaging lens 116 in FIG. 69, and the imaging lens 116 in FIG. 69 has good imaging quality.

### <11th Configuration Example of Imaging Lens>

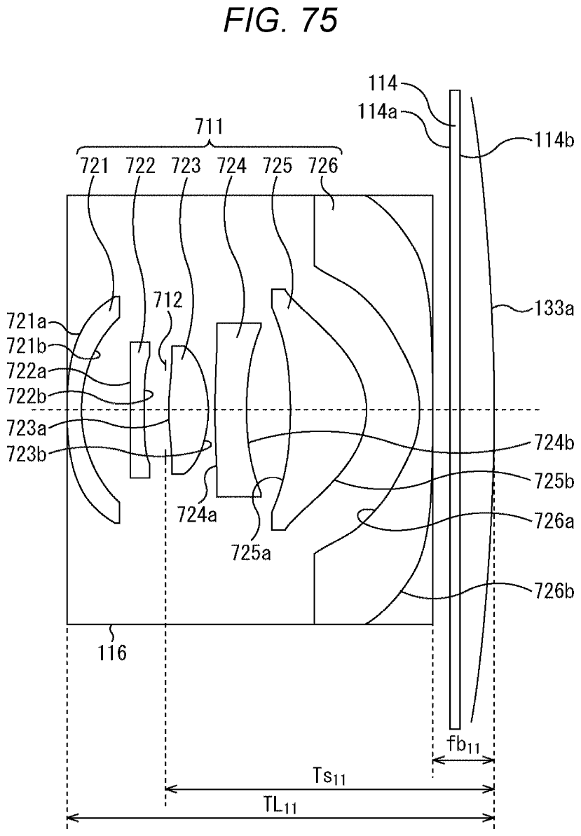

FIG. 75 is a cross-sectional view illustrating an 11th configuration example of the imaging lens 116.

The imaging lens 116 in FIG. 75 includes a lens group 711 and an aperture stop 712.

The lens group 711 includes six aspherical lenses 721 to 726. The seven lenses 721 to 726 are arranged in order from the object side toward the imaging surface 133a side. The lens 721 has a surface 721a on the object side and a surface 721b on the imaging surface 133a side. Similarly to the lens 721, the lenses 722 to 726 also have surfaces 722a and 722b, surfaces 723a and 723b, surfaces 724a and 724b, surfaces 725a and 725b, and surfaces 726a and 726b, respectively.

The surfaces 721a to 726a and 721b to 725b are aspherical surfaces. Among the lenses 721 to 726, the surface 726b (final surface) on the imaging surface 133a side of the lens 726 closest to the imaging surface 133a is an aspherical surface that is concave toward the object side as a whole and whose surface inclination is not inverted as it goes away from the optical axis. The aperture stop 712 is disposed between the lenses 722 and 723, and limits light incident on the lens 722 from the lens 723. In the example of FIG. 75, the imaging surface 133a is a spherical surface.

The light incident on the imaging lens 116 from the object is emitted via the lenses 721 to 726 and the infrared cut filter 114, and is condensed on the imaging surface 133a.

Note that, hereinafter, the optical total length of the imaging lens 116, which is the distance on the optical axis from the surface 721a (foremost surface) closest to the object side of the lens 721 closest to the object side among the lenses 721 to 726 to the imaging surface 133a, is referred to as TL₁₁. The distance on the optical axis from the surface 726b to the imaging surface 133a is referred to as fb₁₁, and the distance on the optical axis from the aperture stop 712 to the imaging surface 133a is referred to as Ts₁₁.

### <11th Example of Various Setting Values of Entire Imaging Lens>

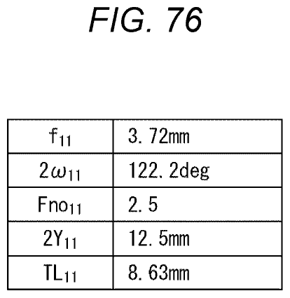

FIG. 76 is a table illustrating an example of various setting values of the entire imaging lens 116 in FIG. 75.

As illustrated in FIG. 76, a focal length f11 of the entire imaging lens 116 in FIG. 75 is 3.72 mm. The maximum angle of view 2ω₁₁ of the imaging lens 116 is 122.2 deg. The f-number Fno₁₁ of the imaging lens 116 is 2.5, which is 2.5 or less. 2Y₁₁, which is twice the maximum image height Y₁₁, is 12.5 mm, and the optical total length TL₁₁ is 8.63 mm.

### <11th Example of Various Setting Values of Each Lens, Aperture Stop, Imaging Surface, and Infrared Cut Filter>

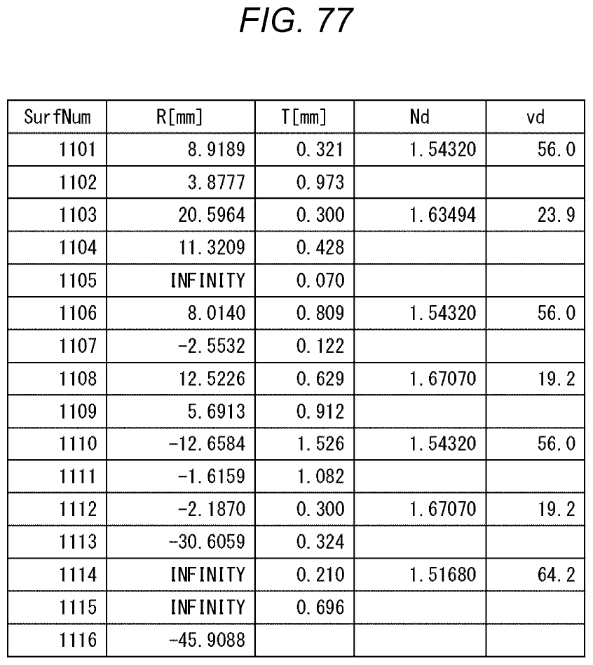

FIG. 77 is a table illustrating examples of various setting values of the lenses 721 to 726, the aperture stop 712, the infrared cut filter 114, and the imaging surface 133a of FIG. 75.

In the first row from the top of the table in FIG. 77, items corresponding to respective columns are described. The second and subsequent rows from the top correspond to the surfaces 721a to 726a and the surfaces 721b to 726b, the surface of the aperture stop 712, the surfaces 114a and 114b, and the imaging surface 133a, respectively. Each column in FIG. 77 is similar to each column in FIG. 17.

In the present specification, it is assumed that surface numbers from 1101 to 1104 are sequentially assigned to the surfaces 721a, 721b, 722a, and 722b. It is assumed that surface numbers from 1105 to 1116 are sequentially assigned to the surface of the aperture stop 712, the surfaces 723a, 723b, 724a, 724b, 725a, 725b, 726a, 726b, 114a, and 114b, and the imaging surface 133a.

Note that, although not described, the radius of curvature R, the surface spacing T, the refractive index Nd, and the Abbe number vd of each of the surfaces 721a to 726a are values illustrated in the table of FIG. 77. The radius of curvature R and the surface spacing T of the surfaces 721b to 726b are values illustrated in the table of FIG. 77.

Since the surfaces of the aperture stop 712 and the surfaces 114a and 114b are planar, the radius of curvature R corresponding to SurfNum of 1105, 1114, and 1115 is infinite. Note that, although not described, the surface spacing T between the surface of the aperture stop 712 and the surface 114b, and the surface spacing T, the refractive index Nd, and the Abbe number vd of the surface 114a are values illustrated in the table of FIG. 77.

The radius of curvature R of the imaging surface 133a with SurfNum of 1116 is −45.9088. Since there is no surface to which 1117 following 1116 is given as SurfNum, there is no surface spacing T.

### <11th Example of Aspherical Data of Each Surface of Lens>

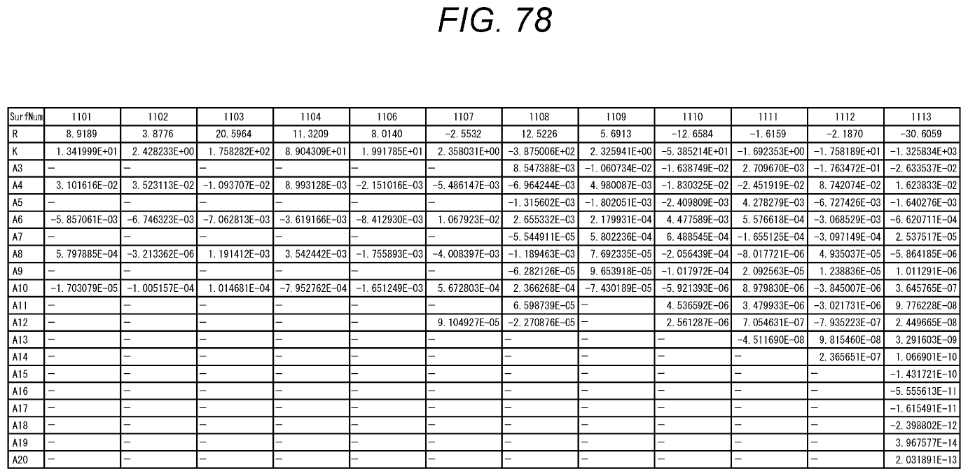

FIG. 78 is a table illustrating an example of aspherical data of the surfaces 721a to 726a and the surfaces 721b to 726b.

In the first column from the left of the table of FIG. 78, items corresponding to each row are described. The second and subsequent columns from the left correspond to the surfaces 721a, 721b, 722a, 722b, 723a, 723b, 724a, 724b, 725a, 725b, 726a, and 726b in order from the left. Each row in FIG. 78 is similar to each row in FIG. 48.

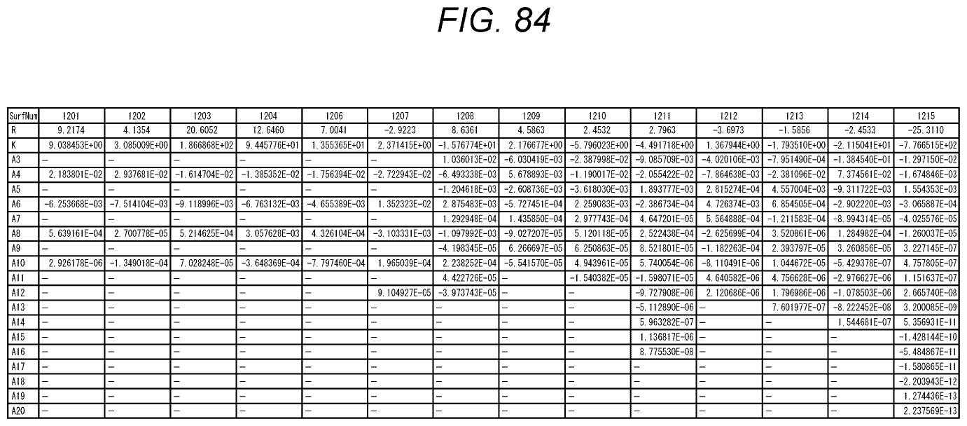

Note that, although not described, the radius of curvature R, the conic coefficient K, and the nth-order aspherical coefficient An (n=4, 6, 8, and 10) of the surfaces 721a to 723a, 721b, and 722b are values illustrated in the table of FIG. 84. The radius of curvature R, the conic coefficient K, and the nth-order aspherical coefficient An (n=4, 6, 8, 10, and 12) of the surface 723b are values illustrated in the table of FIG. 84. The radius of curvature R, the conic coefficient K, and the third-order aspherical coefficients A3 to 12th order aspherical coefficients A12 of the surfaces 724a and 725a are values illustrated in the table of FIG. 84. The radius of curvature R, the conic coefficient K, and the third-order aspherical coefficients A3 to 10th order aspherical coefficients A10 of the surface 724b are values illustrated in the table of FIG. 84. The radius of curvature R, the conic coefficient K, and the third-order aspherical coefficients A3 to 13th order aspherical coefficients A13 of the surface 725b are values illustrated in the table of FIG. 84. The radius of curvature R, the conic coefficient K, and the third-order aspherical coefficients A3 to 14th order aspherical coefficients A14 of the surface 726a are values illustrated in the table of FIG. 84. The radius of curvature R, the conic coefficient K, and the third-order aspherical coefficients A3 to 20th order aspherical coefficients A20 of the surface 726b are values illustrated in the table of FIG. 84.

### <11th Example of Spherical Aberration, Field Curvature, and Distortion Aberration>

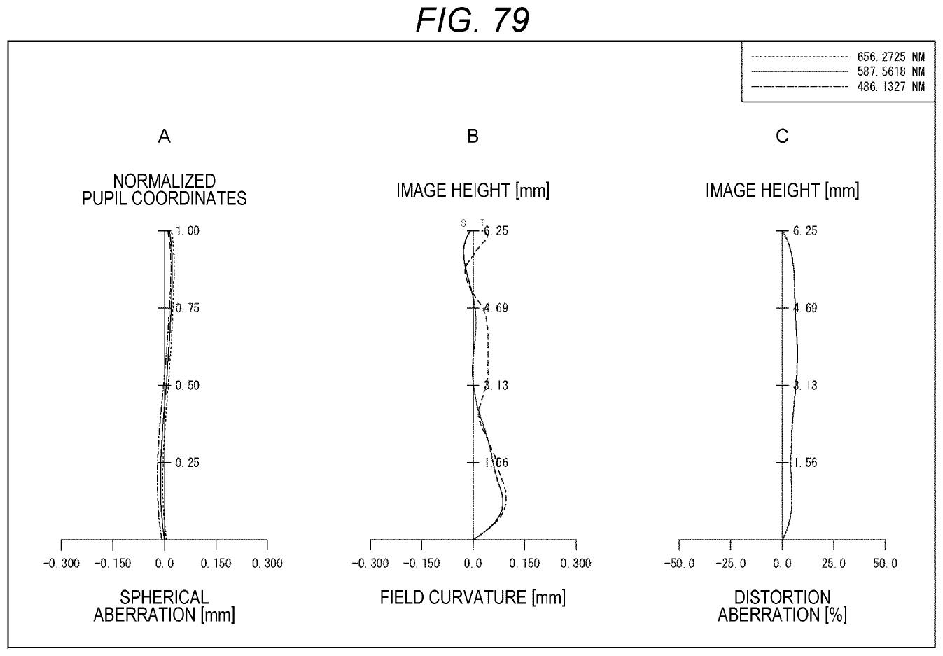

FIG. 79 is a graph illustrating examples of spherical aberration, field curvature, and distortion aberration occurring in the imaging lens 116 of FIG. 75.

A of FIG. 79 is a graph illustrating spherical aberration for each wavelength of light having wavelengths of 486.1327 nm, 587.5618 nm, and 656.2725 nm, which occurs in the imaging lens 116 of FIG. 75. B of FIG. 79 is a graph illustrating field curvature of light having a wavelength of 587.5618 nm generated in the imaging lens 116. C of FIG. 79 is a graph illustrating distortion aberration of light having a wavelength of 587.5618 nm, which occurs in the imaging lens 116.

### <11th Example of Lateral Aberration>

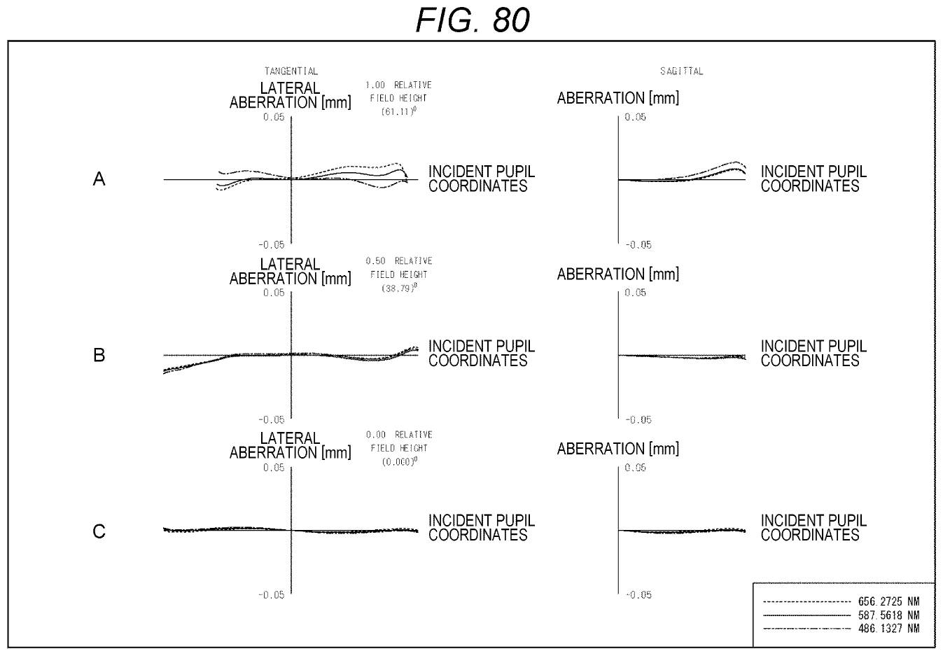

FIG. 80 is a graph illustrating an example of lateral aberration occurring in the imaging lens 116 of FIG. 75.

FIG. 80 is a graph illustrating lateral aberration for each wavelength of light having wavelengths of 486.1327 nm, 587.5618 nm, and 656.2725 nm, which occurs in imaging lens 116.

Specifically, the graphs on the left side in A to C of FIG. 80 represent the lateral aberration in the tangential direction at positions (position of image height in a case where half angle of view is 61.11°, 38.79°, 0°) where the image heights are 1.00 mm, 0.50 mm, and 0.00 mm, respectively. The graphs on the right side in A to C of FIG. 80 represent lateral aberrations in the sagittal direction at positions with image heights of 1.00 mm, 0.50 mm, and 0.00 mm, respectively.

As illustrated in FIGS. 79 and 80, good aberration correction is performed in the imaging lens 116 in FIG. 75, and the imaging lens 116 in FIG. 75 has good imaging quality.

### <12th Configuration Example of Imaging Lens>

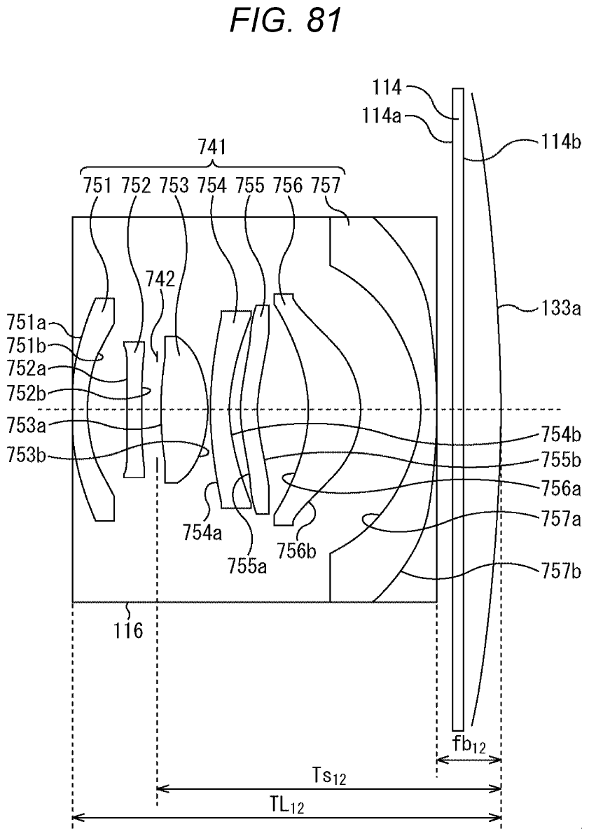

FIG. 81 is a cross-sectional view illustrating a 12th configuration example of the imaging lens 116.

The imaging lens 116 in FIG. 81 includes a lens group 741 and an aperture stop 742.

The lens group 741 includes seven aspherical lenses 751 to 757. The seven lenses 751 to 757 are arranged in order from the object side toward the imaging surface 133a side. The lens 751 has a surface 751a on the object side and a surface 751b on the imaging surface 133a side. Similarly to the lens 751, the lenses 752 to 757 also have surfaces 752a and 752b, surfaces 753a and 753b, surfaces 754a and 754b, surfaces 755a and 755b, surfaces 756a and 756b, and surfaces 757a and 757b, respectively.

The surfaces 751a to 757a and 751b to 756b are aspherical surfaces. Among the lenses 751 to 757, the surface 757b (final surface) on the imaging surface 133a side of the lens 757 closest to the imaging surface 133a is an aspherical surface that is concave toward the object side as a whole and whose surface inclination is not inverted as it goes away from the optical axis. The aperture stop 742 is disposed between the lenses 752 and 753, and limits light incident on the lens 752 from the lens 753. In the example of FIG. 81, the imaging surface 133a is a spherical surface.

The light incident on the imaging lens 116 from the object is emitted via the lenses 751 to 757 and the infrared cut filter 114, and is condensed on the imaging surface 133a.

Note that, hereinafter, the optical total length of the imaging lens 116, which is the distance on the optical axis from the surface 751a (foremost surface) closest to the object side of the lens 751 closest to the object side among the lenses 751 to 757 to the imaging surface 133a, is referred to as TL₁₂. The distance on the optical axis from the surface 757b to the imaging surface 133a is referred to as fb₁₂, and the distance on the optical axis from the aperture stop 742 to the imaging surface 133a is referred to as Ts₁₂.

### <12th Example of Various Setting Values of Entire Imaging Lens>

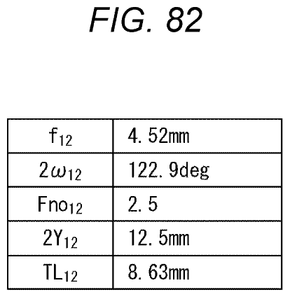

FIG. 82 is a table illustrating an example of various setting values of the entire imaging lens 116 in FIG. 81.

As illustrated in FIG. 82, a focal length f12 of the entire imaging lens 116 in FIG. 81 is 4.52 mm. The maximum angle of view 2ω₁₂ of the imaging lens 116 is 122.9 deg. The f-number Fno₁₂ of the imaging lens 116 is 2.5, which is 2.5 or less. 2Y₁₂, which is twice the maximum image height Y₁₂, is 12.5 mm, and the optical total length TL₁₂ is 8.63 mm.

### <12th Example of Various Setting Values of Each Lens, Aperture Stop, Imaging Surface, and Infrared Cut Filter>

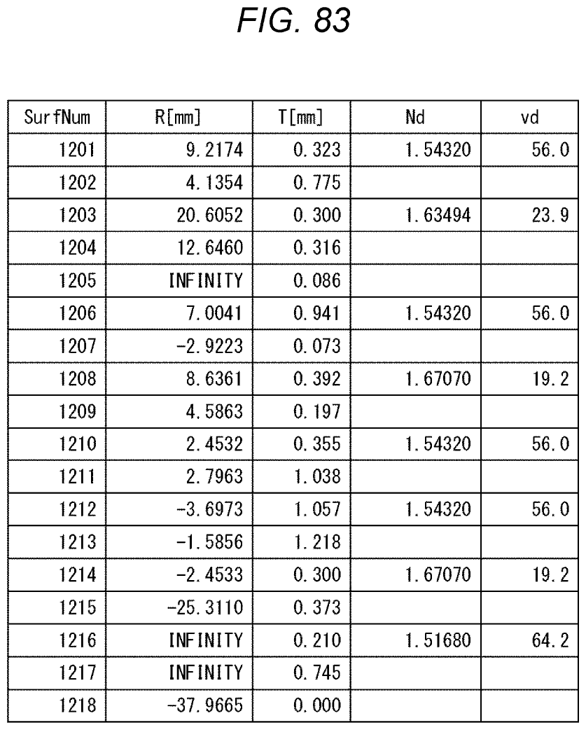

FIG. 83 is a table illustrating examples of various setting values of the lenses 751 to 757, the aperture stop 742, the infrared cut filter 114, and the imaging surface 133a of FIG. 81.

In the first row from the top of the table in FIG. 83, items corresponding to respective columns are described. The second and subsequent rows from the top correspond to the surfaces 751a to 757a and the surfaces 751b to 757b, the surface of the aperture stop 742, the surfaces 114a and 114b, and the imaging surface 133a, respectively. Each column in FIG. 83 is similar to each column in FIG. 17.

In the present specification, it is assumed that surface numbers from 1201 to 1204 are sequentially assigned to the surfaces 751a, 751b, 752a, and 752b. It is assumed that surface numbers from 1205 to 1218 are sequentially assigned to the surface of the aperture stop 742, the surfaces 753a, 753b, 754a, 754b, 755a, 755b, 756a, 756b, 757a, 757b, 114a, and 114b, and the imaging surface 133a.

Note that, although not described, the radius of curvature R, the surface spacing T, the refractive index Nd, and the Abbe number vd of each of the surfaces 751a to 757a are values illustrated in the table of FIG. 83. The radius of curvature R and the surface spacing T of the surfaces 751b to 757b are values illustrated in the table of FIG. 83.

Since the surfaces of the aperture stop 742 and the surfaces 114a and 114b are planar, the radius of curvature R corresponding to SurfNum of 1205, 1216, and 1217 is infinite. Note that, although not described, the surface spacing T between the surface of the aperture stop 742 and the surface 114b, and the surface spacing T, the refractive index Nd, and the Abbe number vd of the surface 114a are values illustrated in the table of FIG. 83.

The radius of curvature R of the imaging surface 133a with SurfNum of 1218 is −37.9665. Since there is no surface to which 1219 following 1218 is given as SurfNum, there is no surface spacing T.

### <12th Example of Aspherical Data of Each Surface of Lens>

FIG. 84 is a table illustrating an example of aspherical data of the surfaces 751a to 757a and the surfaces 751b to 757b.

In the first column from the left of the table of FIG. 84, items corresponding to each row are described. The second and subsequent columns from the left correspond to the surfaces 751a, 751b, 752a, 752b, 753a, 753b, 754a, 754b, 755a, 755b, 756a, 756b, 757a, and 757b in order from the left. Each row in FIG. 84 is similar to each row in FIG. 48.

Note that, although not described, the radius of curvature R, the conic coefficient K, and the nth-order aspherical coefficient An (n=4, 6, 8, and 10) of the surfaces 751a to 753a, 751b, and 752b are values illustrated in the table of FIG. 84. The radius of curvature R, the conic coefficient K, and the nth-order aspherical coefficient An (n=4, 6, 8, 10, and 12) of the surface 753b are values illustrated in the table of FIG. 84. The radius of curvature R, the conic coefficient K, and the third-order aspherical coefficients A3 to 12th order aspherical coefficients A12 of the surfaces 754a and 756a are values illustrated in the table of FIG. 84. The radius of curvature R, the conic coefficient K, and the third-order aspherical coefficients A3 to 10th order aspherical coefficients A10 of the surface 754b are values illustrated in the table of FIG. 84. The radius of curvature R, the conic coefficient K, and the third-order aspherical coefficients A3 to 11th order aspherical coefficients A11 of the surface 755a are values illustrated in the table of FIG. 84.

The radius of curvature R, the conic coefficient K, and the third-order aspherical coefficients A3 to 16th order aspherical coefficients A16 of the surface 755b are values illustrated in the table of FIG. 84. The radius of curvature R, the conic coefficient K, and the third-order aspherical coefficients A3 to 13th order aspherical coefficients A13 of the surface 756b are values illustrated in the table of FIG. 84. The radius of curvature R, the conic coefficient K, and the third-order aspherical coefficients A3 to 14th order aspherical coefficients A14 of the surface 757a are values illustrated in the table of FIG. 84. The radius of curvature R, the conic coefficient K, and the third-order aspherical coefficients A3 to 20th order aspherical coefficients A20 of the surface 757b are values illustrated in the table of FIG. 84.

### <12th Example of Spherical Aberration, Field Curvature, and Distortion Aberration>

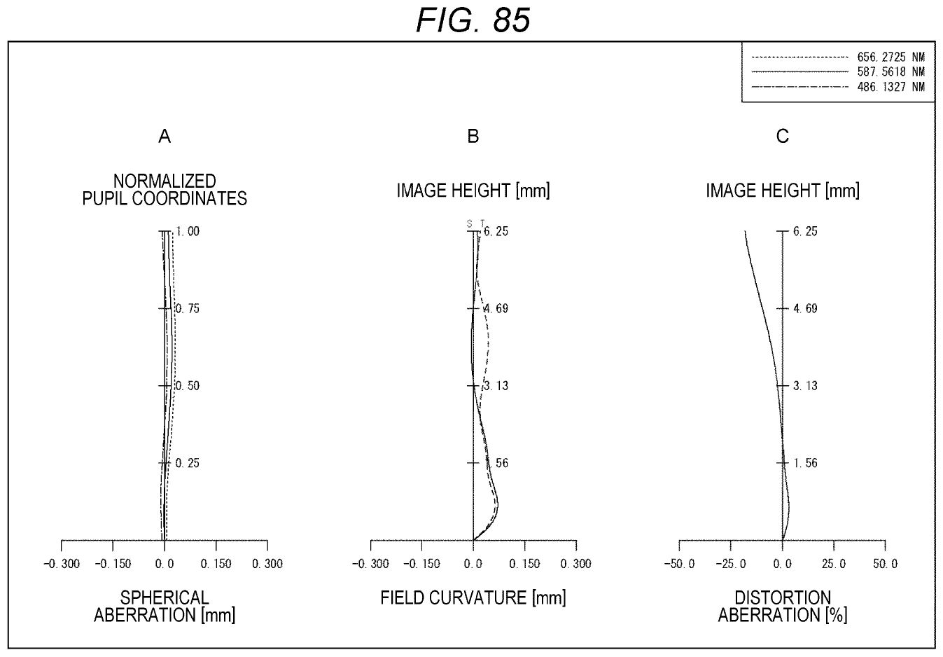

FIG. 85 is a graph illustrating examples of spherical aberration, field curvature, and distortion aberration occurring in the imaging lens 116 of FIG. 81.

A of FIG. 85 is a graph illustrating spherical aberration for each wavelength of light having wavelengths of 486.1327 nm, 587.5618 nm, and 656.2725 nm, which occurs in the imaging lens 116 of FIG. 81. B of FIG. 85 is a graph illustrating field curvature of light having a wavelength of 587.5618 nm generated in the imaging lens 116. C of FIG. 85 is a graph illustrating distortion aberration of light having a wavelength of 587.5618 nm, which occurs in the imaging lens 116.

### <12th Example of Lateral Aberration>

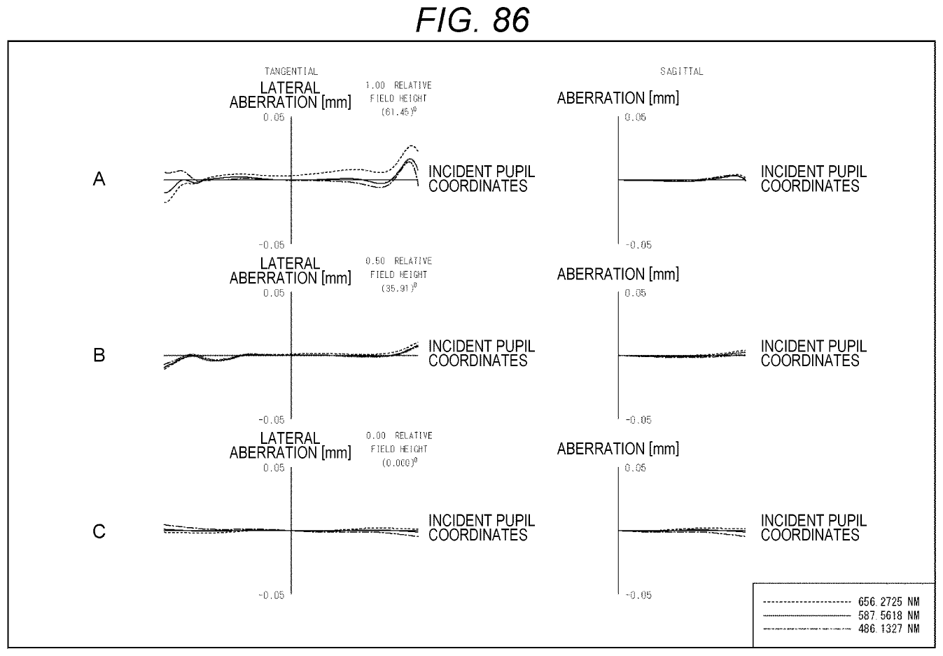

FIG. 86 is a graph illustrating an example of lateral aberration occurring in the imaging lens 116 of FIG. 81.

FIG. 86 is a graph illustrating lateral aberration for each wavelength of light having wavelengths of 486.1327 nm, 587.5618 nm, and 656.2725 nm, which occurs in imaging lens 116.

Specifically, the graphs on the left side in A to C of FIG. 86 represent the lateral aberration in the tangential direction at positions (position of image height in a case where half angle of view is 61.45°, 35.91°, 0°) where the image heights are 1.00 mm, 0.50 mm, and 0.00 mm, respectively. The graphs on the right side in A to C of FIG. 86 represent lateral aberrations in the sagittal direction at positions with image heights of 1.00 mm, 0.50 mm, and 0.00 mm, respectively.

As illustrated in FIGS. 85 and 86, good aberration correction is performed in the imaging lens 116 in FIG. 81, and the imaging lens 116 in FIG. 81 has good imaging quality.

### <Values of Parameters or Expressions>

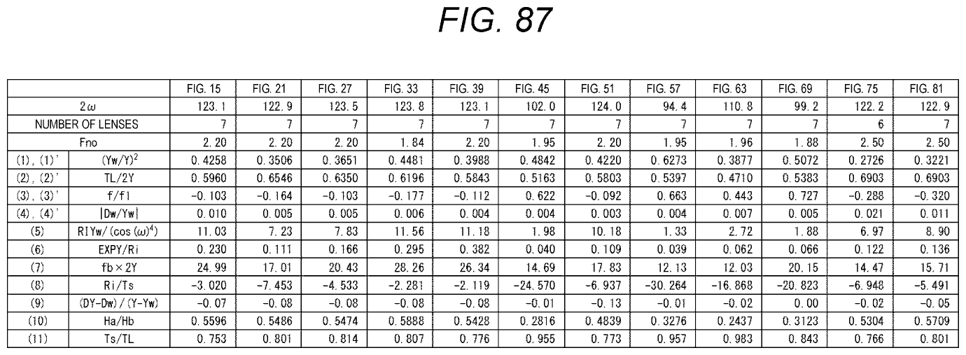

FIG. 87 is a table illustrating values of parameters or expressions in the imaging lens 116 of FIGS. 15, 21, 27, 33, 39, 45, 51, 57, 63, 69, 75, and 81.

In the first column from the left of the table of FIG. 87, items corresponding to each row are described. The second and subsequent columns from the left correspond, in order from the left, to the imaging lens 116 in FIGS. 15, 21, 27, 33, 39, 45, 51, 57, 63, 69, 75, and 81. Each row corresponds to items of a number of the imaging lens 116 in the drawing, 2ω, the number of lenses, Fno, (Yw/Y)², TL/2Y, f/f1, |Dw/Yw|, RIYw/(cos (ω)⁴), EXPY/Ri, fb×2Y, Ri/Ts, (DY−Dw)/(Y−Yw), Ha/Hb, and Ts/TL.

Here, ω is a generic term for the maximum half angles of view ω₁ to ω₁₂, and is a generic term for the maximum angles of view 2ω₁ to 2ω₁₂. Fno is a generic term for the F-numbers Fno₁ to Fno₁₂. Yw is an image height (first image height) in a case where the half angle of view is 40 degrees, and Y is a generic term for maximum image heights Y₁ to Y₁₂. TL is a generic term of optical total lengths TL₁ to TL₁₂, and f is a generic term of focal lengths f₁ to f₁₂. f1 is a focal length of lens 431 (461, 491, 521, 541, 571, 601, 631, 661, 691, 721, 751) closest to the object side. Dw is optical distortion at the image height Yw, and RIYw is a peripheral light amount ratio with respect to the center of the imaging surface 133a in a case where the half angle of view is 40 degrees.

EXPY is the distance [mm] on the optical axis from the imaging surface 133a to the exit pupil of the light beam with the maximum image height Y when the direction from the imaging surface 133a toward the object is the negative direction, and Ri is the radius of curvature R of the center of the imaging surface 133a. fb is a generic term for the distances fb₁ to fb₁₂, and Ts is a generic term for the distances Ts₁ to Ts₁₂. DY is optical distortion [%] at the maximum image height Y. Ha is the maximum effective radius of the surface 431a (461a, 491a, 521a, 541a, 571a, 601a, 631a, 661a, 691a, 721a, 751a). Hb is the maximum effective radius of the surface 437b (467b, 497b, 527b, 547b, 577b, 607b, 637b, 667b, 697b, 726b, 757b).

Since 20 and Fno of each imaging lens 116 have been described above, the description thereof will be omitted. The number of lenses of the imaging lens 116 of FIGS. 15, 21, 27, 33, 39, 45, 51, 57, 63, 69, and 81 is 7, and the number of lenses of the imaging lens 116 in FIG. 75 is 6.

In the imaging lens 116 of FIGS. 15, 21, 27, 33, 39, 45, 51, 57, 63, 69, and 81, (Yw/Y) 2 is 0.4258, 0.3506, 0.3651, 0.4481, 0.3988, 0.4842, 0.4220, 0.6273, 0.3877, 0.5072, 0.2726, and 0.3221, respectively. Therefore, the imaging lens 116 in FIGS. 15, 21, 27, 33, 39, 45, 51, 57, 63, 69, 75, and 81 satisfies the following conditional expression (1). The imaging lens 116 of FIGS. 15, 21, 27, 33, 39, 45, 51, 57, 63, 69, and 81 further satisfies the following conditional expression (1)′.

0.27≤(Yw/Y)²≤0.7 (1)

0.32≤(Yw/Y)²≤0.65 (1)′

When (Yw/Y)² exceeds the upper limit of the conditional expression (1), the distortion aberration in the ultra-wide-angle image becomes extremely large, and the deterioration of the peripheral resolution becomes remarkable. When (Yw/Y)² is less than the lower limit of the conditional expression (1), the effective pixel region decreases and the number of effective pixels decreases in a case where the total angle of view at the highest imaging frequency is within 80 degrees. As a result, the resolution of the wide-angle image is greatly deteriorated. In a case where the imaging lens 116 satisfies the conditional expression (1)′, the effect is larger than that in a case where the conditional expression (1) is satisfied.

In the imaging lens 116 of FIGS. 15, 21, 27, 33, 39, 45, 51, 57, 63, 69, and 81, TL/2Y is 0.5960, 0.6546, 0.6350, 0.6196, 0.5843, 0.5163, 0.5803, 0.5397, 0.4710. 0.5383, 0.6903, and 0.6903, respectively. Therefore, the imaging lens 116 in FIGS. 15, 21, 27, 33, 39, 45, 51, 57, 63, 69, 75, and 81 satisfies the following conditional expression (2). The imaging lens 116 in FIGS. 15, 21, 27, 33, 39, 45, 51, 57, 63, and 69 further satisfies the following conditional expression (2)′.

$$0.3 \leq TL / 2 Y \leq 0 \text{.695} \qquad ( 2 )$$

$$0.35 \leq TL / 2 Y \leq 0.675 \qquad {( 2 )}^{′}$$

When TL/2Y exceeds the upper limit of the conditional expression (2), it is difficult to house the ultra-wide-angle camera 11 in the housing of the smartphone 10. As a result, usability and design of the smartphone 10 are impaired, or the size of the smartphone 10 is increased. When TL/2Y falls below the lower limit of the conditional expression (2), the amount of curvature of the imaging element 133 increases, making it difficult to manufacture the ultra-wide-angle camera 11. In addition, when TL/2Y falls below the lower limit of the conditional expression (2), aberration correction becomes difficult even if the imaging surface 133a is curved, and a desired resolution cannot be obtained in the captured image. In a case where the imaging lens 116 satisfies the conditional expression (2)′, the effect is larger than that in a case where the conditional expression (2) is satisfied.

In the imaging lens 116 of FIGS. 15, 21, 27, 33, 39, 45, 51, 57, 63, 69, and 81, f/f1 is −0.103, −0.164, −0.103, −0.177, −0.112, 0.622, −0.092, 0.663, 0.443, 0.727, −0.288, and −0.320, respectively. Therefore, the imaging lens 116 in FIGS. 15, 21, 27, 33, 39, 45, 51, 57, 63, 69, 75, and 81 satisfies the following conditional expression (3). The imaging lens 116 in FIGS. 15, 21, 27, 33, 39, 51, 75, and 81 further satisfies the following conditional expression (3)′.

$$- 0.35 \leq f / f 1 \leq 0.73 \qquad ( 3 )$$

$$- 0.33 \leq f / f 1 \leq 0 \qquad {( 3 )}^{′}$$

When f/f1 exceeds the upper limit of the conditional expression (3), the imaging lens 116 becomes a so-called telephoto type lens, the focal length of the entire imaging lens 116 becomes long, and it becomes difficult to achieve wide-angle. In addition, since the imaging surface 133a is curved, it is important to secure appropriate back focus in order to avoid physical interference between the imaging lens 116, the infrared cut filter 114, and the imaging surface 133a. However, it is difficult to extend back focus with a telephoto type lens.

When f/f1 falls below the lower limit of the conditional expression (3), the distortion aberration increases. As a result, image quality deterioration of the captured image becomes remarkable, or in a case where distortion aberration is corrected by the signal processing section 105 in the subsequent stage, resolution degradation of the captured image and an increase in power consumption occur. In a case where the imaging lens 116 satisfies the conditional expression (3)′, the effect is larger than that in a case where the conditional expression (3) is satisfied.

In the imaging lens 116 of FIGS. 15, 21, 27, 33, 39, 45, 51, 57, 63, 69, and 81, |Dw/Yw| is 0.010, 0.005, 0.005, 0.006, 0.004, 0.004, 0.003, 0.004, 0.07, 0.005, 0.021, and 0.011, respectively. Therefore, the imaging lens 116 in FIGS. 15, 21, 27, 33, 39, 45, 51, 57, 63, 69, 75, and 81 satisfies the following conditional expressions (4) and (4)′.

$$0.001 \leq \vert Dw / Yw \vert \leq 0.08 \qquad ( 4 )$$

$$0.003 \leq \vert Dw / Yw \vert \leq 0.03 \qquad {( 4 )}^{′}$$

When |Dw/Yw| exceeds the upper limit of the conditional expression (4), post-stage correction of distortion aberration is essential even in the wide-angle image in which the total angle of view with the highest imaging frequency is within 80 degrees, and as a result, the resolution of the wide-angle image is deteriorated and the power consumption is increased. When |Dw/Yw| falls below the lower limit of the conditional expression (4), the shape of each surface (surfaces 431a to 437a, 431b to 437b, and the like) of the imaging lens 116 becomes difficult to manufacture, or the number of lenses increases in order to correct the distortion aberration. In a case where the imaging lens 116 satisfies the conditional expression (4)′, the effect is larger than that in a case where the conditional expression (4) is satisfied.

In the imaging lens 116 of FIGS. 15, 21, 27, 33, 39, 45, 51, 57, 63, 69, and 81, RIYw/(cos (ω)⁴) is 11.03, 7.23, 7.83, 11.56, 11.18, 1.98, 10.18, 1.33, 2.72, 1.88, 6.97, and 8.90, respectively. Therefore, the imaging lens 116 in FIGS. 15, 21, 27, 33, 39, 45, 51, 57, 63, 69, 75, and 81 satisfies the following conditional expression (5).

$$1.2 \leq RIYw / ( {cos ( ω )}^{4} ) \leq 35 \qquad ( 5 )$$

When RIYw/(cos (ω)⁴) exceeds the upper limit of the conditional expression (5), the optical total length TL becomes extremely large, so that it becomes difficult to house the ultra-wide-angle camera 11 in the housing of the smartphone 10. When RIYw/(cos (ω)⁴) is less than the lower limit of the conditional expression (5), the signal noise increases when the light amount correction is performed in the peripheral portion of the captured image, and the image quality in the dark place is greatly deteriorated even in the wide-angle image or the like in which the total angle of view having the highest imaging frequency is within 80 degrees.

In the imaging lens 116 of FIGS. 15, 21, 27, 33, 39, 45, 51, 57, 63, 69, and 81, EXPY/Ri is 0.230, 0.111, 0.166, 0.295, 0.382, 0.040, 0.109, 0.039, 0.062, 0.066, 0.122, and 0.136, respectively. Therefore, the imaging lens 116 in FIGS. 15, 21, 27, 33, 39, 45, 51, 57, 63, 69, 75, and 81 satisfies the following conditional expression (6).

$$0.01 \leq EXPY / Ri \leq 0.39 \qquad ( 6 )$$

When EXPY/Ri exceeds the upper limit of the conditional expression (6), the amount of curvature of the imaging element 133 increases, so that it becomes difficult to manufacture the ultra-wide-angle camera 11 or the optical total length TL increases. When EXPY/Ri falls below the lower limit of the conditional expression (6), pupil correction by the on-chip lens 258 cannot be appropriately performed, and as a result, the amount of light substantially incident on the imaging element 133 decreases, and the S/N ratio of the electric signal deteriorates.

In the imaging lens 116 of FIGS. 15, 21, 27, 33, 39, 45, 51, 57, 63, 69, and 81, fb×2Y is 24.99, 17.01, 20.43, 28.26, 26.34, 14.69, 17.83, 12.13, 12.03, 20.15, 14.47, and 15.71, respectively. Therefore, the imaging lens 116 in FIGS. 15, 21, 27, 33, 39, 45, 51, 57, 63, 69, 75, and 81 satisfies the following conditional expression (7).

$$9.7 \leq fb \times 2 Y \leq 28.4 \qquad ( 7 )$$

When fb×2Y exceeds the upper limit of the conditional expression (7), the negative optical power of the lens 431 (461, 491, 521, 541, 571, 601, 631, 661, 691, 721, 751) closest to the object side becomes strong, and it becomes difficult to correct the distortion aberration. When fb×2Y falls below the lower limit of the conditional expression (7), the component shape of the imaging lens 116 becomes complicated, and it becomes difficult to manufacture the imaging lens 116. In addition, there is an increased risk that the imaging lens 116, the infrared cut filter 114, and the imaging element 133 are damaged at the time of focus adjustment or drop impact.

In the imaging lens 116 of FIGS. 15, 21, 27, 33, 39, 45, 51, 57, 63, 69, and 81, Ri/Ts are −3.020, −7.453, −4.533, −2.281, −2.119, −24.570, −6.937, −30.264, −16.868, −20.823, −6.948, and −5.491, respectively. Therefore, the imaging lens 116 in FIGS. 15, 21, 27, 33, 39, 45, 51, 57, 63, 69, 75, and 81 satisfies the following conditional expression (8).

$$- 50 \leq Ri / Ts \leq - 1.95 \qquad ( 8 )$$

If Ri/Ts exceeds the upper limit of the conditional expression (8), the amount of curvature of the imaging surface 133a increases, so that defects such as fracture and cracking of the imaging element 133 increase, making it difficult to manufacture the ultra-wide-angle camera 11. When Ri/Ts is less than the lower limit of the conditional expression (8), the effect due to the curvature of the imaging surface 133a cannot be sufficiently obtained, and as a result, the optical total length TL increases.

In the imaging lens 116 of FIGS. 15, 21, 27, 33, 39, 45, 51, 57, 63, 69, and 81, (DY−Dw)/(Y−Yw) is −0.07, −0.08, −0.08, −0.08, −0.08, −0.01, −0.13, −0.01, −0.02, 0.00, −0.02, and −0.05, respectively. Therefore, the imaging lens 116 in FIGS. 15, 21, 27, 33, 39, 45, 51, 57, 63, 69, 75, and 81 satisfies the following conditional expression (9).

$$- 0.16 \leq ( DY - Dw ) / ( Y - Yw ) \leq 0.16 \qquad ( 9 )$$

When (DY−Dw)/(Y−Yw) exceeds the upper limit or falls below the lower limit of the conditional expression (9), the distortion aberration in the ultra-wide-angle image increases, and the high-frequency information of the subject disappears. As a result, even in a case where the distortion aberration is corrected in the subsequent stage, the resolution of the peripheral portion is significantly deteriorated. In addition, a difference in image quality between peripheral portions of the wide-angle image and the ultra-wide-angle image increases.

In the imaging lens 116 of FIGS. 15, 21, 27, 33, 39, 45, 51, 57, 63, 69, and 81, Ha/Hb is 0.5596, 0.5486, 0.5474, 0.5888, 0.5428, 0.2816, 0.4839, 0.3276, 0.2437, 0.3123, 0.5304, and 0.5709, respectively. Therefore, the imaging lens 116 in FIGS. 15, 21, 27, 33, 39, 51, 75, and 81 satisfies the following conditional expression (10).

$$0.475 \leq Ha / Hb \leq 0.68 \qquad ( 10 )$$

When Ha/Hb exceeds the upper limit of the conditional expression (10), the optical total length TL increases, and the occupancy area of the imaging lens 116 in the smartphone 10 increases, so that a peripheral member or a protective glass cannot be disposed. When Ha/Hb falls below the lower limit of the conditional expression (10), the imaging lens 116 becomes a so-called telephoto type lens, and thus it becomes difficult to secure the peripheral light amount and the back focus as the angle of the imaging lens 116 becomes ultra-wide.

In the imaging lens 116 of FIGS. 15, 21, 27, 33, 39, 45, 51, 57, 63, 69, and 81, Ts/TL is 0.753, 0.801, 0.814, 0.807, 0.776, 0.955, 0.773, 0.957, 0.983, 0.843, 0.766, and 0.801, respectively. Therefore, the imaging lens 116 in FIGS. 15, 21, 27, 33, 39, 51, 69, 75, and 81 satisfies the following conditional expression (11).

$$0.73 \leq Ts / TL \leq 0.9 \qquad ( 11 )$$

When Ts/TL exceeds the upper limit of the conditional expression (11), it becomes difficult to secure the peripheral light amount and the back focus as the imaging lens 116 becomes ultra-wide. When Ts/TL is less than the lower limit of the conditional expression (11), the optical total length TL becomes extremely large, or the incident light amount becomes insufficient because the pupil correction by the on-chip lens 258 cannot be appropriately performed, and the S/N ratio of the electric signal deteriorates.

Note that the numerical values of the setting data and the aspherical data in the imaging lens 116 are not limited to the above-described numerical values.

The arrangement of the pixels 160 is not limited to the arrangement illustrated in FIG. 6.

### <Another Example of Pixel Array>

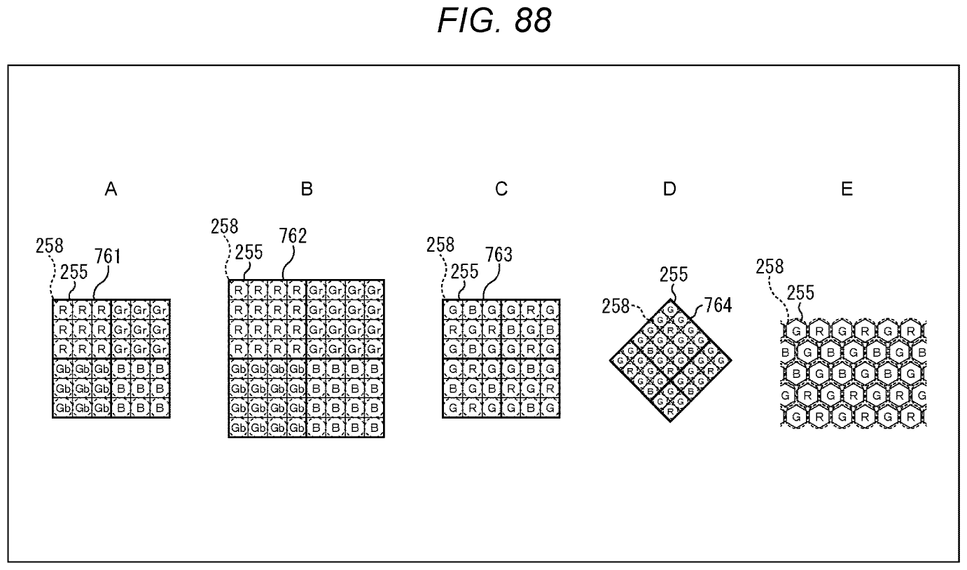

FIG. 88 is a top view of the imaging element 133 illustrating another example of the arrangement of the pixels 160.

Note that, in FIG. 88, in order to simplify the drawing, only a region of some pixels 160 of the imaging element 133 is illustrated, and the antireflection film 259 is omitted.

As illustrated in A of FIG. 88, the array of the pixels 160 can be such that the array of the 6×6 pixels 160 is a Bayer array of a same color pixel group 761 including 3×3 pixels 160. As illustrated in B of FIG. 88, the array of 8×8 pixels 160 may be a Bayer array of a same color pixel group 762 including 4×4 pixels 160. The arrays in A and B of FIG. 88 are different from the array in FIG. 6 in that the same color pixel groups 761 and 762 having the color filters 255 of the same color include 3×3 pixels 160 and 4×4 pixels 160, respectively, and are similar to the array in FIG. 6 except for this.

The arrangement of the pixels 160 can also have a predetermined arrangement for each unit pixel group 763 including 3×3 pixels 160 as illustrated in C of FIG. 88. Specifically, in the unit pixel group 763, the pixels 160 at the four corners and the central pixel 160 have the green color filters 255, the pixels 160 at the central left and right end portions have one of the red and blue color filters 255, and the pixels 160 at the central upper and lower end portions have the other. In addition, one and the other are different between adjacent unit pixel groups 763.

As illustrated in D of FIG. 88, the pixels 160 can also be arranged in a matrix with a direction inclined by 45 degrees with respect to the horizontal direction as the row direction and a direction inclined by 45 degrees with respect to the vertical direction as the column direction. In the example of D of FIG. 88, the pixel 160 has a predetermined array for each unit pixel group 764 including 4×4 pixels 160. Specifically, in the unit pixel group 764, the pixels 160 in the first and third rows from the top have the green color filters 255. Pixels 160 in the second row from the top alternately have green and red color filters 255, and pixels 160 in the fourth row from the top alternately have green and blue color filters 255.

As illustrated in E of FIG. 88, the pixels 160 can also be arranged in a matrix with the horizontal direction as the row direction and the direction inclined by 45 degrees with respect to the vertical direction as the column direction. In the example in E of FIG. 88, columns of the pixels 160 including the all-green color filters 255 and columns of the pixels 160 alternately including the red and blue color filters 255 are alternately arranged in the row direction.

As illustrated in A to E of FIG. 88, in a case where the colors of the color filters 255 of at least some of the adjacent pixels 160 are the same color, the effect of suppressing the same color sensitivity difference by the imaging element 133 described in FIG. 7 is useful. Note that, even in a case where the colors of the color filters 255 of the adjacent pixels 160 are not the same color, sensitivity shading caused by vignetting can be improved by the imaging element 133 having a curved shape.

The surface 437b (467b, 497b, 527b, 547b, 577b, 607b, 637b, 667b, 6976, 726b, 757b) may be a spherical surface concave to the object side.

The maximum angle of view 2ω is desirably 93 degrees or more suitable for a group photograph or the like. As the maximum angle of view 2ω is larger, the effect of shortening the optical total length TL becomes higher. On the other hand, when the maximum angle of view 2ω exceeds 145 degrees, it is difficult to correct the distortion aberration. In addition, the effective pixel region in a case where the total angle of view with the highest imaging frequency is within 80 degrees becomes relatively small, and the resolution deteriorates with the decrease in the number of effective pixels. Therefore, the maximum angle of view 2ω is desirably 93 degrees or more and 145 degrees or less.

As described above, the imaging lens 116 includes the lenses 431 to 437 (461 to 467, 491 to 497, 521 to 527, 541 to 547, 571 to 577, 601 to 607, 631 to 637, 661 to 667, 691 to 697, 721 to 726, 751 to 757) that form an optical image of an object on the imaging surface 133a. The imaging surface 133a has a curved shape. Then, the maximum angle of view 2ω of the imaging lens 116 is 90 degrees or more, and satisfies the conditional expressions (1) to (3) or (1), (2), and (4).

Therefore, it is possible to reduce the height and improve the performance while increasing the size (maximum image height Y) of the imaging element 133 of the ultra-wide-angle camera 11 in which the maximum angle of view 2ω is 90 degrees or more. Specifically, the field curvature having a very large correction effect by the imaging surface 133a having a curved shape is proportional to the square of the angle of view with a third-order aberration coefficient. Therefore, in the ultra-wide-angle camera 11 in which the maximum angle of view 2ω is 90 degrees or more, it is preferable that the imaging surface 133a has a curved shape. The imaging lens 116 is configured to maximize the correction effect of the field curvature, thereby shortening the optical total length TL and achieving height reduction while securing high image height and high performance. As a result, the ultra-wide-angle camera 11 can capture an ultra-wide-angle image with high image quality at a low height.

The imaging lens 116 can also achieve both ultra-wide-angle and good lens characteristics. Here, the good lens characteristic means improvement of the peripheral light amount and the image plane incident angle of the principal ray in addition to each aberration correction. The imaging lens 116 can secure a high number of pixels as the number of pixels of a wide-angle image in a case where the total angle of view with the highest imaging frequency is within 80 degrees.

In the ultra-wide-angle camera 11, the imaging surface 133a is curved concavely toward the object side, and the final surface is a spherical surface concavely toward the object side, or an aspherical surface concavely toward the object side as a whole, in which the sign of the inclination of the surface is not inverted with increasing distance from the optical axis. Therefore, it is easy to secure back focus and a manufacturing margin. As a result, it is possible to further shorten the optical total length TL.

In the ultra-wide-angle camera 11, the imaging surface 133a is curved concavely toward the object side, so that the position of the aperture stop 422 (452, 482, 512, 532, 562, 592, 622, 652, 682, 712, 742) and the center of curvature of the imaging surface 133a can be brought close to each other. Therefore, the ultra-wide-angle camera 11 is also advantageous in terms of improving the peripheral light amount and relaxing the light beam incident angle on the imaging surface 133a in addition to various aberration corrections.

Since the ultra-wide-angle camera 11 changes the method of reading the electric signal in the ultra-wide-angle mode and the wide-angle mode, the electric signal can be read by the method of reading the electric signal optimum for the characteristics of the imaging lens 116.

Specifically, characteristics such as aberration, a peripheral light amount, and a light beam incident angle on the imaging surface 133a are very good in a central region that is a region from the central portion to the intermediate region of the imaging lens 116, whereas these characteristics are relatively deteriorated in the peripheral region. Therefore, in a case where the imaging mode is the wide-angle mode, the electric signal is less likely to be affected by a decrease in the amount of light. Therefore, high resolution is secured by reading the electric signal in units of pixels. On the other hand, in a case where the imaging mode is the ultra-wide-angle mode, the light amount in the peripheral portion greatly decreases particularly in a dark place, and the noise of the electric signal increases. Therefore, the S/N ratio of the electric signal is improved by adding and reading the electric signals of the same color pixel group 271 (761, 762). Note that, since the number of effective pixels in the ultra-wide-angle mode is larger than the number of effective pixels in the wide-angle mode, the influence of the decrease in the number of pixels due to the addition of the electric signals (pixel addition) is relatively small.

### 2. Second Embodiment

### <External Configuration Example of Smartphone>

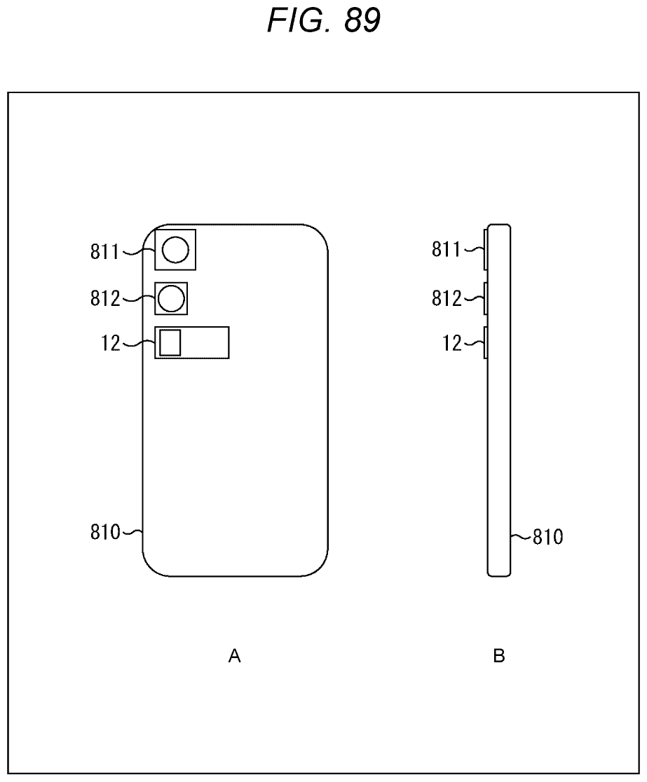

FIG. 89 is a diagram illustrating an external configuration example of a smartphone including an ultra-wide-angle camera as a second embodiment of an imaging device to which the present technology is applied.

A of FIG. 89 is a rear front view of the smartphone 810, and B of FIG. 89 is a side view of the smartphone 810.

In the smartphone 810 in FIG. 89, portions corresponding to those of the smartphone 10 in FIG. 1 are denoted by the same reference signs. Therefore, description of the portions will be appropriately omitted, and description will be given focusing on portions different from the smartphone 10. The smartphone 810 is different from the smartphone 10 in that an ultra-wide-angle camera and a wide-angle camera are separately provided, and the other configurations are similar to those of the smartphone 10 in FIG. 89.

Specifically, the smartphone 810 includes the wide-angle camera 811, the ultra-wide-angle camera 812, and the telephoto camera 12 as multi-view cameras. The wide-angle camera 811 captures a wide-angle image. The ultra-wide-angle camera 812 is different from the ultra-wide-angle camera 11 in that the imaging mode is only the ultra-wide-angle mode and that the method of reading the electric signal in the ultra-wide-angle mode is a method of individually reading the electric signal of each pixel 160, and is configured similarly to the ultra-wide-angle camera 11 in the other respects. Therefore, the ultra-wide-angle camera 812 can realize imaging of an ultra-wide-angle image with high image quality at a low height, similarly to the ultra-wide-angle camera 11.

### 3. Third Embodiment

### <Configuration Example of Ultra-Wide-Angle Sensor>

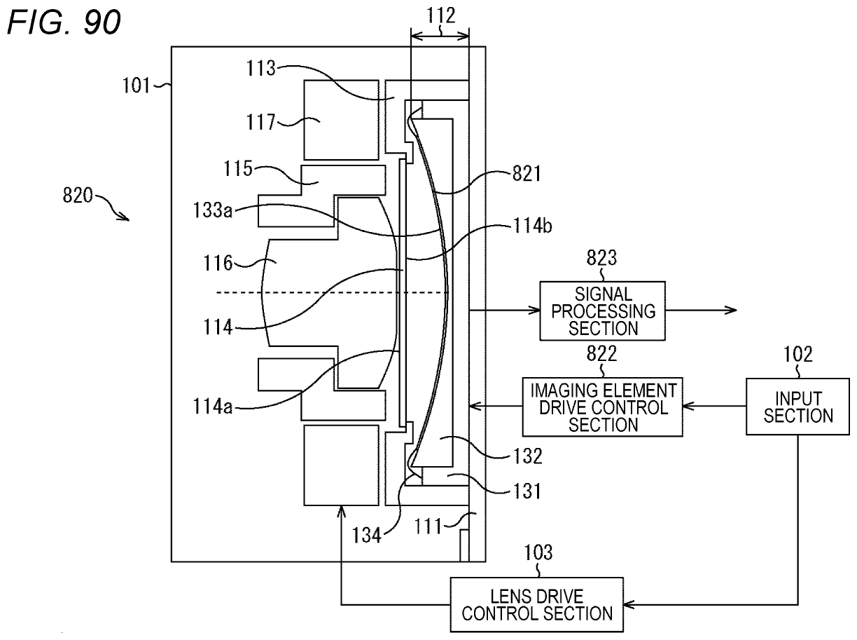

FIG. 90 is a diagram illustrating a configuration example of an ultra-wide-angle sensor that is a third embodiment of an imaging device to which the present technology is applied.

In the ultra-wide-angle sensor 820 of FIG. 90, portions corresponding to those of the ultra-wide-angle camera 11 of FIG. 2 are denoted by the same reference signs. Therefore, description of the portions will be appropriately omitted, and description will be given focusing on portions different from the ultra-wide-angle camera 11. The ultra-wide-angle sensor 820 is different from the ultra-wide-angle camera 11 in that an ultra-wide-angle phase difference image representing a phase difference of an ultra-wide-angle image is generated instead of the ultra-wide-angle image, and the other configurations are similar to those of the ultra-wide-angle camera 11.

Specifically, the ultra-wide-angle sensor 820 is different from the ultra-wide-angle camera 11 in including an imaging element 381, an imaging element drive control section 822, and a signal processing section 823 instead of the imaging element 133, the imaging element drive control section 104, and the signal processing section 105. Other configurations are similar to those of the ultra-wide-angle camera 11.

The imaging element 381 is different from the imaging element 133 in that a pixel includes one or more photoelectric conversion sections, an on-chip lens is formed for each phase pixel block including pixels corresponding to a plurality of adjacent photoelectric conversion sections, and an image signal is generated in units of photoelectric conversion sections. Other configurations are similar to those of the imaging element 133.

The imaging element drive control section 822 is different from the imaging element drive control section 104 in that it generates a signal instructing an effective pixel as an imaging element drive control signal, and is otherwise configured similarly to the imaging element drive control section 822.

The signal processing section 823 holds the image signal output from the imaging element 381 in units of photoelectric conversion sections in a built-in memory as necessary. For each phase pixel block, the signal processing section 823 (phase difference detection section) detects a phase difference of an image signal due to parallax of a plurality of photoelectric conversion sections constituting the phase pixel block, and generates an ultra-wide-angle phase difference image representing the phase difference. The signal processing section 823 calculates and outputs the distance to the subject on the basis of the ultra-wide-angle phase difference image.

### <Configuration Example of Imaging Element>

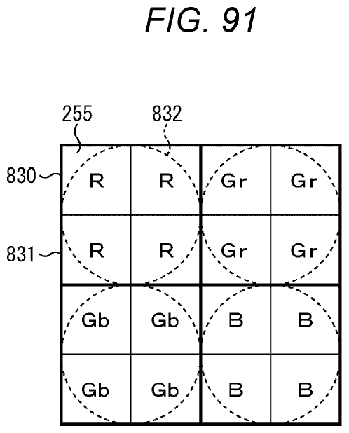

FIG. 91 is a top view illustrating a configuration example of the imaging element 381 in FIG. 90.

Note that, in FIG. 91, in order to simplify the drawing, only a region of 4×4 pixels 830 arranged four in the horizontal direction and four in the vertical direction in the imaging element 381 is illustrated, and the antireflection film 259 is omitted. In FIG. 91, portions corresponding to those in FIG. 6 are denoted by the same reference signs. Therefore, description of the portions will be appropriately omitted, and description will be given focusing on portions different from that in FIG. 6.

In the example of FIG. 91, the array of the 4×4 pixels 830 is a Bayer array of the phase pixel block 831 including 2×2 pixels 830 having the color filters 255 of the same color, that is, a Quad Bayer array. The pixel 830 is configured similarly to the pixel 160.

The on-chip lens 832 formed on the color filter 255 of each pixel 830 is formed in units of phase pixel blocks 831. As a result, parallax occurs between two adjacent pixels 830 in the phase pixel block 831. Therefore, the signal processing section 823 detects the phase difference between the image signals of the two pixels 830. Note that the pixels 830 in the phase pixel block 831 may share the charge holding section 202.

### <Description of Effect of Imaging Element>

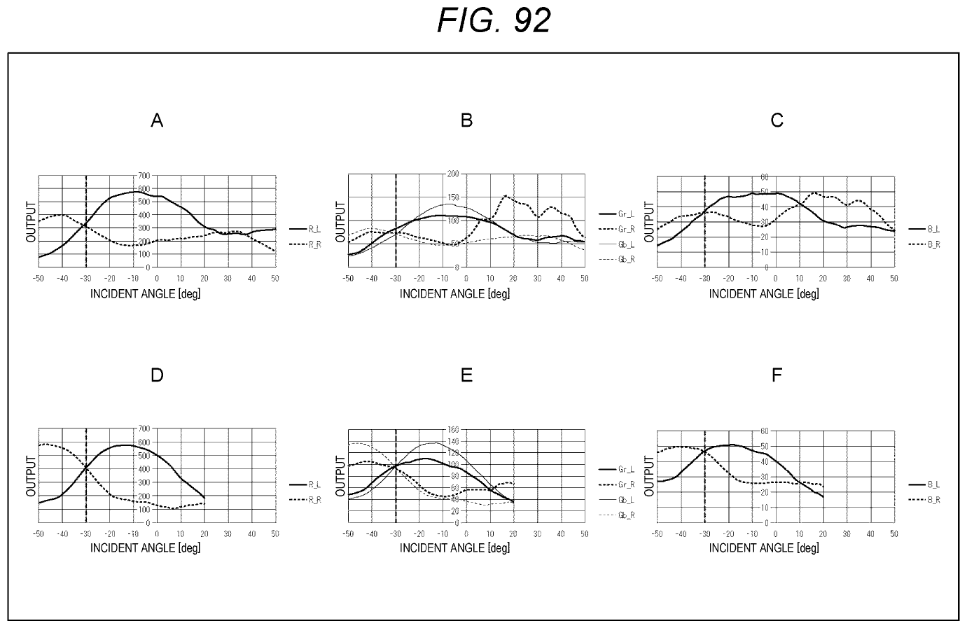

FIG. 92 is a diagram for explaining an effect of the imaging element 381.

A to C of FIG. 92 are graphs illustrating light receiving angle distributions of pixels having red, green, and blue color filters adjacent on the left and right in a phase pixel block of an imaging element having a pupil correction function and a flat imaging surface and having the configuration of the pixel illustrated in FIG. 91, respectively. The light receiving angle distribution is a distribution representing the incident angle dependence of the image signal output when the parallel light is incident. D to F of FIG. 92 are graphs illustrating light reception angle distributions of the pixels 830 including the red, green, and blue color filters 255 adjacent to the left and right in the phase pixel block 831 of the imaging element 381 not having the pupil correction function, respectively.

In A to F of FIG. 92, the horizontal axis represents the incident angle [deg] of the parallel light having the wavelength of 650 nm incident on the pixel, and the vertical axis represents the output value of the image signal. In A, C, D, and F of FIG. 92, a solid line represents the light receiving angle distribution of the left pixel, and a dotted line represents the light receiving angle distribution of the right pixel. In B and E of FIG. 92, a thick solid line represents the light receiving angle distribution of the left pixel in the phase pixel block having the green (Gr) color filter in the upper right of the Quad Bayer array, and a thick dotted line represents the light receiving angle distribution of the right pixel. In B and E of FIG. 92, a thin solid line represents the light receiving angle distribution of the left pixel in the phase pixel block having the color filter of green (Gr) at the lower left of the Quad Bayer array, and a thin dotted line represents the light receiving angle distribution of the right pixel. Note that, in FIG. 92, the CRA at the end portion of the maximum angle of view is −30 deg.

As illustrated in A to C of FIG. 92, in the imaging element having the flat imaging surface, the light receiving angle distribution is distorted due to the anisotropy of vignetting and color mixture even in a case where pupil correction is performed on obliquely incident light. As a result, at the time of detecting the phase difference, a mismatch between image signals of pixels having different parallaxes occurs, and the distance measurement accuracy is deteriorated.

On the other hand, as illustrated in D to F of FIG. 92, in the imaging element 381 having a curved shape, a light receiving angle distribution having good symmetry without anisotropy of vignetting or color mixture as compared with A to C of FIG. 92 is obtained. Therefore, the separation of the image signals of the left pixel 830 and the right pixel 830 in the phase pixel block 831 is high. As a result, good distance measurement accuracy can be obtained.

Note that, in the green (Gb) pixel 830 and the green (Gr) pixel 830, the change in the image signal depending on the incident angle differs depending on the difference in color mixture leaking from the red pixel 830. However, since the cross points of the image signals of the left and right green (Gb) pixels 830 and the cross points of the image signals of the left and right green (Gr) pixels 830 coincide with each other and symmetry in the left and right pixels 830 is maintained, there is no problem in distance measurement accuracy.

### <Another Configuration Example of Imaging Element>

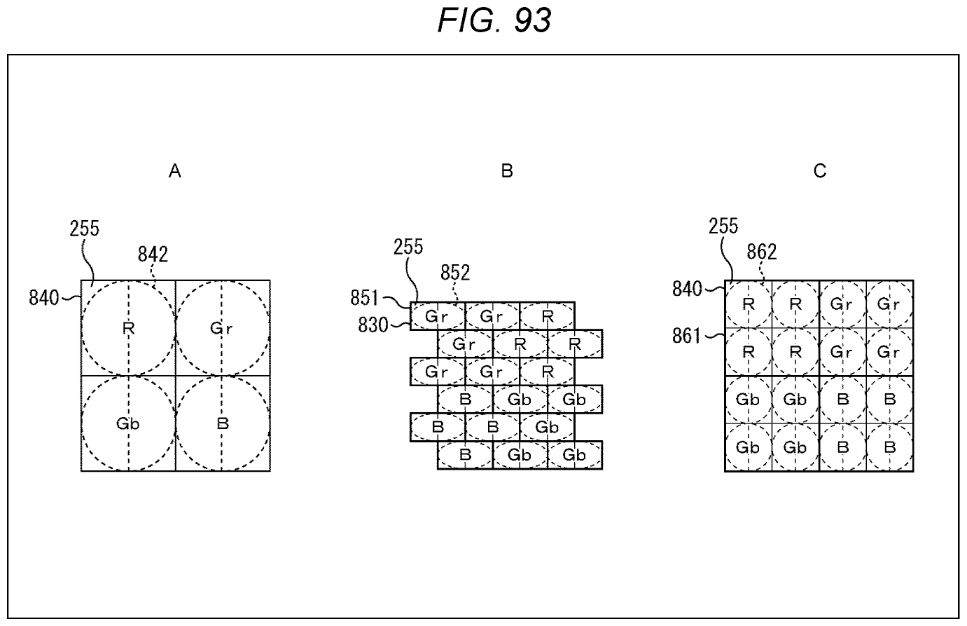

FIG. 93 is a top view illustrating another configuration example of the imaging element 381.

Note that, in FIG. 93, in order to simplify the drawing, only a region of some pixels of the imaging element 381 is illustrated, and the antireflection film 259 is omitted. In FIG. 93, portions corresponding to those in FIG. 91 are denoted by the same reference signs. Therefore, description of the portions will be appropriately omitted, and description will be given focusing on portions different from that in FIG. 6.

In the example in A of FIG. 93, the imaging element 381 has a plurality of pixels 840, and the array of 2×2 pixels 840 is a Bayer array. The configuration of the pixel 840 is different from the configuration of the pixel 160 in that two photoelectric conversion sections adjacent in the horizontal direction are included, and the other configurations are similar to those of the pixel 160. Pixels 840 corresponding to two horizontally adjacent photoelectric conversion sections having color filters 255 of the same color are set as phase pixel blocks, and the on-chip lens 842 is formed in units of pixels 840. In the example of A of FIG. 93, the phase difference of the image signal due to the parallax of the two photoelectric conversion sections included in the pixel 840 is detected.

In the example in B of FIG. 93, the imaging element 381 has a plurality of pixels 830, and the array of the pixels 830 is a Bayer array of a red pixel group, a green pixel group, and a blue pixel group. The red pixel group includes pixels 830 of three rows including red color filters 255. The pixels 830 in the first and third rows from the top of the three rows are 1×2 pixels 830, and the pixels 830 in the second row are 1×4 pixels 830 shifted by one pixel in the left direction with respect to the first row. The green pixel group includes pixels 830 of three rows having green color filters 255. The pixels 830 in the first and third rows from the top of the three rows are 1×4 pixels 830, and the pixels 830 in the second row are 1×2 pixels 830 shifted by one pixel in the right direction with respect to the first row. The blue pixel group is different from the red pixel group in that the color of the color filter 255 is blue, and is otherwise configured similarly to the red pixel group.

1×2 pixels 830 corresponding to two horizontally adjacent photoelectric conversion sections having color filters 255 of the same color are set in the phase pixel block 851, and the color filters 255 are formed in units of the phase pixel block 851. In the example of A of FIG. 93, the phase difference of the image signal due to the parallax of the two pixels 830 constituting the phase pixel block 851 is detected.

In the example in C of FIG. 93, the imaging element 381 has a plurality of pixels 840, and the array of 4×4 pixels 840 is a Bayer array of a same color pixel group 861 including 2×2 pixels 840 having color filters 255 of the same color, that is, a Quad Bayer array. Pixels 840 corresponding to two horizontally adjacent photoelectric conversion sections having color filters 255 of the same color are set as phase pixel blocks, and the on-chip lens 862 is formed in units of pixels 840. In the example of C of FIG. 93, the phase difference of the image signal due to the parallax of the two photoelectric conversion sections included in the pixel 840 is detected.

As described above, the signal processing section 823 detects the phase difference of the image signal due to the parallax of the plurality of adjacent photoelectric conversion sections in the phase pixel block. Therefore, the signal processing section 823 can measure the distance to the subject on the basis of the phase difference. At this time, since the imaging element 381 has a curved shape, good distance measurement accuracy can be obtained as described with reference to FIG. 92.

Note that the infrared cut filter 114 may be curved instead of a parallel flat plate. In this case, it is easy to secure the distance between the lens 437 (467, 497, 527, 547, 577, 607, 637, 667, 697, 726, 757) or the imaging surface 133a and the infrared cut filter 114, so that the optical total length TL can be further shortened. In addition, similarly to the effect of the curvature of the imaging surface 133a, it is possible to reduce the light beam incident angle of off-axis light to the infrared cut filter 114.

The color type of the color filter 255 is not limited to the three colors of red, green, and blue. For example, the color of the color filter 255 may be three colors of cyan, magenta, and yellow or white.

The number of lenses of the imaging lens 116 is not limited to the above-described number as long as it is one or more. The number of lenses is desirably seven or more. In a case where the number of lenses is seven or more, the F-number is 2.2 or less. As a result, it is possible to perform good aberration correction up to the peripheral portion while shortening the optical total length TL.

A metalens having a nanostructure may be disposed on the object side with respect to the imaging surface 133a. In general, since the metalens have low light use efficiency at oblique incidence, it is preferable to combine the metalens with the imaging surface 133a having a curved shape.

The metalens can have, for example, a pupil correction function of efficiently allowing a light beam reaching the imaging surface 133a to be incident on the pixel 160 (330, 340), a color separation function as a substitute for the color filter 255, and the like. The metalens can also have an antireflection function excellent in angle characteristics, a function of increasing the focal depth by arranging the minimum lenses in parallel, and the like.

It is desirable to divide a region on the imaging element 133a into a central region and a peripheral region, form a metalens having a pupil correction function in the central region, and form a metalens having a color separation function in the peripheral region. The range of the intermediate region and the peripheral region can be appropriately set according to the purpose of use. For example, the intermediate region can be a region having a half angle of view of 40 degrees, and the peripheral region can be a region having a half angle of view of 60 degrees.

While the light use efficiency is greatly improved in the metalens having the color separation function as compared with the color filter 255, the resolution is deteriorated. Therefore, by forming the metalens having the pupil correction function in the central region and forming the metalens having the color separation function in the peripheral region, it is possible to secure the resolution of the intermediate region and improve the light use efficiency of the peripheral region. Formation of the metalens having the pupil correction function in the central region and formation of the metalens having the color separation function in the peripheral region can be integrally performed by a semiconductor process. Therefore, the imaging surface 133a having such a metalens can be manufactured with a large area and at low cost.

Unnecessary light and degradation of resolution caused by the metalens, and a change in an image at a boundary portion of the metalens are desirably corrected by the signal processing section 105 (323) or the like at a subsequent stage.

### <4. Application Example to Mobile Body>

The technology according to the present disclosure (present technology) can be applied to various products. For example, the technology according to the present disclosure may be realized as a device mounted on any type of mobile body such as an automobile, an electric vehicle, a hybrid electric vehicle, a motorcycle, a bicycle, a personal mobility, an airplane, a drone, a ship, and a robot.

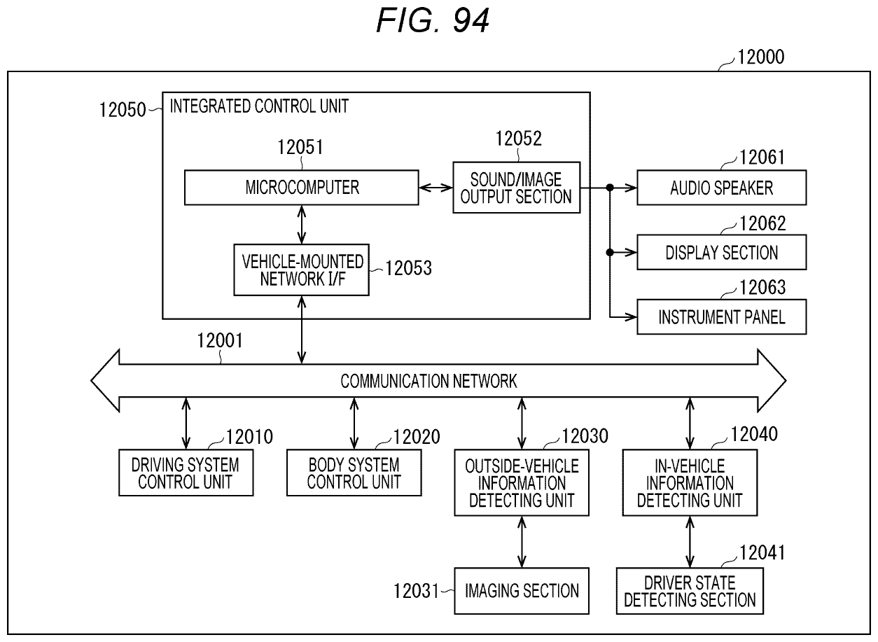

FIG. 94 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 94, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 94, an audio speaker 12061, a display section 12062, and an instrument panel 12063 are illustrated as the output device. The display section 12062 may, for example, include at least one of an on-board display and a head-up display.

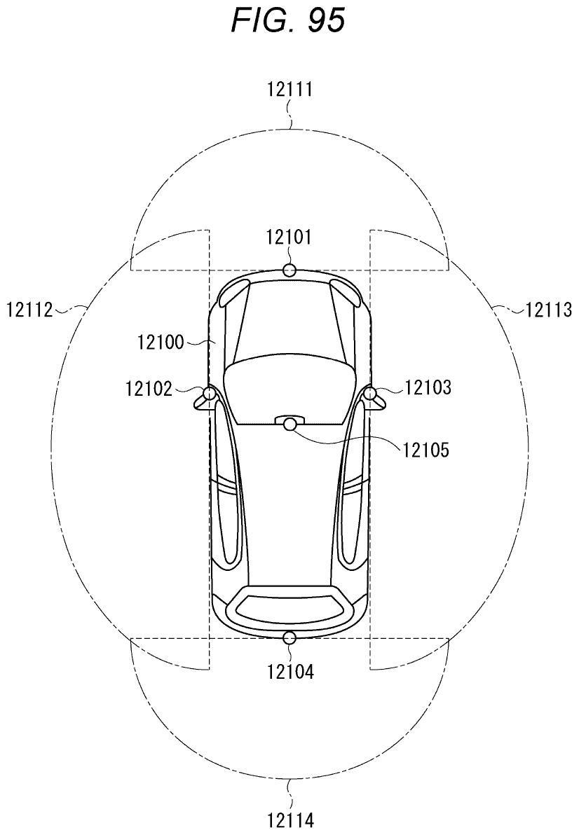

FIG. 95 is a diagram depicting an example of the installation position of the imaging section 12031.

In FIG. 95, the vehicle 12100 includes imaging sections 12101, 12102, 12103, 12104, and 12105 as the imaging section 12031.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The front images acquired by the imaging sections 12101 and 12105 are used mainly to detect a preceding vehicle, a pedestrian, an obstacle, a signal, a traffic sign, a lane, or the like.

Incidentally, FIG. 95 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been described above. The technology according to the present disclosure can be applied to the imaging section 12031 and the like among the configurations described above. Specifically, the ultra-wide-angle camera 11 (312) and the ultra-wide-angle sensor 820 can be applied to the imaging section 12031. By applying the technology according to the present disclosure to the imaging section 12031, it is possible to realize imaging of an ultra-wide-angle image or an ultra-wide-angle phase difference image with high image quality at a low height. As a result, driver's fatigue can be reduced without impairing the design of the vehicle 12100.

The embodiments of the present technology are not limited to the above-described embodiments, and various modifications can be made without departing from the gist of the present technology.

For example, a form in which all or some of the plurality of embodiments described above are combined can be adopted. Specifically, the ultra-wide-angle camera 11 (312) can also generate a wide-angle phase difference image and an ultra-wide-angle phase difference image indicating a phase difference of a wide-angle image, and the ultra-wide-angle sensor 820 can also generate an ultra-wide-angle image and a wide-angle image.

Note that the effects described in the present specification are merely examples and are not limited, and effects other than those described in the present specification may be provided.

The present technology can have the following configurations.

(1)

An imaging lens including
a lens group including one or more lenses that form an optical image of an object on an imaging surface having a curved shape, in which
when a maximum angle of view is 90 degrees or more,
a first image height that is an image height in a case where a half angle of view is 40 degrees is Yw, a second image height that is an image height in a case where a half angle of view is a maximum half angle of view that is half of the maximum angle of view is Y, an optical total length that is a distance on an optical axis from an object-side surface of a lens closest to an object side to the imaging surface in the lens group is TL, a focal length of the entire imaging lens is f, and a focal length of the lens closest to the object side is f1,
the following conditions are satisfied:

$$0.27 \leq {( Yw / Y )}^{2} \leq 0 \text{.7} ,$$

$$0.3 \leq TL / 2 Y \leq 0.6 \; 95 ,$$

$$- 0.3 \; 5 \leq f / f 1 \leq 0.73 .$$

(2)

The imaging lens according to (1), in which
the lens group includes six or more lenses including at least one aspherical lens, and
a F-number is 2.5 or less.
   (3)

The imaging lens according to (1) or (2), in which
when a peripheral light amount ratio with respect to a center of the imaging surface in a case where the half angle of view is 40 degrees is RIYw and the maximum half angle of view is ω,
the following condition is satisfied:

$$1.2 \leq R IYw / ( {cos ( ω )}^{4} ) \leq 35 .$$

(4)

The imaging lens according to any one of (1) to (3), in which
when a distance on an optical axis from the imaging surface to an exit pupil of a light beam having the second image height is EXPY and a radius of curvature of a center of the imaging surface is Ri,
the following condition is satisfied:

$$0.01 \leq EXPY / Ri \leq 0.39 .$$

(5)

The imaging lens according to any one of (1) to (4), in which
when the second image height is Y, and a distance on an optical axis from a surface on an imaging surface side of a lens closest to the imaging surface side in the lens group to the imaging surface is fb,
the following condition is satisfied:

$$9.7 \leq fb \times 2 Y \leq 28.4 .$$

(6)

The imaging lens according to any one of (1) to (5), further including
an aperture stop, in which
when a radius of curvature of a center of the imaging surface is Ri and a distance on an optical axis from the aperture stop to the imaging surface is Ts,
the following condition is satisfied:

$$- 50 \leq Ri / Ts \leq - 1.95 .$$

(7)

The imaging lens according to any one of (1) to (6), in which
the imaging surface is concavely curved toward the object side, and
a surface on an imaging surface side of a lens closest to the imaging surface side in the lens group is a spherical surface concave to the object side or an aspherical surface concave to the object side as a whole in which a sign of an inclination of the surface is not inverted with increasing a distance from an optical axis.
   (8)

The imaging lens according to any one of (1) to (7), in which
the imaging surface has an aspherical shape curved concavely toward the object side, and
a displacement amount of the imaging surface with respect to a spherical surface in a direction away from the imaging lens increases as a distance from an optical axis increases.
   (9)

The imaging lens according to any one of (1) to (8), in which
when an optical distortion at the second image height is DY, an optical distortion at the first image height is Dw, the second image height is Y, and the first image height is Yw,
the following condition is satisfied:

$$- 0.16 \leq ( D Y - Dw ) / ( Y - Y w ) \leq 0.16 .$$

(10)

The imaging lens according to any one of (1) to (9), in which
when a maximum effective radius of a surface on the object side of the lens closest to the object side is Ha and a maximum effective radius of a surface on the imaging surface side of a lens closest to the imaging surface side in the lens group is Hb,
the following condition is satisfied:

$$0.475 \leq Ha / Hb \leq 0.68 .$$

(11)

The imaging lens according to any one of (1) to (5) and (7) to (10), further including
an aperture stop, in which
when a distance on an optical axis from the aperture stop to the imaging surface is Ts and the optical total length is TL,
the following condition is satisfied:

$$0.73 \leq Ts / TL \leq 0.9 .$$

(12)

An imaging device including:
a lens group including one or more lenses that form an optical image of an object on an imaging surface having a curved shape;
an imaging lens configured such that,
when a maximum angle of view is 90 degrees or more,
a first image height that is an image height in a case where a half angle of view is 40 degrees is Yw, a second image height that is an image height in a case where a half angle of view is a maximum half angle of view that is half of the maximum angle of view is Y, an optical total length that is a distance on an optical axis from an object-side surface of a lens closest to an object side to the imaging surface in the lens group is TL, a focal length of the entire imaging lens is f, and a focal length of the lens closest to the object side is f1,
the following conditions are satisfied:

$$0.27 \leq {( Yw / Y )}^{2} \leq 0 \text{.7} ,$$

$$0.3 \leq TL / 2 Y \leq 0.6 \; 95 ,$$

$$- 0.3 \; 5 \leq f / f 1 \leq 0.73 ;$$

and
an imaging element having the imaging surface, in which
a pixel array section including a plurality of pixels is formed on the imaging surface, and
the pixel includes one or more photoelectric conversion sections that converts light corresponding to the optical image formed on the imaging surface into a charge, and outputs an electric signal corresponding to the charge.
   (13)

The imaging device according to (12), further including
an image generation section that generates, on the basis of the electric signal read from the pixel, an ultra-wide-angle image having an angle of view in a range from the maximum angle of view to a predetermined angle, or a wide-angle image having an angle of view smaller than the predetermined angle.
   (14)

The imaging device according to (13), in which
an ultra-wide-angle reading method which is a reading method of the electric signal at a time of generating the ultra-wide-angle image and a wide-angle reading method which is a reading method of the electric signal at a time of generating the wide-angle image are different.
   (15)

The imaging device according to (14), further including
a color filter formed on the imaging lens side of the pixel, in which
the ultra-wide-angle reading method is a method of adding and reading the electric signals of the pixels having the color filters of respective colors for each pixel block including a plurality of the pixels, and
the wide-angle reading method is a method of individually reading the electric signal for each of the pixels.
   (16)

The imaging device according to (15), in which
the pixels having the color filters of a same color in the pixel block share a charge holding section that holds the charge, and
the ultra-wide-angle reading method is a method of reading the electric signal corresponding to the charge retained in the charge retaining section.
   (17)

The imaging device according to any one of (12) to (16), further including
a phase difference detection section that detects a phase difference of the electric signal due to parallax of a plurality of adjacent photoelectric conversion sections.
   (18)

An imaging lens including
a lens group including one or more lenses that form an optical image of an object on an imaging surface having a curved shape, in which
when a maximum angle of view is 90 degrees or more,
a first image height that is an image height in a case where a half angle of view is 40 degrees is Yw, a second image height that is an image height in a case where a half angle of view is a maximum half angle of view that is half of the maximum angle of view is Y, an optical total length that is a distance on an optical axis from an object-side surface of a lens closest to an object side to the imaging surface in the lens group is TL, and an optical distortion at the first image height is Dw,
the following conditions are satisfied:

$$0.27 \leq {( Yw / Y )}^{2} \leq 0 \text{.7} ,$$

$$0.3 \leq TL / 2 Y \leq 0.6 \; 95 ,$$

$$0.001 \leq \vert Dw / Yw \vert \leq 0. 08 .$$

(19)

The imaging lens according to (18), in which
the lens group includes six or more lenses including at least one aspherical lens, and
a F-number is 2.5 or less.
   (20)

The imaging lens according to (18) or (19), in which
when a peripheral light amount ratio with respect to a center of the imaging surface in a case where the half angle of view is 40 degrees is RIYw and the maximum half angle of view is ω,
the following condition is satisfied:

$$1. 2 \leq R IYw / ( {cos ( ω )}^{4} ) \leq 35 .$$

(21)

The imaging lens according to any one of (18) to (20), in which
when a distance on an optical axis from the imaging surface to an exit pupil of a light beam having the second image height is EXPY and a radius of curvature of a center of the imaging surface is Ri,
the following condition is satisfied:

$$0.01 \leq EXPY / Ri \leq 0.39 .$$

(22)

The imaging lens according to any one of (18) to (21), in which
when the second image height is Y, and a distance on an optical axis from a surface on an imaging surface side of a lens closest to the imaging surface side in the lens group to the imaging surface is fb,
the following condition is satisfied:

$$9.7 \leq fb \times 2 Y \leq 28.4 .$$

(23)

The imaging lens according to any one of (18) to (22), further including
an aperture stop, in which
when a radius of curvature of a center of the imaging surface is Ri and a distance on an optical axis from the aperture stop to the imaging surface is Ts,
the following condition is satisfied:

$$- 50 \leq Ri / Ts \leq - 1.95 .$$

(24)

The imaging lens according to any one of (18) to (23), in which
the imaging surface is concavely curved toward the object side, and
a surface on an imaging surface side of a lens closest to the imaging surface side in the lens group is a spherical surface concave to the object side or an aspherical surface concave to the object side as a whole in which a sign of an inclination of the surface is not inverted with increasing a distance from an optical axis.
   (25)

The imaging lens according to any one of (18) to (24), in which
the imaging surface has an aspherical shape curved concavely toward the object side, and
a displacement amount of the imaging surface with respect to a spherical surface in a direction away from the imaging lens increases as a distance from an optical axis increases.
   (26)

The imaging lens according to any one of (18) to (25), in which
when an optical distortion at the second image height is DY, an optical distortion at the first image height is Dw, the second image height is Y, and the first image height is Yw,
the following condition is satisfied:

$$- 0.16 \leq ( D Y - Dw ) / ( Y - Y w ) \leq 0.16 .$$

(27)

The imaging lens according to any one of (18) to (26), in which
when a maximum effective radius of a surface on the object side of the lens closest to the object side is Ha and a maximum effective radius of a surface on the imaging surface side of a lens closest to the imaging surface side in the lens group is Hb,
the following condition is satisfied:

$$0.475 \leq Ha / Hb \leq 0.68 .$$

(28)

The imaging lens according to any one of (18) to (22) and (24) to (27), further including
an aperture stop, in which
when a distance on an optical axis from the aperture stop to the imaging surface is Ts and the optical total length is TL,
the following condition is satisfied:

$$0.73 \leq Ts / TL \leq 0.9 .$$

(29)

An imaging device including:
a lens group including one or more lenses that form an optical image of an object on an imaging surface having a curved shape;
an imaging lens configured such that,
when a maximum angle of view is 90 degrees or more,
a first image height that is an image height in a case where a half angle of view is 40 degrees is Yw, a second image height that is an image height in a case where a half angle of view is a maximum half angle of view that is half of the maximum angle of view is Y, an optical total length that is a distance on an optical axis from an object-side surface of a lens closest to an object side to the imaging surface in the lens group is TL, and an optical distortion at the first image height is Dw,
the following conditions are satisfied:

$$0.27 \leq {( Yw / Y )}^{2} \leq 0 \text{.7} ,$$

$$0.3 \leq TL / 2 Y \leq 0.6 \; 95 ,$$

$$0.001 \leq \vert Dw / Yw \vert \leq 0.08 ;$$

and
an imaging element having the imaging surface, in which
a pixel array section including a plurality of pixels is formed on the imaging surface, and
the pixel includes one or more photoelectric conversion sections that converts light corresponding to the optical image formed on the imaging surface into a charge, and outputs an electric signal corresponding to the charge.
   (30)

The imaging device according to (29), further including
an image generation section that generates, on the basis of the electric signal read from the pixel, an ultra-wide-angle image having an angle of view in a range from the maximum angle of view to a predetermined angle, or a wide-angle image having an angle of view smaller than the predetermined angle.
   (31)

The imaging device according to (30), in which
an ultra-wide-angle reading method which is a reading method of the electric signal at a time of generating the ultra-wide-angle image and a wide-angle reading method which is a reading method of the electric signal at a time of generating the wide-angle image are different.
   (32)

The imaging device according to (31), further including
a color filter formed on the imaging lens side of the pixel, in which
the ultra-wide-angle reading method is a method of adding and reading the electric signals of the pixels having the color filters of respective colors for each pixel block including a plurality of the pixels, and
the wide-angle reading method is a method of individually reading the electric signal for each of the pixels.
   (33)

The imaging device according to (32), in which
the pixels having the color filters of a same color in the pixel block share a charge holding section that holds the charge, and
the ultra-wide-angle reading method is a method of reading the electric signal corresponding to the charge retained in the charge retaining section.
   (34)

The imaging device according to any one of (29) to (33), further including
a phase difference detection section that detects a phase difference of the electric signal due to parallax of a plurality of adjacent photoelectric conversion sections.

### REFERENCE SIGNS LIST

11 Ultra-wide-angle camera
105 Signal processing section
116 Imaging lens
133 Imaging element
133a Imaging surface
151 Pixel array section
160 Pixel
201 Photoelectric conversion section
202 Charge holding section
255 Color filter
421 Lens group
422 Aperture stop
431 Lens
431a Surface
432 to 437 Lens
437a Surface
451 Lens group
452 Aperture stop
461 Lens
461a Surface
462 to 467 Lens
467a Surface
481 Lens group
482 Aperture stop
491 Lens
491a Surface
492 to 497 Lens
497a Surface
511 Lens group
512 Aperture stop
521 Lens
521a Surface
522 to 527 Lens
522a Surface
531 Lens group
532 Aperture stop
541 Lens
541a Surface
542 to 547 Lens
547a Surface
561 Lens group
562 Aperture stop
571 Lens
571a Surface
572 to 577 Lens
577a Surface
591 Lens group
592 Aperture stop
601 Lens
601a Surface
602 to 607 Lens
607a Surface
621 Lens group
622 Aperture stop
631 Lens
631a Surface
632 to 637 Lens
637a Surface
651 Lens group
652 Aperture stop
661 Lens
661a Surface
662 to 667 Lens
667a Surface
681 Lens group
682 Aperture stop
691 Lens
691a Surface
692 to 697 Lens
697a Surface
711 Lens group
712 Aperture stop
721 Lens
721a Surface
722 to 726 Lens
726a Surface
741 Lens group
742 Aperture stop
751 Lens
751a Surface
752 to 757 Lens
757a Surface
812 Ultra-wide-angle camera
820 Ultra-wide-angle sensor
821 Imaging element
823 Signal processing section
830, 840 Pixel

What is claimed is:

1. An imaging lens, comprising
a lens group including one or more lenses that form an optical image of an object on an imaging surface having a curved shape, wherein
when a maximum angle of view is 90 degrees or more,
a first image height that is an image height in a case where a half angle of view is 40 degrees is Yw, a second image height that is an image height in a case where a half angle of view is a maximum half angle of view that is half of the maximum angle of view is Y, an optical total length that is a distance on an optical axis from an object-side surface of a lens closest to an object side to the imaging surface in the lens group is TL, a focal length of the entire imaging lens is f, and a focal length of the lens closest to the object side is f1,
the following conditions are satisfied:
$$0.27 \leq {( Yw / Y )}^{2} \leq 0 \text{.7} ,$$
$$0.3 \leq TL / 2 Y \leq 0.6 \; 95 ,$$
$$- 0.3 \; 5 \leq f / f 1 \leq 0.7 3 .$$

2. The imaging lens according to claim 1, wherein
the lens group includes six or more lenses including at least one aspherical lens, and
a F-number is 2.5 or less.

3. The imaging lens according to claim 1, wherein
when a peripheral light amount ratio with respect to a center of the imaging surface in a case where the half angle of view is 40 degrees is RIYw and the maximum half angle of view is @,
the following condition is satisfied:
$$2 \leq R IYw / ( {cos ( ω )}^{4} ) \leq 35 .$$

4. The imaging lens according to claim 1, wherein
when a distance on an optical axis from the imaging surface to an exit pupil of a light beam having the second image height is EXPY and a radius of curvature of a center of the imaging surface is Ri,
the following condition is satisfied:
$$0.01 \leq EXP Y / Ri \leq 0.39 .$$
$$0.02$$

5. The imaging lens according to claim 1, wherein
when the second image height is Y, and a distance on an optical axis from a surface on an imaging surface side of a lens closest to the imaging surface side in the lens group to the imaging surface is fb,
the following condition is satisfied:
$$9.7 \leq fb \times 2 Y \leq 28.4 .$$

6. The imaging lens according to claim 1, further comprising
an aperture stop, wherein
when a radius of curvature of a center of the imaging surface is Ri and a distance on an optical axis from the aperture stop to the imaging surface is Ts,
the following condition is satisfied:
$$- 50 \leq Ri / Ts \leq - 1.95 .$$

7. The imaging lens according to claim 1, wherein
the imaging surface is concavely curved toward the object side, and
a surface on an imaging surface side of a lens closest to the imaging surface side in the lens group is a spherical surface concave to the object side or an aspherical surface concave to the object side as a whole in which a sign of an inclination of the surface is not inverted with increasing a distance from an optical axis.

8. The imaging lens according to claim 1, wherein
the imaging surface has an aspherical shape curved concavely toward the object side, and
a displacement amount of the imaging surface with respect to a spherical surface in a direction away from the imaging lens increases as a distance from an optical axis increases.

9. The imaging lens according to claim 1, wherein
when an optical distortion at the second image height is DY, an optical distortion at the first image height is Dw, the second image height is Y, and the first image height is Yw,
the following condition is satisfied:
$$- 0.16 \leq ( D Y - Dw ) / ( Y - Y w ) \leq 0.16 .$$

10. The imaging lens according to claim 1, wherein
when a maximum effective radius of a surface on the object side of the lens closest to the object side is Ha and a maximum effective radius of a surface on the imaging surface side of a lens closest to the imaging surface side in the lens group is Hb,
the following condition is satisfied:
$$0.475 \leq Ha / Hb \leq 0.68 .$$

11. The imaging lens according to claim 1, further comprising
an aperture stop, wherein
when a distance on an optical axis from the aperture stop to the imaging surface is Ts and the optical total length is TL,
the following condition is satisfied:
$$0.73 \leq Ts / TL \leq 0.9 .$$

12. An imaging device, comprising:
a lens group including one or more lenses that form an optical image of an object on an imaging surface having a curved shape;
an imaging lens configured such that,
when a maximum angle of view is 90 degrees or more,
a first image height that is an image height in a case where a half angle of view is 40 degrees is Yw, a second image height that is an image height in a case where a half angle of view is a maximum half angle of view that is half of the maximum angle of view is Y, an optical total length that is a distance on an optical axis from an object-side surface of a lens closest to an object side to the imaging surface in the lens group is TL, a focal length of the entire imaging lens is f, and a focal length of the lens closest to the object side is f1,
the following conditions are satisfied:
$$0.27 \leq {( Yw / Y )}^{2} \leq 0 \text{.7} ,$$
$$0.3 \leq TL / 2 Y \leq 0.6 \; 95 ,$$
$$- 0.3 \; 5 \leq f / f 1 \leq 0.73 ;$$
and
an imaging element having the imaging surface, wherein
a pixel array section including a plurality of pixels is formed on the imaging surface, and
the pixel includes one or more photoelectric conversion sections that converts light corresponding to the optical image formed on the imaging surface into a charge, and outputs an electric signal corresponding to the charge.

13. The imaging device according to claim 12, further comprising
an image generation section that generates, on a basis of the electric signal read from the pixel, an ultra-wide-angle image having an angle of view in a range from the maximum angle of view to a predetermined angle, or a wide-angle image having an angle of view smaller than the predetermined angle.

14. The imaging device according to claim 13, wherein
an ultra-wide-angle reading method which is a reading method of the electric signal at a time of generating the ultra-wide-angle image and a wide-angle reading method which is a reading method of the electric signal at a time of generating the wide-angle image are different.

15. The imaging device according to claim 14, further comprising
a color filter formed on the imaging lens side of the pixel, wherein
the ultra-wide-angle reading method is a method of adding and reading the electric signals of the pixels having the color filters of respective colors for each pixel block including a plurality of the pixels, and
the wide-angle reading method is a method of individually reading the electric signal for each of the pixels.

16. The imaging device according to claim 15, wherein
the pixels having the color filters of a same color in the pixel block share a charge holding section that holds the charge, and
the ultra-wide-angle reading method is a method of reading the electric signal corresponding to the charge retained in the charge retaining section.

17. The imaging device according to claim 12, further comprising
a phase difference detection section that detects a phase difference of the electric signal due to parallax of a plurality of adjacent photoelectric conversion sections.

18. An imaging lens, comprising
a lens group including one or more lenses that form an optical image of an object on an imaging surface having a curved shape, wherein
when a maximum angle of view is 90 degrees or more,
a first image height that is an image height in a case where a half angle of view is 40 degrees is Yw, a second image height that is an image height in a case where a half angle of view is a maximum half angle of view that is half of the maximum angle of view is Y, an optical total length that is a distance on an optical axis from an object-side surface of a lens closest to an object side to the imaging surface in the lens group is TL, and an optical distortion at the first image height is Dw,
the following conditions are satisfied:
$$0.27 \leq {( Yw / Y )}^{2} \leq 0 \text{.7} ,$$
$$0.3 \leq TL / 2 Y \leq 0.6 \; 95 ,$$
$$0.001 \leq \vert Dw / Yw \vert \leq 0.08 .$$

19. An imaging device, comprising:
a lens group including one or more lenses that form an optical image of an object on an imaging surface having a curved shape;
an imaging lens configured such that,
when a maximum angle of view is 90 degrees or more,
a first image height that is an image height in a case where a half angle of view is 40 degrees is Yw, a second image height that is an image height in a case where a half angle of view is a maximum half angle of view that is half of the maximum angle of view is Y, an optical total length that is a distance on an optical axis from an object-side surface of a lens closest to an object side to the imaging surface in the lens group is TL, and an optical distortion at the first image height is Dw,
the following conditions are satisfied:
$$0.27 \leq {( Yw / Y )}^{2} \leq 0 \text{.7} ,$$
$$0.3 \leq TL / 2 Y \leq 0.6 \; 95 ,$$
$$0.001 \leq \vert Dw / Yw \vert \leq 0.08 ;$$
and
an imaging element having the imaging surface, wherein
a pixel array section including a plurality of pixels is formed on the imaging surface, and
the pixel includes one or more photoelectric conversion sections that converts light corresponding to the optical image formed on the imaging surface into a charge, and outputs an electric signal corresponding to the charge.
